(19) United States
(12) Patent Application Publication
(10) Pub. No.: US 2016/0295211 A1
(43) Pub. Date: Oct. 6, 2016

(54) DECODING DEVICE AND DECODING METHOD, AND ENCODING DEVICE AND ENCODING METHOD

(71) Applicant: SONY CORPORATION, Tokyo (JP)

(72) Inventor: Kazushi SATO, Kanagawa (JP)

(73) Assignee: SONY CORPORATION, Tokyo (JP)

(21) Appl. No.: 15/035,391

(22) PCT Filed: Dec. 12, 2014
(86) PCT No.: PCT/JP2014/082922

§ 371 Date: May 9, 2016

(30) Foreign Application Priority Data
Dec. 27, 2013 (JP) 2013-272512

(51) Int. Cl. H04N 19/103; H04N 19/124; H04N 19/174; H04N 19/33; H04N 19/187

(52) U.S. Cl. CPC H04N 19/103; H04N 19/33; H04N 19/187; H04N 19/174; H04N 19/124

(57) ABSTRACT

The present disclosure relates to a decoding device and a decoding method, and an encoding device and an encoding method, which are capable of optimizing encoding of the enhancement image when the profile of the base image is the main still picture profile or the all intra profile. An enhancement decoding unit decodes encoded data of an enhancement image based on general_profile_idc that is set when a profile of a base image is a main still picture profile and indicates that a profile of the enhancement image is a scalable main still picture profile or general_profile_idc that is set when the profile of the base image is an all intra profile and indicates that the profile of the enhancement image is a scalable all intra profile. The present disclosure can be applied to, for example, a decoding device according to an HEVC scheme.

### TECHNICAL FIELD

The present disclosure relates to a decoding device, a decoding method, an encoding device, and an encoding method, and more particularly, a decoding device, a decoding method, an encoding device, and an encoding method, which are capable of optimizing encoding of an enhancement image when a profile of a base image is a main still picture profile or an all intra profile.

### BACKGROUND ART

In recent years, devices complying with a scheme such as a Moving Picture Experts Group phase (MPEG) in which compression is performed by orthogonal transform such as discrete cosine transform (DCT) and motion compensation using image information-specific redundancy have become widespread for the purpose of information delivery of broadcasting stations and information reception in general households.

Particularly, MPEG2 (ISO/IEC 13818-2) scheme is defined as a general-purpose image encoding scheme. MPEG 2 is a standard that covers interlaced scan images, progressive scan images, standard resolution images, and high definition images. MPEG 2 is now being widely used in a wide range of applications such as professional use and consumer use. Using the MPEG 2 scheme, for example, a high compression rate and an excellent image quality can be implemented by allocating a coding amount of 4 to 8 Mbps in the case of an interlaced scanned image of a standard resolution having 720×480 pixels and a coding amount of 18 to 22 MBps in the case of an interlaced scanned image of a high resolution having 1920*1088 pixels.

MPEG 2 is mainly intended for high definition coding suitable for broadcasting but does not support an encoding scheme having a coding amount (bit rate) lower than that of MPEG 1, that is, an encoding scheme of a high compression rate. With the spread of mobile terminals, it is considered that the need for such an encoding scheme will increase in the future, and thus an MPEG 4 encoding scheme has been standardized. An international standard for an image encoding scheme of MPEG 4 was approved as ISO/IEC 14496-2 in December, 1998.

Further, in recent years, standards such as H.26L (ITU-T Q6/16 VCEG) for the purpose of image encoding for video conferences have been standardized. H.26L requires a larger computation amount for encoding and decoding than in encoding schemes such as MPEG 2 or MPEG 4, but is known to implement high encoding efficiency.

Further, currently, as one activity of MPEG 4, standardization of incorporating even a function that is not supported in H.26L and implementing high encoding efficiency based on H.26L has been performed as a Joint Model of Enhanced-Compression Video Coding. As a standardization schedule, an international standard called H.264 and MPEG-4 Part10 (Advanced Video Coding (AVC) was established in March, 2003.

Furthermore, as an extension of H.264/AVC, Fidelity Range Extension (FRExt) including an encoding tool necessary for professional use such as RGB or 4:2:2 or 4:4:4 or 8×8 Discrete Cosine Transform (DCT) and a quantization matrix which are specified in MPEG-2 was standardized in February, 2005. As a result, the AVC scheme has become an encoding scheme capable of also expressing film noise included in movies well and is being used in a wide range of applications such as Blu-ray Discs (a registered trademark)(BD).

However, in recent years, there is an increasing need for high compression rate encoding capable of compressing an image of about 4000×2000 pixels, which is 4 times that of a high-definition image, or delivering a high-definition image in a limited transmission capacity environment such as the Internet. To this end, improvements in encoding efficiency have been under continuous review by Video Coding Expert Group (VCEG) under ITU-T.

Further, currently, in order to further improve the encoding efficiency to be higher than in AVC, Joint Collaboration Team-Video Coding (JCTVC), which is a joint standardization organization of ITU-T and ISO/IEC, has been standardizing an encoding scheme called High Efficiency Video Coding (HEVC). Non-Patent Document 1 was issued as a draft as of December, 2013.

Meanwhile, image encoding schemes such as MPEG-2 and AVC have a scalable function of dividing an image into a plurality of layers and encoding the plurality of layers. According to encoding using the scalable function (scalable coding), it is possible to transmit encoded data according to a processing performance of a decoding side without performing a transcoding process.

Specifically, for example, it is possible to transmit only an encoded stream of an image (hereinafter, referred to as a “base image”) of a base layer that is a layer serving as a base to terminals having a low processing performance such as mobile phones. Meanwhile, it is possible to transmit an encoded stream of an image of the base layer and an image (hereinafter, referred to as an “enhancement image”) of an enhancement layer that is a layer other than the base layer to terminals having a high processing performance such as television receivers or personal computers.

A scalable extension in the HEVC scheme is specified in Non-Patent Document 2.

Meanwhile, in an HEVC version 1, three profiles, that is, a main profile, a main 10 profile, and a main still picture profile are specified as profiles specifying technical elements necessary for an encoding process and a decoding process. An all intra profile is also proposed in Non-Patent Document 3.

### CITATION LIST

### Non-Patent Document

Non-Patent Document 1: Benjamin Bross, Gary J. Sullivan, Ye-Kui Wang, “Editors' proposed corrections to HEVC version 1,” JCTVC-M0432 v3, 2013.4.18-4.26
Non-Patent Document 2: Jianle Chen, Jill Boyce, YanYe, Miska M. Hannuksela, “High efficiency video coding (HEVC) scalable extension draft 3,” JCTVC-N1008 v3, 2013.7.25-8.2
Non-Patent Document 3: K. Sharman, N. Saunders, J. Gamei, T. Suzuki, A. Tabatabai, “AHG 5 and 18. Profiles for Range Extensions,” JCTVC-00082, 2013.10.23-11.1

### SUMMARY OF THE INVENTION

### Problems to be Solved by the Invention

In the scalable coding, when the profile of the base image is the main still picture profile or the all intra profile, it is not considered to optimize encoding of the enhancement image.

The present disclosure was made in light of the foregoing, and it is desirable to optimize encoding of the enhancement image when the profile of the base image is the main still picture profile or the all intra profile.

### Solutions to Problems

A decoding device according to a first aspect of the present disclosure includes a decoding unit that decodes encoded data of an enhancement image based on still profile information that is set when a profile of a base image serving as an image of a first layer is a main still picture profile and indicates that a profile of the enhancement image serving as an image of a second layer is a scalable main still picture profile or intra profile information that is set when the profile of the base image is an all intra profile and indicates that the profile of the enhancement image is a scalable all intra profile.

A decoding method according to the first aspect of the present disclosure corresponds to the decoding device of the first aspect of the present disclosure.

In the first aspect of the present disclosure, encoded data of an enhancement image is decoded based on still profile information that is set when a profile of a base image serving as an image of a first layer is a main still picture profile and indicates that a profile of the enhancement image serving as an image of a second layer is a scalable main still picture profile or intra profile information that is set when the profile of the base image is an all intra profile and indicates that the profile of the enhancement image is a scalable all intra profile.

An encoding device according to a second aspect of the present disclosure includes a setting unit that sets still profile information indicating that a profile of an enhancement image serving as an image of a second layer is a scalable main still picture profile when a profile of a base image serving as an image of a first layer is a main still picture profile, and sets intra profile information indicating that the profile of the enhancement image is a scalable all intra profile when the profile of the base image is an all intra profile, an encoding unit that encodes the enhancement image, and generates encoded data, and a transmission unit that transmits the still profile information and the intra profile information set by the setting unit and the encoded data generated by the encoding unit.

An encoding method according to the second aspect of the present disclosure corresponds to the encoding device according to the second aspect of the present disclosure.

In the second aspect of the present disclosure, still profile information indicating that a profile of an enhancement image serving as an image of a second layer is a scalable main still picture profile is set when a profile of a base image serving as an image of a first layer is a main still picture profile, intra profile information indicating that the profile of the enhancement image is a scalable all intra profile is set when the profile of the base image is an all intra profile, the enhancement image is encoded to generate encoded data, and the still profile information, the intra profile information, and the encoded data are transmitted.

The decoding device of the first aspect and the encoding device of the second aspect may be implemented by causing a computer to execute a program.

The program executed by the computer to implement the decoding device of the first aspect and the encoding device of the second aspect may be provided such that the program is transmitted via a transmission medium or recorded in a recording medium.

The decoding device of the first aspect and the encoding device of the second aspect may be independent devices or may be internal blocks configuring a single device.

A network refers to a mechanism configured such that at least two devices are connected, and information is transferred from one device to the other device. The devices that perform communication via the network may be independent devices or may be internal blocks configuring a single device.

### Effects of the Invention

According to the first aspect of the present disclosure, it is possible to decode encoded data. Further, according to the first aspect of the present disclosure, it is possible to decode encoded data that is optimally encoded when the profile of the base image is the main still picture profile or the all intra profile.

According to the second aspect of the present disclosure, it is possible to encode an image. Further, according to the second aspect of the present disclosure, it is possible to optimize encoding of the enhancement image when the profile of the base image is the main still picture profile or the all intra profile.

The effect described herein is not necessarily limited, and any effect described in the present disclosure may be included.

### BRIEF DESCRIPTION OF DRAWINGS

FIG. 1 is a diagram for describing spatial scalability.

FIG. 2 is a diagram for describing temporal scalability.

FIG. 3 is a diagram for describing SNR scalability.

FIG. 4 is a block diagram illustrating an exemplary configuration of an encoding device according to an embodiment of the present disclosure.

FIG. 5 is a block diagram illustrating an exemplary configuration of an enhancement encoding unit of FIG. 4.

FIG. 6 is a diagram illustrating an exemplary syntax of a VPS.

FIG. 7 is a diagram illustrating an exemplary syntax of profile_tier_level.

FIG. 8 is a diagram illustrating an exemplary syntax of vps_extension.

FIG. 9 is a diagram illustrating an exemplary syntax of vps_extension.

FIG. 10 is a diagram illustrating an exemplary syntax of an SPS.

FIG. 11 is a diagram illustrating an exemplary syntax of an SPS.

FIG. 12 is a diagram illustrating an exemplary syntax of a PPS.

FIG. 13 is a diagram illustrating an exemplary syntax of a PPS.

FIG. 14 is a diagram illustrating an exemplary syntax of a slice header.

FIG. 15 is a diagram illustrating an exemplary syntax of a slice header.

FIG. 16 is a diagram illustrating an exemplary syntax of a slice header.

FIG. 17 is a block diagram illustrating an exemplary configuration of a specific profile setting unit.

FIG. 18 is a diagram for describing a reference relation in a scalable main still picture profile.

FIG. 19 is a diagram for describing a reference relation in a scalable all intra profile.

FIG. 20 is a diagram for describing a reference relation when the number of reference layers is 2 or more.

FIG. 21 is a block diagram illustrating an exemplary configuration of an encoding unit of FIG. 5.

FIG. 22 is a diagram for describing a CU.

FIG. 23 is a flowchart for describing a scalable encoding process of an encoding device of FIG. 4.

FIG. 24 is a flowchart for describing a specific profile setting process.

FIG. 25 is a block diagram illustrating an exemplary configuration of a decoding device according to an embodiment of the present disclosure.

FIG. 26 is a block diagram illustrating an exemplary configuration of an enhancement decoding unit of FIG. 25.

FIG. 27 is a block diagram illustrating an exemplary configuration of a decoding unit of FIG. 26.

FIG. 28 is a flowchart for describing a scalable decoding process of a decoding device of FIG. 25.

FIG. 29 is a diagram illustrating another example of scalable coding.

FIG. 30 is a block diagram illustrating an exemplary hardware configuration of a computer.

FIG. 31 is a diagram illustrating an exemplary multi-view image coding scheme.

FIG. 32 is a diagram illustrating an exemplary configuration of a multi-view image encoding device to which the present disclosure is applied.

FIG. 33 is a diagram illustrating an exemplary configuration of a multi-view image decoding device to which the present disclosure is applied.

FIG. 34 is a diagram illustrating an exemplary schematic configuration of a television device to which the present disclosure is applied.

FIG. 35 is a diagram illustrating an exemplary schematic configuration of a mobile telephone to which the present disclosure is applied.

FIG. 36 is a diagram illustrating an exemplary schematic configuration of a recording/reproducing device to which the present disclosure is applied.

FIG. 37 is a diagram illustrating an exemplary schematic configuration of an imaging device to which the present disclosure is applied.

FIG. 38 is a block diagram illustrating a scalable coding application example.

FIG. 39 is a block diagram illustrating another scalable coding application example.

FIG. 40 is a block diagram illustrating another scalable coding application example.

FIG. 41 illustrates an exemplary schematic configuration of a video set to which the present disclosure is applied.

FIG. 42 illustrates an exemplary schematic configuration of a video processor to which the present disclosure is applied.

FIG. 43 illustrates another exemplary schematic configuration of a video processor to which the present disclosure is applied.

### MODE FOR CARRYING OUT THE INVENTION

<Description of Scalable Coding>

(Description of Spatial Scalability)

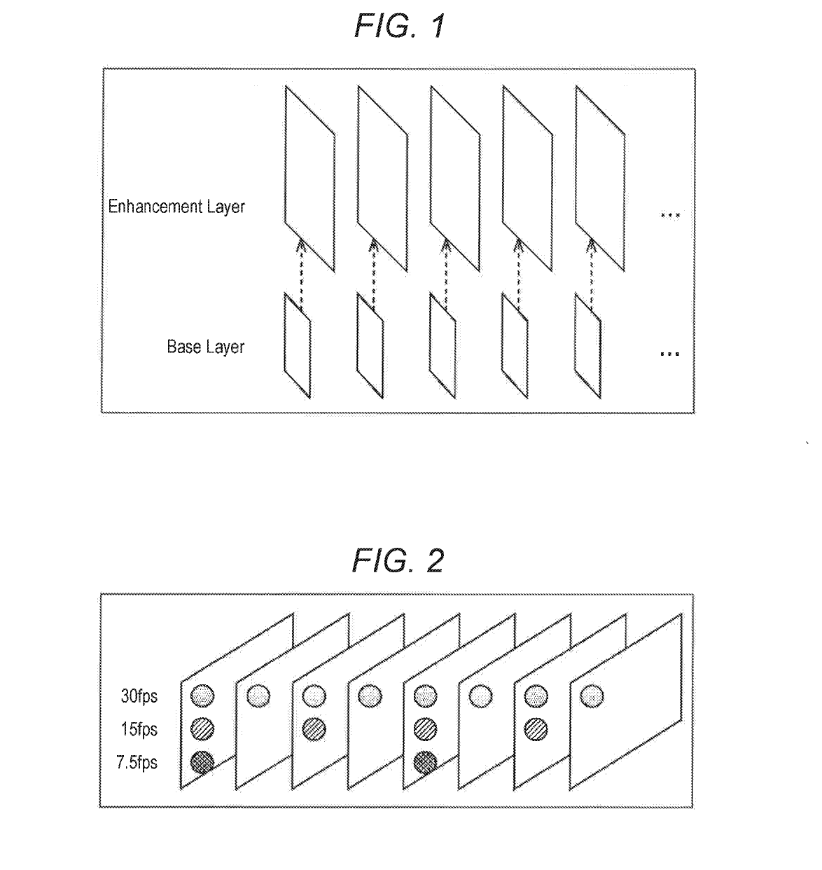

FIG. 1 is a diagram for describing spatial scalability.

As illustrated in FIG. 1, in a spatial scalability, an image is hierarchized and encoded according to a spatial resolution. Specifically, in the spatial scalability, a low resolution image is encoded as the base image, and a high resolution image is encoded as the enhancement image.

Thus, an encoding device transmits only encoded data of the base image to a decoding device having a low processing performance, and the decoding device can generate a low resolution image. Further, the encoding device transmits encoded data of the base layer and encoded data of the enhancement image to a decoding device having a high processing performance, and the decoding device can generate a high resolution image by decoding the base layer and the enhancement image.

(Description of Temporal Scalability)

FIG. 2 is a diagram for describing temporal scalability.

As illustrated in FIG. 2, in a temporal scalability, an image is hierarchized and encoded according to a frame rate. Specifically, in the temporal scalability, for example, an image of a low frame rate (7.5 fps in an example of FIG. 2) is encoded as the base image. An image of an intermediate frame rate (15 fps in the example of FIG. 2) is encoded as the enhancement image. Further, an image of a high frame rate (30 fps in the example of FIG. 2) is encoded as the enhancement image.

Thus, the encoding device transmits only encoded data of the base image to the decoding device having the low processing performance, and the decoding device can generate the image of the low frame rate. Further, the encoding device transmits encoded data of the base layer and encoded data of the enhancement image to the decoding device having the high processing performance, and the decoding device can generate the image of the high frame rate or the intermediate frame rate by decoding the base layer and the enhancement image.

(Description of SNR Scalability)

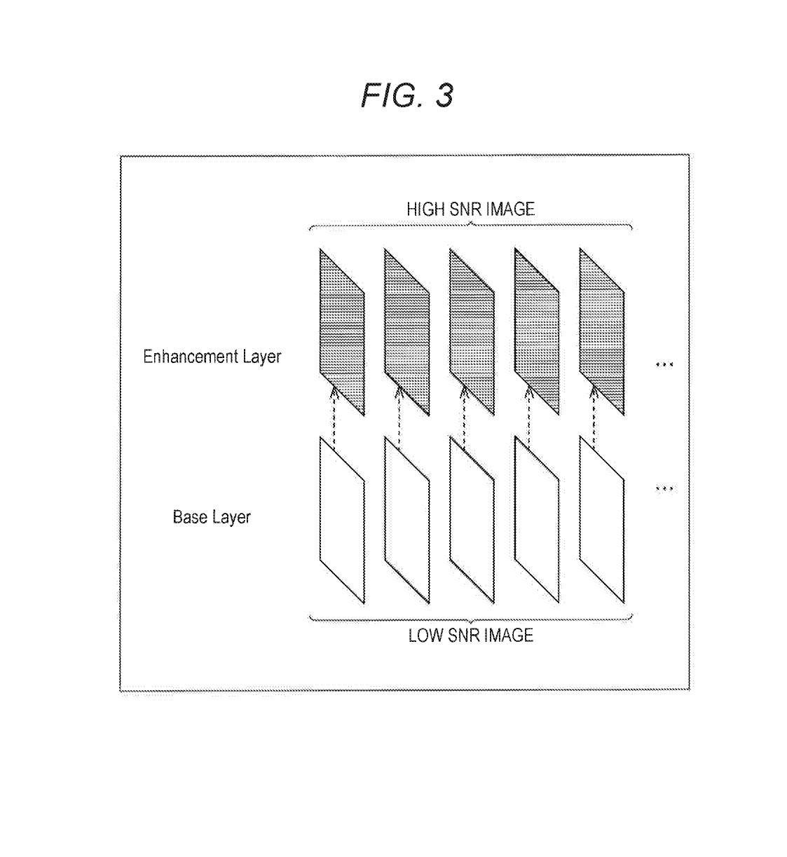

FIG. 3 is a diagram for describing SNR scalability.

As illustrated in FIG. 3, in an SNR scalability, an image is hierarchized and encoded according to a signal-noise ratio (SNR). Specifically, in the SNR scalability, an image of a low SNR is encoded as the base image, and an image of a high SNR is encoded as the enhancement image.

Thus, the encoding device transmits only encoded data of the base image to the decoding device having the low processing performance, and the decoding device can generate the image of the low SNR. Further, the encoding device transmits encoded data of the base layer and encoded data of the enhancement image to the decoding device having the high processing performance, and the decoding device can generate the image of the high SNR by decoding the base layer and the enhancement image.

Although not illustrated, in addition to the spatial scalability, the temporal scalability, and the SNR scalability, there is other scalable coding.

For example, as the scalable coding, there is also a bit-depth scalability of hierarchizing and encoding an image according to a bit depth. In this case, for example, an image of an 8-bit video is encoded as the base image, and an image of a 10-bit video is encoded as the enhancement image.

Further, as the scalable coding, there is also a chroma scalability of hierarchizing and encoding an image according to a chroma format thereof. In this case, for example, an image of a 4:2:0 format is encoded as the base image, and an image of a 4:2:2 format is encoded as the enhancement image.

For the sake of convenience of description, the following description will proceed with an example in which the number of enhancement layers is one.

### First Embodiment

### Exemplary Configuration of Encoding Device According to Embodiment

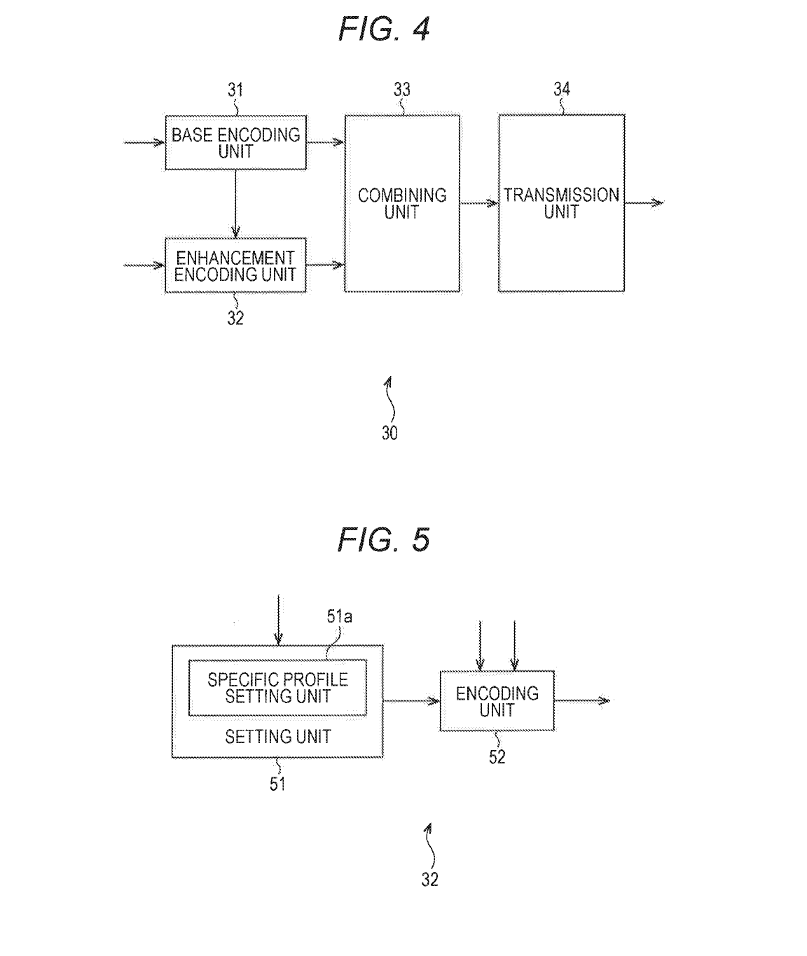

FIG. 4 is a block diagram illustrating an exemplary configuration of an encoding device according to an embodiment of the present disclosure.

An encoding device 30 of FIG. 4 includes a base encoding unit 31, an enhancement encoding unit 32, a combining unit 33, and a transmission unit 34, and performs scalable coding on an image according to a scheme complying with the HEVC scheme.

The base encoding unit of the encoding device 30 sets data including a profile of the base image other than vps_extension of a video parameter set (VPS), a sequence parameter set (SPS), a picture parameter set (PPS), and a header portion of a slice header or the like. The profiles of the base image include a main profile, a main 10 profile, a main still picture profile, and an all intra profile.

The main profile is a profile specifying a technical element necessary for an encoding process and a decoding process of an 8-bit image of 4:2:0. There are the following six conditions as conditions related to the main profile.

A first condition is a condition in which a value of chroma_format_idc indicating a color format set to the SPS is 1. A second condition is a condition in which a value of bit_depth_luma_minus8 obtained by subtracting 8 from a bit depth of a luminance signal set to the SPS is 0. A third condition is a condition in which a value of bit_depth_chroma_minus8 obtained by subtracting 8 from a bit depth of a chrominance signal set to the SPS is 0.

A fourth condition is a condition in which a value of CtbLog2SizeY is 4 or more and 6 or less. A fifth condition is a condition in which a value of entropy_coding_sync_enabled_flag is 0 when a value of tiles_enabled_flag set to the PPS is 1. tiles_enabled_flag is a flag indicating whether or not there are two or more tiles in a picture, and is 1 when there are two or more tiles and 0 when there are no two or more tiles. entropy_coding_sync_enabled_flag is a flag indicating whether or not a synchronization process of a specific context variable is performed, and is 1 when the synchronization process is performed and 0 when the synchronization process is not performed.

A sixth condition is a condition in which, when a value of tiles_enabled_flag set to the PPS is 1, a value of ColumnWidthInLumaSamples[i] is 256 or more for i that is 0 or more and num_tile_columns_minus1 or less, and a value of RowHeightInLumaSamples[j] is 64 or more for j that is 0 or more and num_tile_rows_minus1 or less. num_tile_columns_minus1 is a value obtained by subtracting 1 from the number of columns of tiles in a picture set to the PPS. num_tile_rows_minus1 is a value obtained by subtracting 1 from the number of rows of tiles in a picture set to the PPS.

The main 10 profile is a profile that is higher than the main profile and specifies a technical element necessary for an encoding process and a decoding process of a 10-bit image of 4:2:0. There are the following six conditions as conditions related to the main 10 profile.

A first condition is a condition in which a value of chroma_format_idc is 1. A second condition is a condition in which a value of bit_depth_luma_minus8 is 0 or more and 2 or less. A third condition is a condition in which a value of bit_depth_chroma_minus8 is 0 or more and 2 or less. A fourth condition is a condition in which a value of CtbLog2SizeY is 4 or more and 6 or less.

A fifth condition is a condition in which a value of entropy_coding_sync_enabled_flag is 0 when a value of tiles_enabled_flag is 1. A sixth condition is a condition in which, when a value of tiles_enabled_flag is 1, a value of ColumnWidthInLumaSamples[i] is 256 or more for i that is 0 or more and num_tile_columns_minus1 or less, and a value of RowHeightInLumaSamples[j] is 64 or more for j that is 0 or more and num_tile_rows_minus1 or less.

The main still picture profile is a profile that is higher than the main 10 profile and specifying a technical element necessary for an encoding process of encoding an I picture as a still image and a corresponding decoding process. The main still picture profile is a profile useful for an application for generating a thumbnail image. There are the following seven conditions as conditions related to the main still picture profile.

A first condition is a condition in which a value of chroma_format_idc is 1. A second condition is a condition in which a value of bit_depth_luma_minus8 is 0. A third condition is a condition in which a value of bit_depth_chroma_minus8 is 0. A fourth condition is a condition in which a value of sps_max_dec_pic_buffering_minus1[sps_max_sub_layers_minus 1] that is set to the SPS and obtained by subtracting 1 from the number of pictures that can be held in a decoded picture buffer (DPB) in a picture of a maximum sub layer is 0.

A fifth condition is a condition in which a value of CtbLog2SizeY is 4 or more and 6 or less. A sixth condition is a condition in which a value of entropy_coding_sync_enabled_flag is 0 when a value of tiles_enabled_flag is 1. A seventh condition is a condition in which, when a value of tiles_enabled_flag is 1, a value of ColumnWidthInLumaSamples[i] is 256 or more for i that is 0 or more and num_tile_columns_minus1 or less, and a value of RowHeightInLumaSamples[j] is 64 or more for j that is 0 or more and num_tile_rows_minus1 or less.

The all intra profile is a profile useful for an image edition application.

The base image is input from the outside to the base encoding unit 31. The base encoding unit 31 has, for example, a similar configuration to an encoding device complying with the HEVC scheme, and encodes the base image with reference to the header portion according to the HEVC scheme. The base encoding unit 31 supplies an encoded stream including encoded data obtained as a result of encoding and the header portion to the combining unit 33 as a base stream. The base encoding unit 31 supplies the base image decoded to be used as a reference image at the time of encoding of the base image and the header portion of the base image to the enhancement encoding unit 32.

The enhancement encoding unit 32 sets vps_extension, the SPS, the PPS, and a header portion of a slice header or the like based on the profile included in the header portion of the base image supplied from the base encoding unit 31. The enhancement image is input from the outside to the enhancement encoding unit 32. The enhancement encoding unit 32 encodes the enhancement image according to a scheme complying with the HEVC scheme.

At this time, the enhancement encoding unit 32 refers to the base image and the header portion of the base image supplied from the base encoding unit 31. The enhancement encoding unit 32 supplies an encoded stream including encoded data obtained as a result of encoding and the header portion to the combining unit 33 as an enhancement stream.

The combining unit 33 generates an encoded stream of all layers by combining the base stream supplied from the base encoding unit 31 and the enhancement stream supplied from the enhancement encoding unit 32. The combining unit 33 supplies the encoded stream of all layers to the transmission unit 34.

The transmission unit 34 transmits the encoded stream of all layers supplied from the combining unit 33 to a decoding device which will be described later.

Here, the encoding device 30 is assumed to transmit the encoded stream of all layers but may transmit only the base stream as necessary.

(Exemplary Configuration of Enhancement Encoding Unit)

FIG. 5 is a block diagram illustrating an exemplary configuration of the enhancement encoding unit 32 of FIG. 4.

The enhancement encoding unit 32 of FIG. 5 includes a setting unit 51 and an encoding unit 52.

The setting unit 51 of the enhancement encoding unit 32 includes a specific profile setting unit 51a. The specific profile setting unit 51a sets some information of the header portion by a different setting method from the other cases when the profile of the base image supplied from the base encoding unit 31 is the main still picture profile or the all intra profile. The setting unit 51 sets information of the header portion other than the information set by the specific profile setting unit 51a. The setting unit 51 supplies the set header portion to the encoding unit 52.

The encoding unit 52 encodes the enhancement image input from the outside according to the scheme complying with the HEVC scheme with reference to the base image based on the header portion of the enhancement image supplied from the setting unit 51 and the header portion of the base image supplied from the base encoding unit 31. The encoding unit 52 generates the enhancement stream based on encoded data obtained as a result and the header portion supplied from the setting unit 51, and supplies the generated enhancement stream to the combining unit 33 of FIG. 4.

(Exemplary Syntax of VPS)

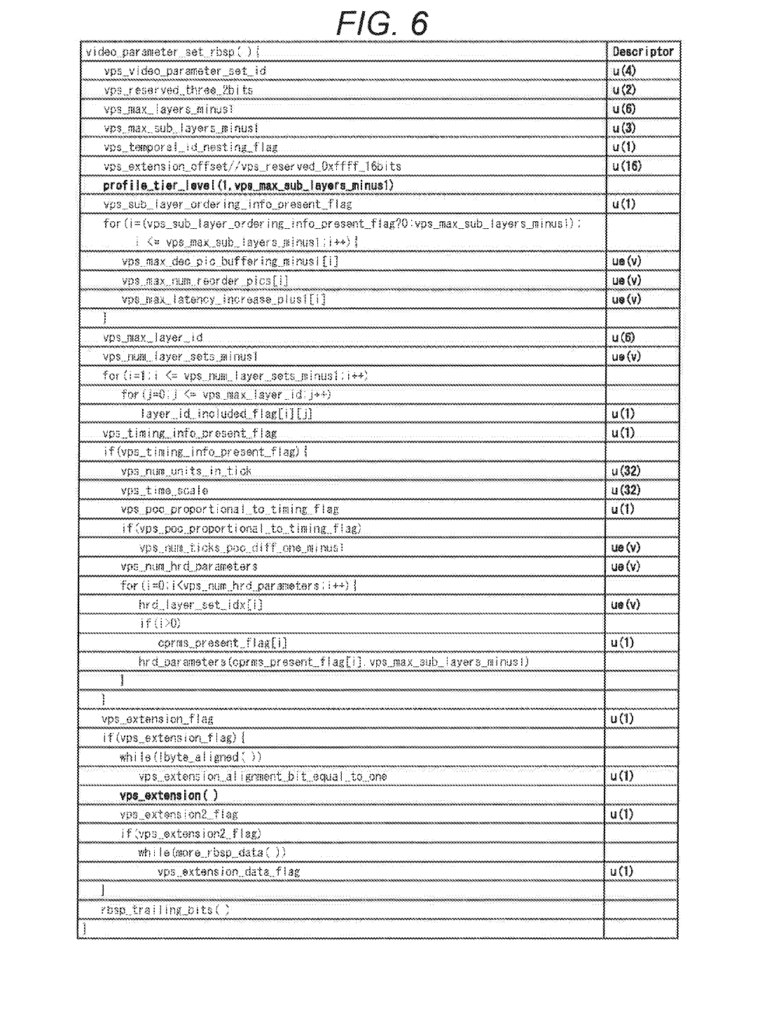

FIG. 6 is a diagram illustrating an exemplary syntax of the VPS.

As illustrated in FIG. 6, profile_tier_level serving as information related to the profile of the base layer that is given 0 as layer_id specifying a layer is set to the VPS. Further, vps_extension is set to the VPS.

(Exemplary Syntax of profile_tier_level)

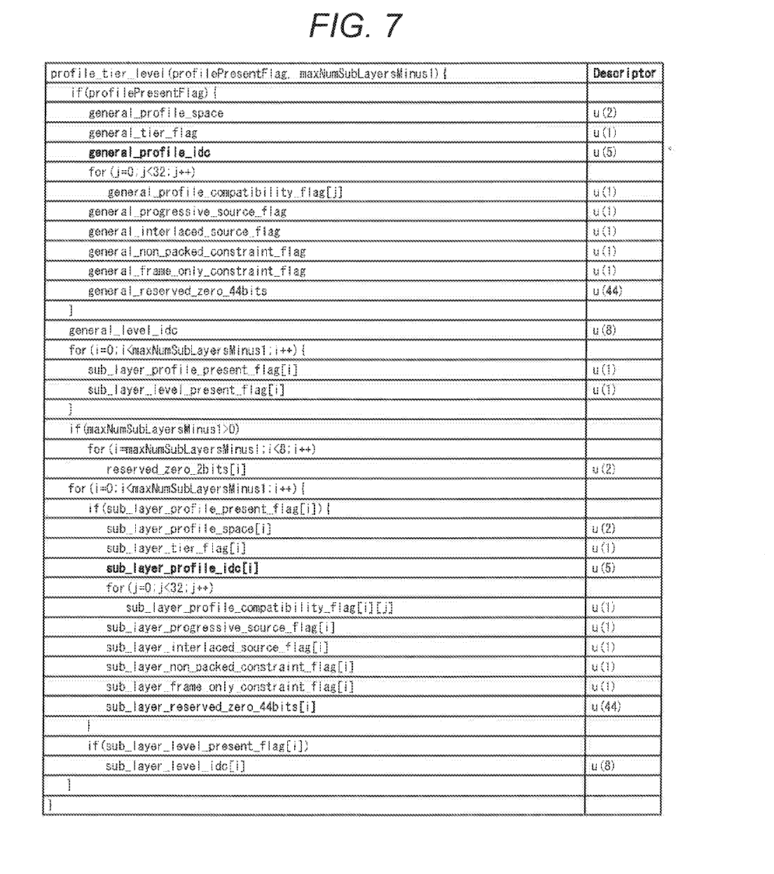

FIG. 7 is a diagram illustrating an exemplary syntax of profile_tier_level.

As illustrated in FIG. 7, general_profile_idc indicating a profile of a corresponding layer is set to profile_tier_level. For example, general_profile_id (profile information) of profile_tier_level included in the VPS indicates the profile of the base layer.

(Exemplary Syntax of vps_extension)

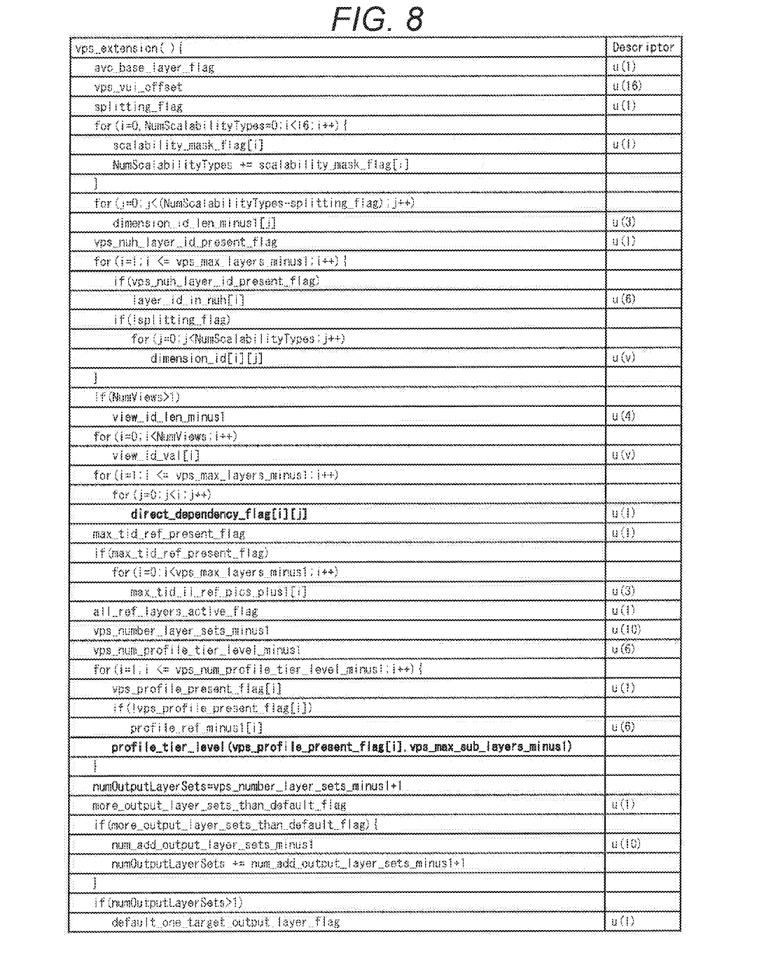

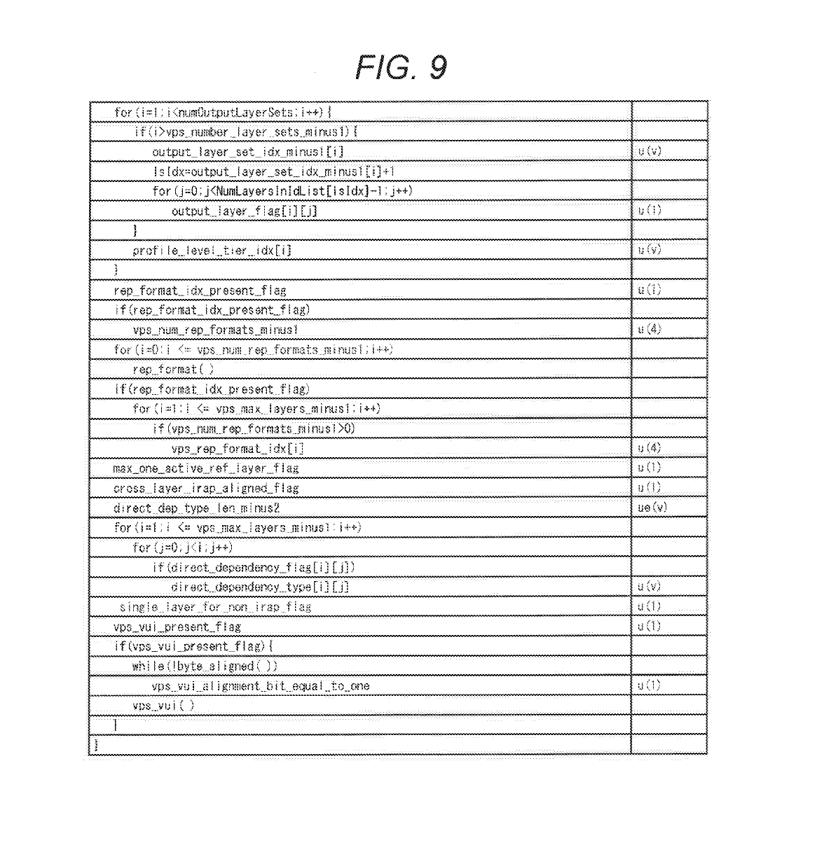

FIGS. 8 and 9 are diagrams illustrating an exemplary syntax of vps_extension.

As illustrated in FIG. 8, direct_dependency_flag (reference layer number information) indicating whether or not the number of layers (hereinafter, referred to as “reference layers”) of an image that can be referred to at the time of quantization of the encoded data of the enhancement image is 1, is set to vps_extension.

Further, as illustrated in FIG. 8, profile_tier_level of the enhancement layer that is given layer_id larger than 0 is set to vps_extension. As illustrated in FIG. 7, general_profile_idc indicating the profile of the enhancement layer is set to profile_tier_level.

(Exemplary Syntax of SPS)

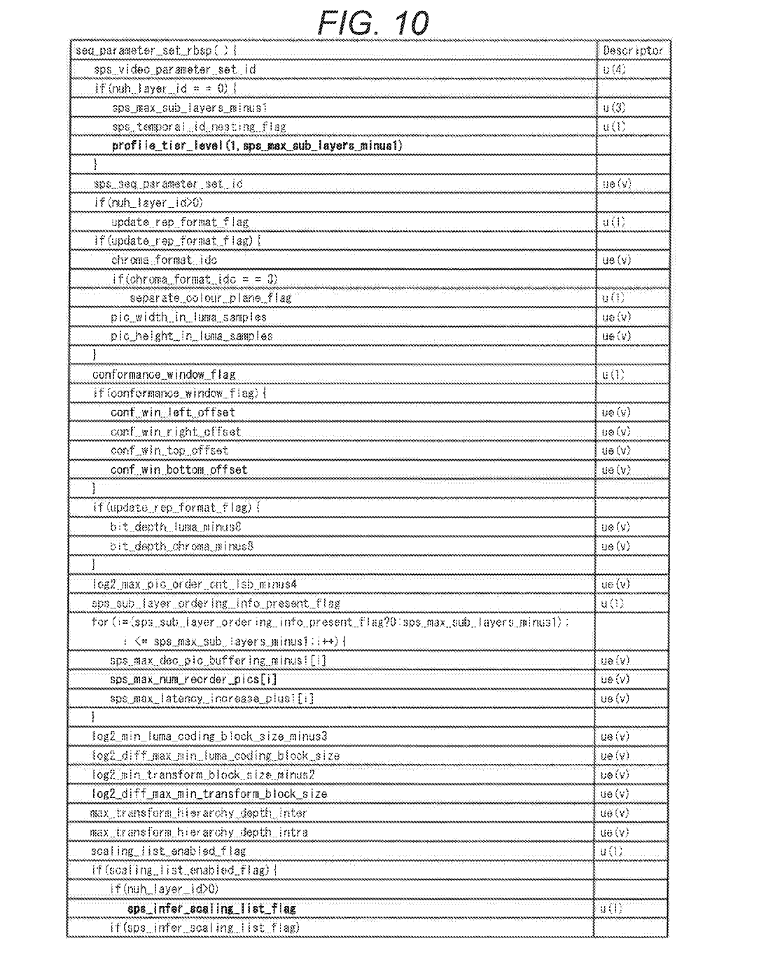

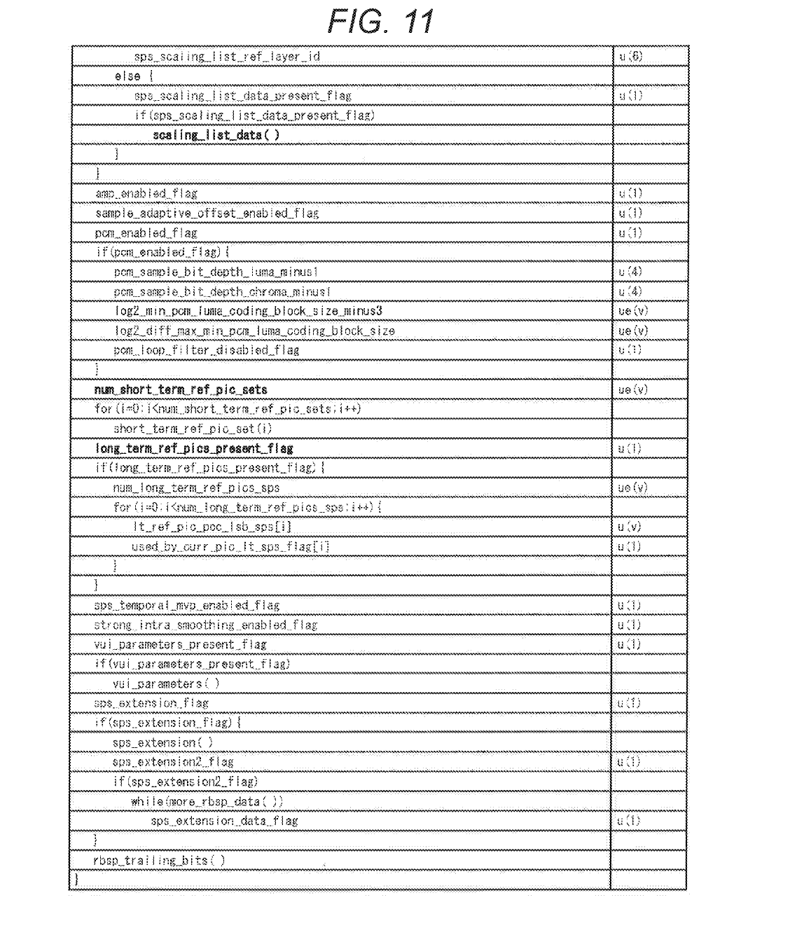

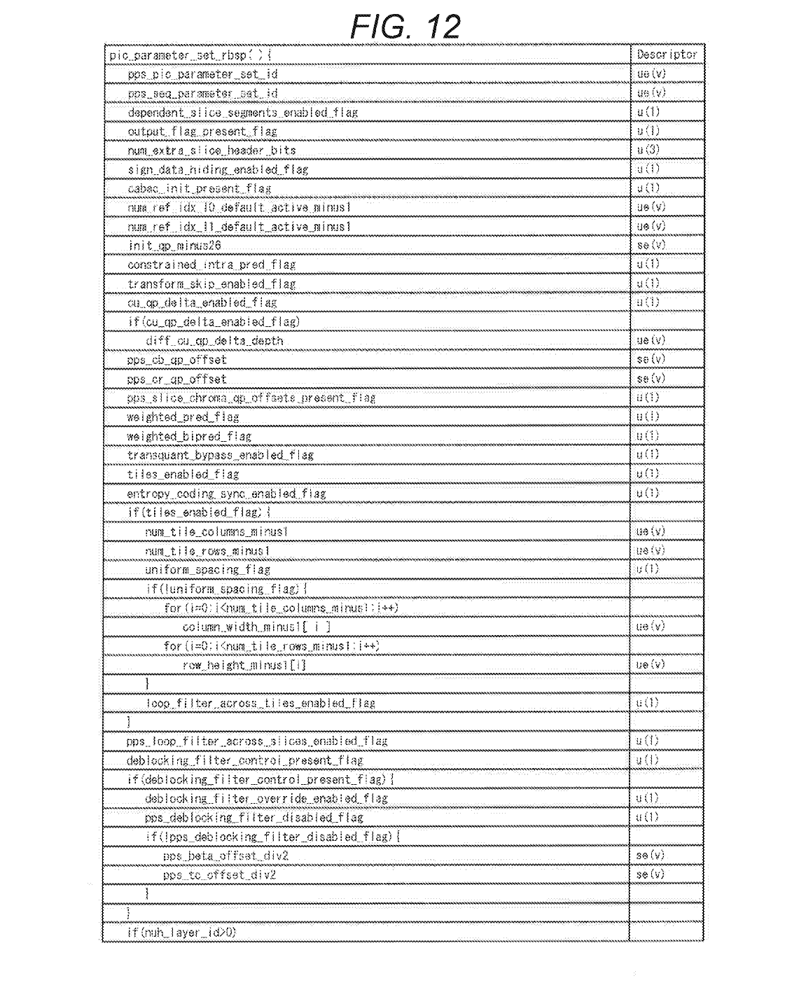

FIGS. 10 and 11 are diagrams illustrating an exemplary syntax of the SPS.

As illustrated in FIG. 10, profile_tier_level of the base layer is set to the SPS of the base image, similarly to the VPS. Further, sps_infer_scaling_list_flag (reference scaling list information) is set to the SPS of the enhancement image.

sps_infer_scaling_list_flag is information indicating whether or not a scaling list used at the time of quantization of encoded data of an image (the base image in the present embodiment) of another layer is used at the time of quantization of the encoded data of the enhancement image in units of sequences. sps_infer_scaling_list_flag is 1 when the scaling list used at the time of quantization of encoded data of an image of another layer is used at the time of quantization of the encoded data of the enhancement image and 0 when the scaling list used at the time of quantization of encoded data of an image of another layer is not used at the time of quantization of the encoded data of the enhancement image.

Further, as illustrated in FIG. 11, scaling_list_data indicating the scaling list (quantization matrix) in units of sequences is set to the SPS of the enhancement image as necessary when sps_infer_scaling_list_flag is 0.

Further, as illustrated in FIG. 11, num_short_term_ref_pic_sets indicating the number of short_term_ref_pic_sets is set to the SPS of the enhancement image. short_term_ref_pic_set is a reference picture set designating an image of the same layer that is close to a current image to be encoded in terms of a temporal distance as a candidate of the reference image.

Further, as illustrated in FIG. 11, long_term_ref_pics_present_flag indicating whether or not long_term_ref_pic_set is set is set to the SPS of the enhancement image. long_term_ref_pic_set is a reference picture set designating an image of the same layer that is far from a current image to be encoded in terms of a temporal distance and an image of a different layer from that of a current image to be encoded as a candidate of the reference image. long_term_ref_pics_present_flag is 1 when long_term_ref_pic_set is set and 0 when long_term_ref_pic_set is not described.

As illustrated in FIG. 11, when long_term_ref_pic_set is 1, lt_refpic_poc_sb_sps and used_by_curr_pic_lt_sps_flag configuring long_term_ref_pic_set are set.

(Exemplary Syntax of PPS)

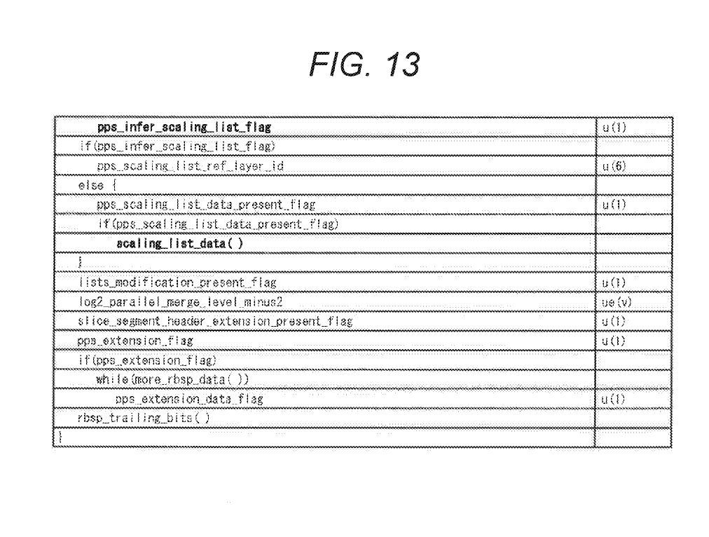

FIGS. 12 and 13 are diagrams illustrating an exemplary syntax of the PPS.

As illustrated in FIG. 13, pps_infer_scaling_list_flag is set to the PPS of the enhancement image. pps_infer_scaling_list_flag is information indicating whether or not a scaling list used at the time of quantization of encoded data of an image (the base image in the present embodiment) of another layer is used at the time of quantization of the encoded data of the enhancement image in units of pictures. pps_infer_scaling_list_flag is 1 when the scaling list used at the time of quantization of encoded data of an image of another layer is used at the time of quantization of the encoded data of the enhancement image and 0 when the scaling list used at the time of quantization of encoded data of an image of another layer is not used at the time of quantization of the encoded data of the enhancement image.

Further, as illustrated in FIG. 13, scaling_list_data indicating the scaling list in units of pictures is set to the PPS of the enhancement image as necessary when pps_infer_scaling_list_flag is 0.

(Exemplary Syntax of Slice Header)

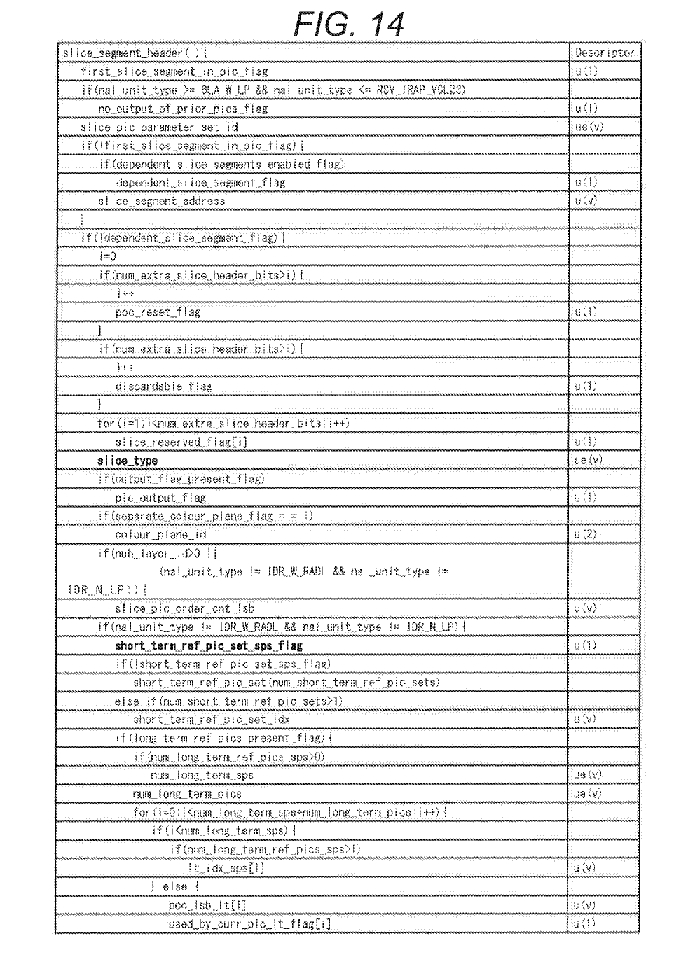

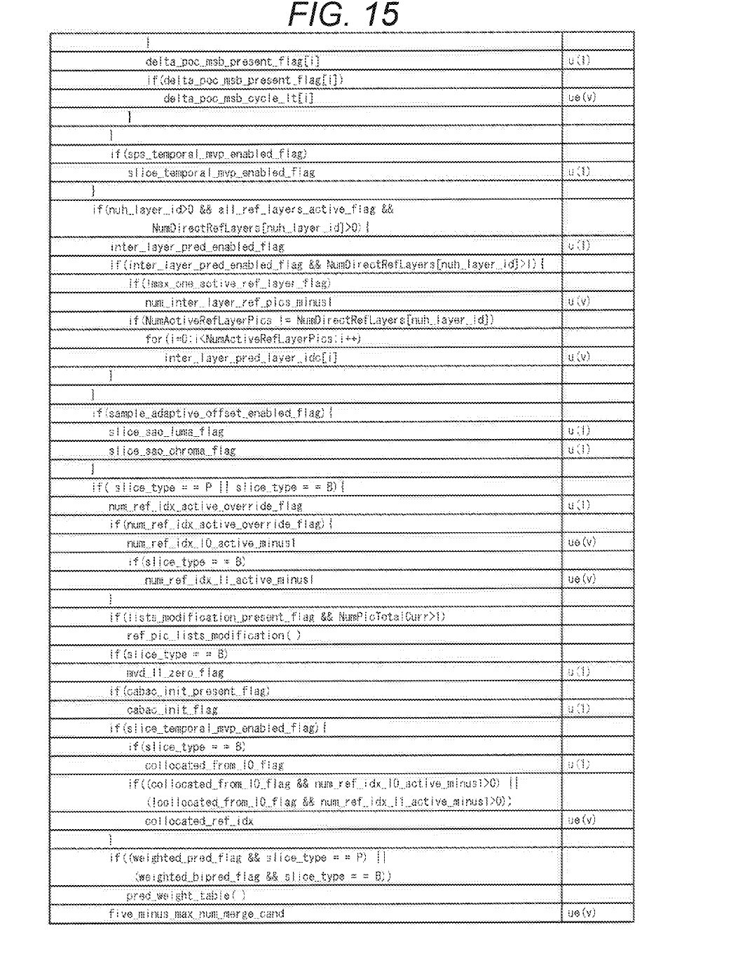

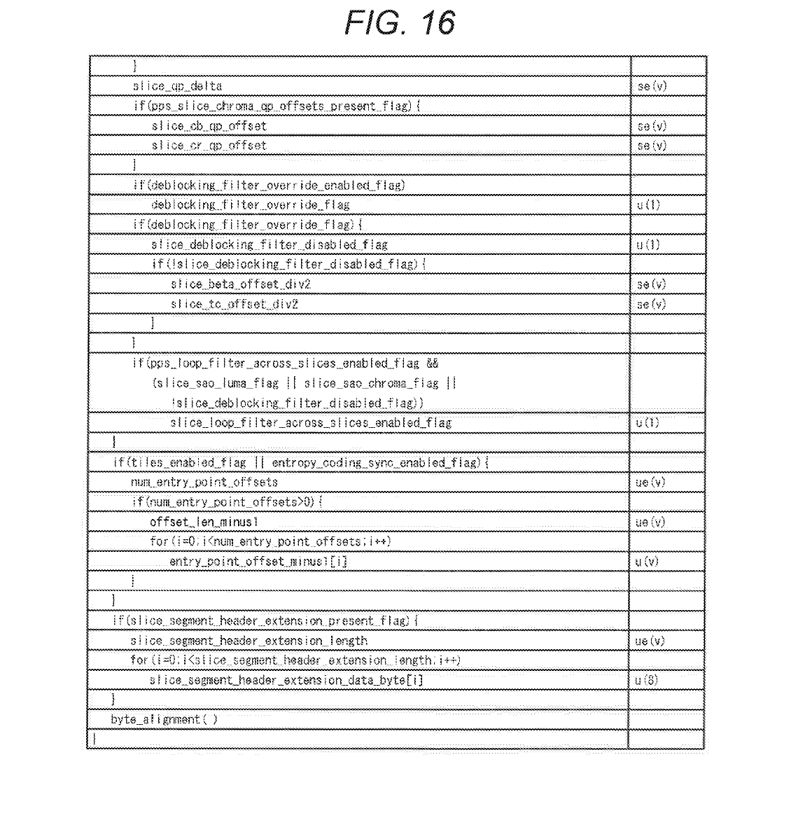

FIGS. 14 to 16 are diagrams illustrating an exemplary syntax of a slice header.

As illustrated in FIG. 14, slice_type indicating a slice type is set to the slice header. short_term_ref_pic_set_sps_flag indicating whether or not short_term_ref_pic_set set to the SPS is used is set to the slice header. short_term_ref_pic_set_sps_flag is 1 when short_term_ref_pic_set set to the SPS is used and 0 when short_term_ref_pic_set set to the SPS is not used.

(Exemplary Configuration of Specific Profile Setting Unit)

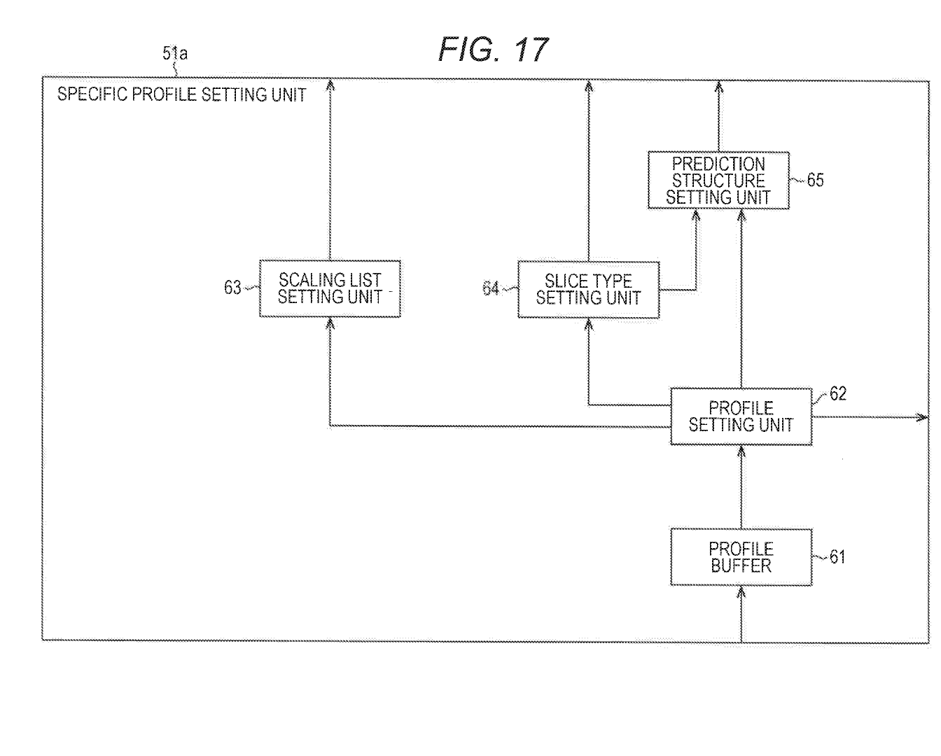

FIG. 17 is a block diagram illustrating an exemplary configuration of the specific profile setting unit 51a of FIG. 5.

The specific profile setting unit 51a of FIG. 17 includes a profile buffer 61, a profile setting unit 62, a scaling list setting unit 63, a slice type setting unit 64, and a prediction structure setting unit 65.

The profile buffer 61 holds the profile of the base image supplied from the base encoding unit 31 of FIG. 4.

The profile setting unit 62 reads the profile of the base image from the profile buffer 61. The profile setting unit 62 sets the scalable main still picture profile as the profile of the enhancement image when the profile of the base image is the main still picture profile. Further, the profile setting unit 62 sets the scalable all intra profile as the profile of the enhancement image when the profile of the base image is the all intra profile.

The profile setting unit 62 supplies the set profile of the enhancement image to the scaling list setting unit 63, the slice type setting unit 64, and the prediction structure setting unit 65. The profile setting unit 62 sets profile_tier_level including general_profile_idc indicating the profile of the enhancement image to vps_extension.

When the profile of the enhancement image is supplied from the profile setting unit 62, the scaling list setting unit 63 sets sps_infer_scaling_list_flag and pps_infer_scaling_list_flag to 0. In other words, when the profile of the base image is the main still picture profile or the all intra profile, the scaling list of the base image is the scaling list for intra encoding and thus set not to be used as the scaling list of the enhancement image. In this case, the scaling list setting unit 63 sets scaling_list_data in units of sequences or in units of pictures.

The scaling list setting unit 63 sets scaling_list_data and sps_infer_scaling_list_flag in units of sequences to the SPS. The scaling list setting unit 63 sets scaling_list_data and pps_infer_scaling_list_flag in units of pictures to the PPS.

When the profile of the enhancement image is supplied from the profile setting unit 62, the slice type setting unit 64 sets the slice type so that the slice type of at least one slice in each picture of the enhancement image is a P slice.

In the present embodiment, since a current image to be encoded has the two layers, that is, the base layer and the enhancement layer, the number of reference layers is 1, and a B slice is not set as the slice type. In other words, when an image of another layer is used as the reference image, the motion vector is 0, and thus when the number of reference layers is 1, the B slice is hardly set as the slice type. When the number of reference layers is 2 or more, the B slice can be set as the slice type.

The slice type setting unit 64 supplies the set slice type to the prediction structure setting unit 65. Further, the slice type setting unit 64 set slice type indicating the set slice type to the slice header.

When the profile of the enhancement image supplied from the profile setting unit 62 is the scalable all intra profile, and the slice type supplied from the slice type setting unit 64 is the P slice or the B slice, the prediction structure setting unit 65 performs a setting of information related to the reference picture set so that only the base image is used as the reference image.

Specifically, the prediction structure setting unit 65 sets short_term_ref_pic_set_sps_flag to 1, and sets num_short_term_ref_pic_sets to 0. In other words, short_term_ref_pic_set is not set. Further, the prediction structure setting unit 65 sets long_term_ref_pics_present_flag to 1, and sets long_term_ref_pic_set.

The prediction structure setting unit 65 sets short_term_ref_pic_set_sps_flag to the slice header. Further, the prediction structure setting unit 65 sets num_short_term_ref_pic_sets, long_term_ref_pics_present_flag, and long_term_ref_pic_set to the SPS.

(Description of Reference Relation in Scalable Main Still Picture Profile)

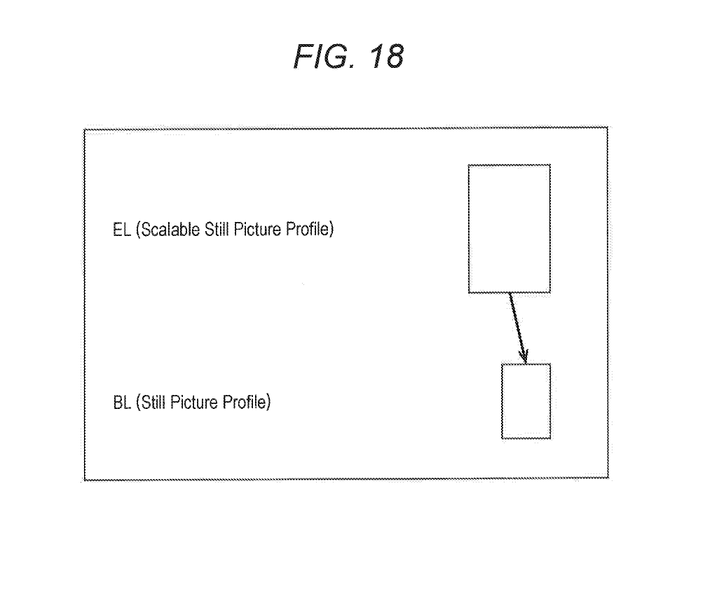

FIG. 18 is a diagram for describing a reference relation in the scalable main still picture profile.

As illustrated in FIG. 18, when the profile of the base image is the main still picture profile, the picture of the base image is one piece of picture in which all slices are an I slice. In this case, the profile of the enhancement image is the scalable main still picture profile, and the picture of the enhancement image is one piece of picture in which at least one slice is the P slice other than the I slice. The base image is referred to when the P slice of the picture of the enhancement image is encoded.

(Description of Reference Relation in Scalable all Intra Profile)

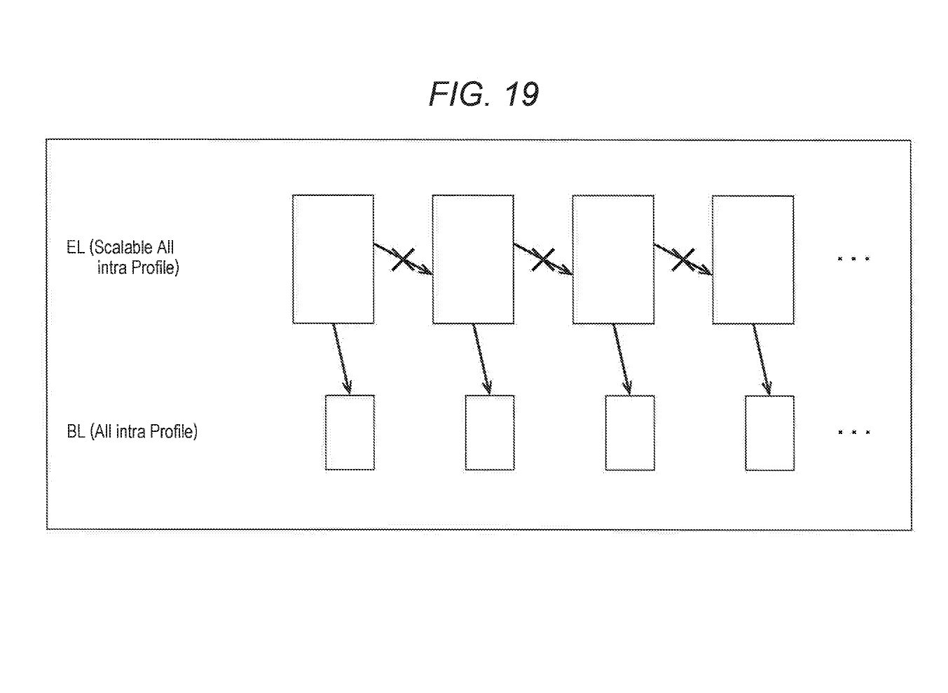

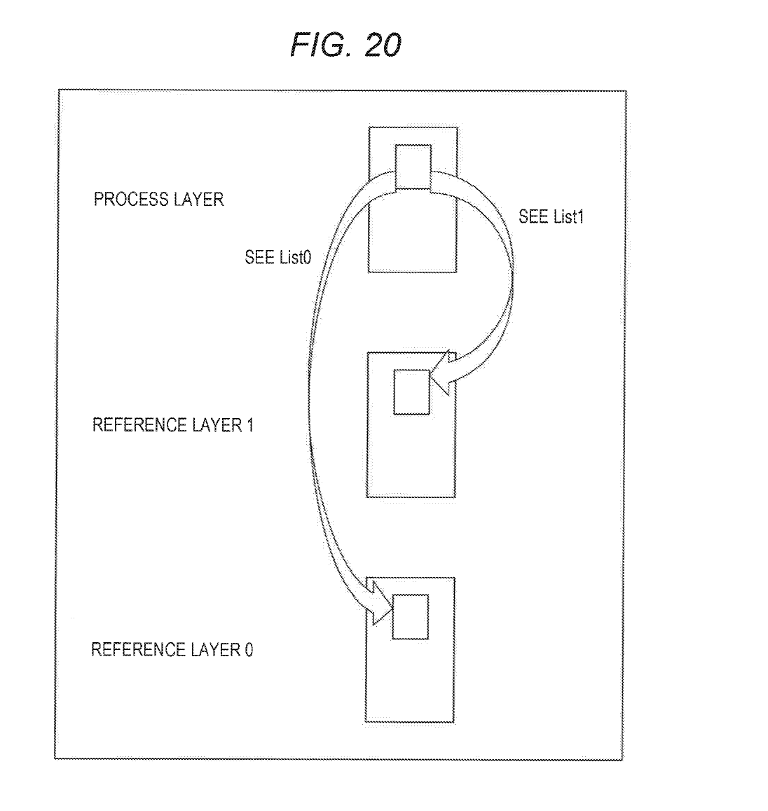

FIG. 19 is a diagram for describing a reference relation in the scalable all intra profile.

As illustrated in FIG. 19, when the profile of the base image is the all intra profile, each picture of the base image is a picture in which all slices are the I slice. In this case, the profile of the enhancement image is the scalable all intra profile, each picture of the enhancement image is a picture in which at least one slice is the P slice. When the P slice of the enhancement image is encoded, only the base image is referred to, and the enhancement image at a different time is not referred to. As a result, the encoded data of the enhancement image can be edited in units of access units (AUs).

Since at least one slice in the picture of the enhancement image is set to be the P slice other than the I slice as described above, the enhancement image and the base image necessarily have a reference relation.

Further, in the present embodiment, when the profile of the enhancement image is the scalable all intra profile, the enhancement image has no picture in which all slices are the I slice, similarly to the case of the scalable main still picture profile. However, when the enhancement image and the base image have the reference relation, the enhancement image may have a picture in which all slices are the I slice.

Further, as described above, in the present embodiment, since the number of layers of a current image to be encoded is 2, and the number of reference layers is 1, and thus the I slice or the P slice are set as the slices of the enhancement image. However, when the number of layers of a current image to be encoded is 3 or more (3 in an example of FIG. 20), and the number of reference layers is 2 or more as illustrated in FIG. 20, the B slice can be set as the slices of the enhancement image. When the slices of the enhancement image are the B slice, images of two different layers are referred to at the time of encoding.

(Exemplary Configuration of Encoding Unit)

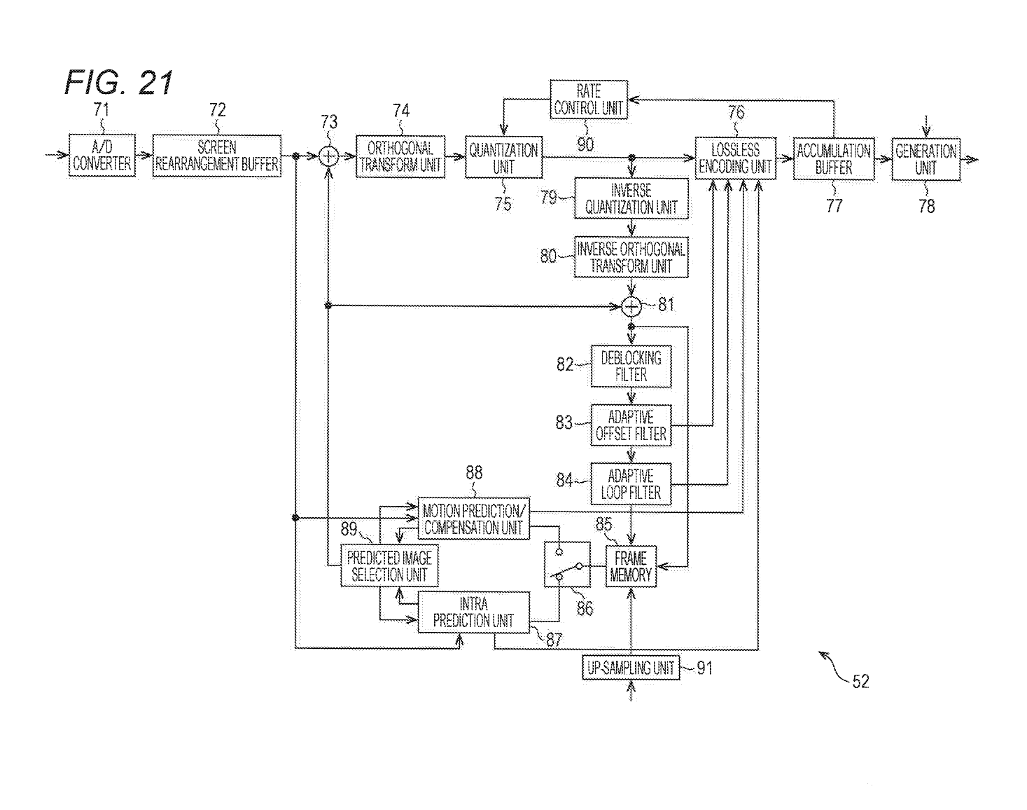

FIG. 21 is a block diagram illustrating an exemplary configuration of the encoding unit 52 illustrated in FIG. 5.

The encoding unit 52 of FIG. 21 includes an A/D converter 71, a screen rearrangement buffer 72, an operation unit 73, an orthogonal transform unit 74, a quantization unit 75, a lossless encoding unit 76, an accumulation buffer 77, a generation unit 78, an inverse quantization unit 79, and an inverse orthogonal transform unit 80. The encoding unit 52 includes an addition unit 81, a deblocking filter 82, an adaptive offset filter 83, an adaptive loop filter 84, a frame memory 85, a switch 86, an intra prediction unit 87, a motion prediction/compensation unit 88, a predicted image selection unit 89, a rate control unit 90, and an up-sampling unit 91. The encoding unit 52 refers to the header portion supplied from the setting unit 51 as necessary.

The A/D converter 71 of the encoding unit 52 performs A/D conversion on an input enhancement image of a frame unit. The A/D converter 71 outputs the enhancement image serving as the converted digital signal to be stored in the screen rearrangement buffer 72.

The screen rearrangement buffer 72 rearranges the stored enhancement image of the frame unit of a display order in an encoding order according to a group of picture (GOP) structure. The screen rearrangement buffer 72 outputs the rearranged enhancement image to the operation unit 73, the intra prediction unit 87, and the motion prediction/compensation unit 88.

The operation unit 73 functions as an encoding unit, and performs encoding by subtracting a predicted image supplied from the predicted image select ion unit 89 from the enhancement image supplied from the screen rearrangement buffer 72. The operation unit 73 outputs an image obtained as a result to the orthogonal transform unit 74 as residual information. Further, when no predicted image is supplied from the predicted image selection unit 89, the operation unit 73 outputs the enhancement image read from the screen rearrangement buffer 72 to the orthogonal transform unit 74 as the residual information without change.

The orthogonal transform unit 74 performs orthogonal transform on the residual information supplied from the operation unit 73 in units of transform units (TU). The orthogonal transform unit 74 supplies orthogonal transform coefficients obtained as a result of the orthogonal transform to the quantization unit 75.

The quantization unit 75 performs quantization on the orthogonal transform coefficients supplied from the orthogonal transform unit 74 using the scaling list set to the header portion of the base image or the enhancement image. The quantization unit 75 supplies the quantized orthogonal transform coefficients to the lossless encoding unit 76.

The lossless encoding unit 76 acquires intra prediction mode information indicating an optimal intra prediction mode from the intra prediction unit 87. The lossless encoding unit 76 acquires inter prediction mode information indicating an optimal inter prediction mode, the motion vector, information specifying the reference image, and the like from the motion prediction/compensation unit 88.

The lossless encoding unit 76 acquires offset filter information related to an offset filter from the adaptive offset filter 83, and acquires a filter coefficient from the adaptive loop filter 84.

The lossless encoding unit 76 performs lossless encoding such as variable length coding (for example, context-adaptive variable length coding (CAVLC)) or arithmetic coding (for example, context-adaptive binary arithmetic coding (CABAC)) on the quantized orthogonal transform coefficients supplied from the quantization unit 75.

The lossless encoding unit 76 performs loss less encoding on either of the intra prediction mode information and the inter prediction mode information, the motion vector, the information specifying the reference image, the offset filter information, and the filter coefficient as encoding information related to encoding. The lossless encoding unit 76 supplies the lossless-encoded encoding information and the orthogonal transform coefficients to be accumulated in the accumulation buffer 77 as encoded data. The lossless-encoded encoding information may be added to the encoded data as the header portion.

The accumulation buffer 77 temporarily stores the encoded data supplied from the lossless encoding unit 76. The accumulation buffer 77 supplies the stored encoded data to the generation unit 78.

The generation unit 78 generates the enhancement stream from the header portion supplied from the setting unit 51 of FIG. 5 and the encoded data supplied from the accumulation buffer 77, and supplies the generated enhancement stream to the combining unit 33 of FIG. 4.

The quantized orthogonal transform coefficients output from the quantization unit 75 are input to the inverse quantization unit 79 as well. The inverse quantization unit 79 performs inverse quantization on the orthogonal transform coefficients quantized by the quantization unit 75 using the scaling list set to the header portion of the base image or the enhancement image according to a method corresponding to a quantization method in the quantization unit 75. The inverse quantization unit 79 supplies the orthogonal transform coefficients obtained as a result of the inverse quantization to the inverse orthogonal transform unit 80.

The inverse orthogonal transform unit 80 performs inverse orthogonal transform on the orthogonal transform coefficients supplied from the inverse quantization unit 79 in units of TUs according to a method corresponding to an orthogonal transform method in the orthogonal transform unit 74. The inverse orthogonal transform unit 80 supplies the residual information obtained as a result to the addition unit 81.

The addition unit 81 adds the residual information supplied from the inverse orthogonal transform unit 80 to the predicted image supplied from the predicted image selection unit 89, and performs decoding locally. Further, when no predicted image is supplied from the predicted image selection unit 89, the addition unit 81 regards the residual information supplied from the inverse orthogonal transform unit 80 as the locally decoded enhancement image. The addition unit 81 supplies the locally decoded enhancement image to the deblocking filter 82 and the frame memory 85.

The deblocking filter 82 performs a deblocking filter process for removing block distortion on the locally decoded enhancement image supplied from the addition unit 81, and supplies the enhancement image obtained as a result to the adaptive offset filter 83.

The adaptive offset filter 83 performs an adaptive offset filter (sample adaptive offset (SAO)) process for mainly removing ringing on the enhancement image that has undergone the deblocking filter process by the deblocking filter 82.

Specifically, the adaptive offset filter 83 decides a type of an adaptive offset filter process for each largest coding unit (LCU) serving as a maximum coding unit, and obtains an offset used in the adaptive offset filter process. The adaptive offset filter 83 performs the decided type of the adaptive offset filter process on the enhancement image that has undergone the deblocking filter process using the obtained offset.

The adaptive offset filter 83 supplies the enhancement image that has undergone the adaptive offset filter process to the adaptive loop filter 84. Further, the adaptive offset filter 83 supplies the type of the performed adaptive offset filter process and the information indicating the offset to the lossless encoding unit 76 as the offset filter information.

For example, the adaptive loop filter 84 is configured with a two-dimensional Wiener Filter. The adaptive loop filter 84 performs an adaptive loop filter (ALF) process on the enhancement image that has undergone the adaptive offset filter process and has been supplied from the adaptive offset filter 83, for example, in units of LCUs.

Specifically, the adaptive loop filter 84 calculates a filter coefficient used in the adaptive loop filter process in units of LCUs such that a residue between an original image serving as the enhancement image output from the screen rearrangement buffer 72 and the enhancement image that has undergone the adaptive loop filter process is minimized. Then, the adaptive loop filter 84 performs the adaptive loop filter process on the enhancement image that has undergone the adaptive offset filter process using the calculated filter coefficient in units of LCUs.

The adaptive loop filter 84 supplies the enhancement image that has undergone the adaptive loop filter process to the frame memory 85. Further, the adaptive loop filter 84 supplies the filter coefficient used in the adaptive loop filter process to the lossless encoding unit 76.

Here, the adaptive loop filter process is assumed to be performed in units of LCUs, but a processing unit of the adaptive loop filter process is not limited to an LCU. Here, as the processing unit of the adaptive offset filter 83 is identical to the processing unit of the adaptive loop filter 84, processing can be efficiently performed.

The frame memory 85 accumulates the enhancement image supplied from the addition unit 81 and the adaptive loop filter 84 and the base image supplied from the up-sampling unit 91. Adjacent pixels in a prediction unit (PU) in the enhancement image that is accumulated in the frame memory 85 but has not undergone the filter process are supplied to the intra prediction unit 87 via the switch 86 as a neighboring pixel. On the other hand, the enhancement images or the base images that are accumulated in the frame memory 85 and have undergone the filter process are output to the motion prediction/compensation unit 88 via the switch 86 as the reference image.

The intra prediction unit 87 performs intra prediction processes of all intra predict ion modes serving as a candidate in units of PUs using the neighboring pixels read from the frame memory 85 via the switch 86.

Further, the intra prediction unit 87 calculates a cost function value (which will be described later in detail) for all the intra prediction modes serving as a candidate based on the enhancement image read from the screen rearrangement buffer 72 and the predicted image generated as a result of the intra prediction process. Then, the intra prediction unit 87 decides an intra prediction mode in which the cost function value is smallest as the optimal intra prediction mode.

The intra prediction unit 87 supplies the predicted image generated in the optimal intra prediction mode and the corresponding cost function value to the predicted image selection unit 89. When a notification indicating selection of the predicted image generated in the optimal intra prediction mode is given from the predicted image selection unit 89, the intra prediction unit 87 supplies the intra prediction mode information to the lossless encoding unit 76.

Further, the cost function value is also called a rate distortion (RD) cost and calculated based on a technique of either of a high complexity mode and a low complexity mode decided by a joint model (JM) that is reference software, for example, in the H.264/AVC scheme. Further, the reference software in the H.264/AVC scheme is found at http://iphome.hhi.de/suehring/tml/index.htm.

Specifically, when the high complexity mode is employed as the cost function value calculation technique, up to decoding is supposedly performed on all prediction modes serving as a candidate, and a cost function value Cost (Mode) expressed by the following Formula (1) is calculated on each of the prediction modes.

[Mathematical Formula 1]

Cost(Mode)=D+λ·R (1)

D indicates a difference (distortion) between an original image and a decoded image, R indicates a generated coding amount including up to orthogonal transform coefficients, and X indicates a Lagrange undetermined multiplier given as a function of a quantization parameter QP.

Meanwhile, when the low complexity mode is employed as the cost function value calculation technique, generation of a predicted image and calculation of a coding amount of encoding information are performed on all prediction modes serving as a candidate, and a cost function Cost (Mode) expressed by the following Formula (2) is calculated on each of the prediction modes.

[Mathematical Formula 2]

Cost(Mode)=D+QPtoQuant(QP)·Header_Bit (2)

D indicates a difference (distortion) between an original image and a predicted image, Header_Bit indicates a coding amount of encoding information, and QPtoQuant indicates a function given as a function of the quantization parameter QP.

In the low complexity mode, since only the predicted image has only to be generated for all the prediction modes, and it is unnecessary to generate the decoded image, a computation amount is small.

The motion prediction/compensation unit 88 performs a motion prediction/compensation process (inter prediction) based on all the inter prediction modes serving as a candidate, the motion vector, and the reference image in units of PUs. Specifically, the motion prediction/compensation unit 88 reads the reference image serving as a candidate from the frame memory 85 via the switch 86 based on reference picture sets of a short term and a long term. Further, the motion prediction/compensation unit 88 includes a two-dimensional (2D) linear interpolation adaptive filter, and increases a resolution of the reference image by performing an interpolation filter process on the reference image using the 2D linear interpolation adaptive filter.

The motion prediction/compensation unit 88 performs a compensation process on the reference image having the high resolution based on the inter prediction mode serving as a candidate and the motion vector of a fractional pixel accuracy, and generates the predicted image. The inter prediction mode is a mode indicating a size of a PU or the like.

The motion prediction/compensation unit 88 calculates the cost function values for a combination of the inter prediction mode, the motion vector, and the reference image based on the enhancement image supplied from the screen rearrangement buffer 72 and the predicted image. The motion prediction/compensation unit 88 decides the inter prediction mode in which the cost function value is smallest as the optimal inter prediction mode. Further, the motion prediction/compensation unit 88 decides the motion vector and the reference image in which the cost function value is smallest as the optimal motion vector and the optimal reference image. Then, the motion prediction/compensation unit 88 supplies the predicted image of the optimal inter prediction mode and the cost function value to the predicted image selection unit 89.

Further, when a notification indicating selection of the predicted image generated in the optimal inter prediction mode is given from the predicted image selection unit 89, the motion prediction/compensation unit 88 outputs the inter prediction mode information, and the optimal motion vector, and the information specifying the reference image to the lossless encoding unit 76.

The predicted image selection unit 89 decides one of the optimal intra prediction mode and the optimal inter prediction mode that is smaller in the corresponding cost function value as the optimal prediction mode based on the cost function values supplied from the intra prediction unit 87 and the motion prediction/compensation unit 88. Then, the predicted image selection unit 89 supplies the predicted image of the optimal prediction mode to the operation unit 73 and the addition unit 81. Further, the predicted image selection unit 89 gives a notification indicating selection of the predicted image of the optimal prediction mode to the intra prediction unit 87 or the motion prediction/compensation unit 88.

The rate control unit 90 controls a rate of the quantization operation of the quantization unit 75 based on the encoded data accumulated in the accumulation buffer 77 so that an overflow or an underflow does not occur.

The up-sampling unit 91 performs up-sampling on the base image supplied from the base encoding unit 31 of FIG. 4, and supplies the up-sampled base image to the frame memory 85.

(Description of Coding Unit)

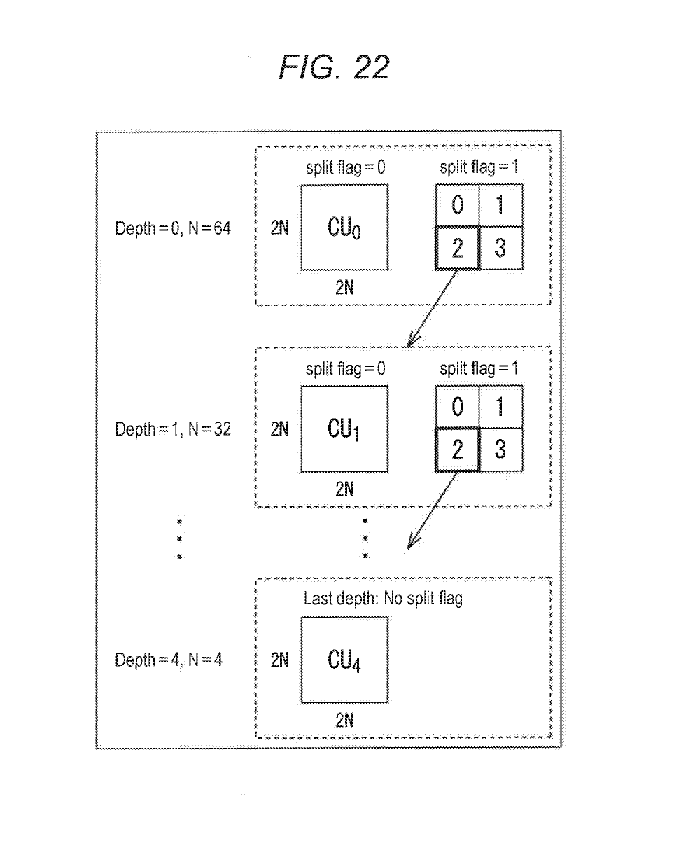

FIG. 22 is a diagram for describing a coding unit (CU) serving as an encoding unit in the HEVC scheme.

In the HEVC scheme, since an image of a large image frame such as ultra high definition (UHD) of 4000×2000 pixels is also a target, it is not optimal to fix a size of a coding unit to 16×16 pixels. Thus, in the HEVC scheme, a CU is defined as a coding unit. The details of the CU are described in Non-Patent Document 1.

The CU undertakes the same role of a macroblock in the AVC scheme. Specifically, the CU is divided into PUs or TUs.

However, the size of the CU is a square that varies for each sequence and is represented by pixels of a power of 2. Specifically, the CU is set such that the LCU serving as the maximum size of the CU is divided into two in the horizontal direction and the vertical direction an arbitrary number of times so that it is not smaller than a smallest coding unit (SCU) serving as the minimum size of the CU. In other words, when the LCU is hierarchized so that a size of an upper layer is one fourth (¼) of a size of a lower layer until the LCU becomes the SCU, a size of an arbitrary layer is the size of the CU.

For example, in FIG. 22, the size of the LCU is 128, and the size of the SCU is 8. Thus, a hierarchical depth of the LCU is 0 to 4, and a hierarchical depth number is 5. In other words, the number of divisions corresponding to the CU is any one of 0 to 4.

Further, information designating the sizes of the LCU and the SCU is included in the SPS. The number of divisions corresponding to the CU is designated by split_flag indicating whether or not division is further performed in each layer.

The TU size may be designated using split transform_flag, similarly to split_flag of the CU. The maximum number of divisions of the TU at the time of the inter prediction and the maximum number of divisions of the TU at the time of the intra prediction are designated by the SPS as max_transform_hierarchy_depth_inter and max_transform_hierarchy_depth_intra, respectively.

In the present specification, a coding tree unit (CTU) is assumed to be a unit including a coding tree block (CTB) of the LCU and a parameter used when processing is performed on the LCU base (level). Further, a CU configuring a CTU is assumed to be a unit including a coding block (CB) and a parameter used when processing is performed on the CU base (level).

(Description of Process of Encoding Device)

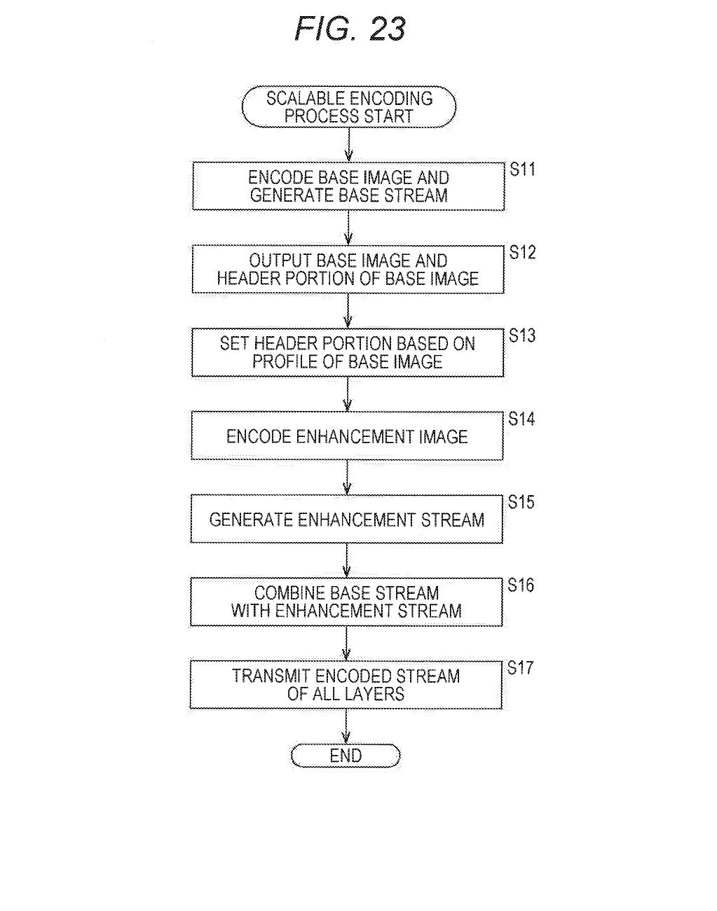

FIG. 23 is a flowchart for describing a scalable encoding process of the encoding device 30 of FIG. 4.

In step S11 of FIG. 23, the base encoding unit 31 of the encoding device 30 encodes the base image input from the outside according to the HEVC scheme, adds the header portion, and generates the base stream. Then, the base encoding unit 31 supplies the base stream to the combining unit 33.

In step S12, the base encoding unit 31 outputs the base image decoded to be used as the reference image and the header portion of the base image to the enhancement encoding unit 32.

In step S13, the setting unit 51 (FIG. 5) of the enhancement encoding unit 32 sets the header portion of the enhancement image based on the profile included in the header portion of the base image supplied from the base encoding unit 31, and supplies the header portion of the enhancement image to the encoding unit 52.

In step S14, the encoding unit 52 encodes the enhancement image input from the outside using the base image supplied from the base encoding unit 31.

In step S15, the generation unit 78 (FIG. 21) of the encoding unit 52 generates the enhancement stream based on the encoded data generated in step S14 and the header portion supplied from the setting unit 51, and supplies the enhancement stream to the combining unit 33.

In step S16, the combining unit 33 generates an encoded stream of all layers by combining the base stream supplied from the base encoding unit 31 and the enhancement stream supplied from the enhancement encoding unit 32. The combining unit 33 supplies the encoded stream of all layers to the transmission unit 34.

In step S17, the transmission unit 34 transmits the encoded stream of all layers supplied from the combining unit 33 to the decoding device which will be described later.

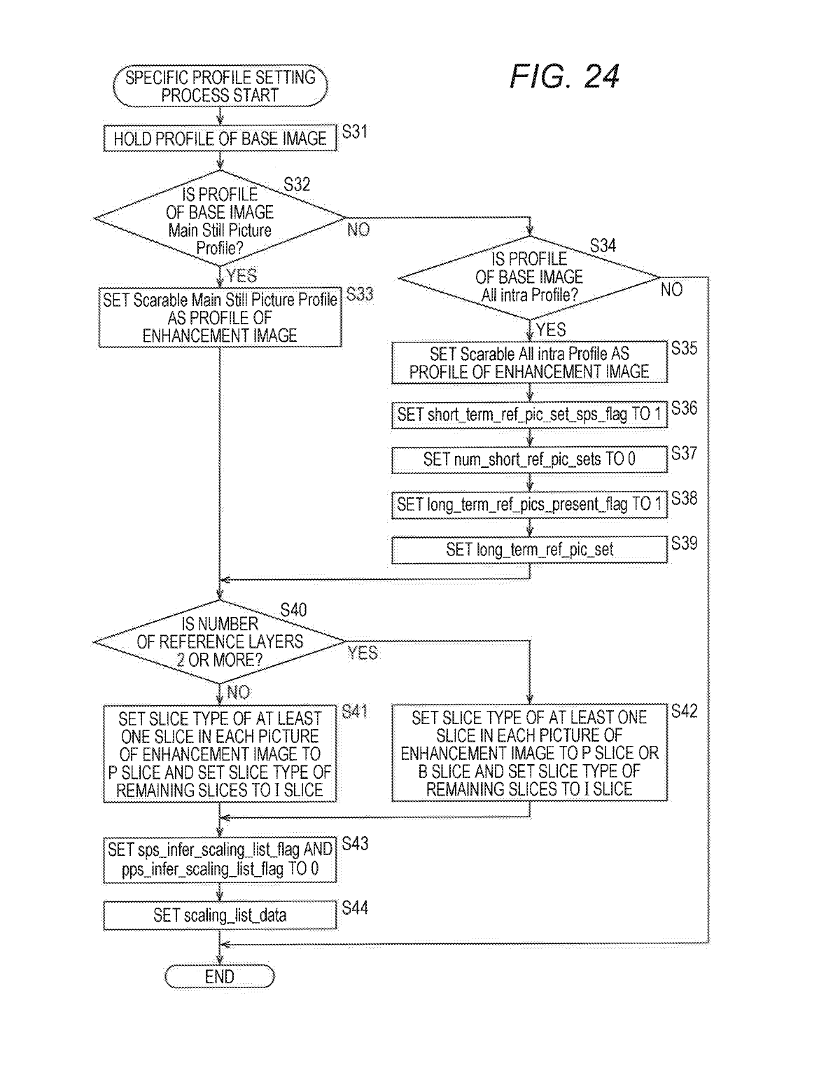

FIG. 24 is a flowchart for describing a specific profile setting process performed by the specific profile setting unit 51a in step S13 of FIG. 23.

In step S31 of FIG. 24, the profile buffer 61 (FIG. 17) holds the profile of the base image supplied from the base encoding unit 31 of FIG. 4.

In step S32, the profile setting unit 62 determines whether or not the profile of the base image held in the profile buffer 61 is the main still picture profile. When the profile of the base image is determined to be the main still picture profile in step S32, the process proceeds to step S33.

In step S33, the profile setting unit 62 sets the scalable main still picture profile as the profile of the enhancement image. The profile setting unit 62 supplies the scalable main still picture profile to the scaling list setting unit 63, the slice type setting unit 64, and the prediction structure setting unit 65 as the profile of the enhancement image. Further, the profile setting unit 62 sets profile_tier_level including general_profile_idc indicating the scalable main still picture profile to vps_extension. Then, the process proceeds to step S40.

On the other hand, when the profile of the base image is determined not to be the main still picture profile in step S32, the process proceeds to step S34. In step S34, the profile setting unit 62 determines whether or not the profile of the base image is the all intra profile.

When the profile of the base image is determined to be the all intra profile in step S34, in step S35, the profile setting unit 62 sets the scalable all intra profile as the profile of the enhancement image. The profile setting unit 62 supplies the scalable all intra profile to the scaling list setting unit 63, the slice type setting unit 64, and the prediction structure setting unit 65 as the profile of the enhancement image. Further, the profile setting unit 62 sets profile_tier_level including general_profile_idc indicating the scalable all intra profile to vps_extension.

In step S36, the prediction structure setting unit 65 sets short_term_ref_pic_set_sps_flag to 1. Then, the prediction structure setting unit 65 sets short_term_ref_pic_set_sps_flag to the slice header.

In step S37, the prediction structure setting unit 65 sets num_short_term_ref_pic_sets to 0. In step S38, the prediction structure setting unit 65 sets long_term_ref_pics_present_flag to 1. In step S39, the prediction structure setting unit 65 sets long_term_ref_pic_set. Then, the prediction structure setting unit 65 sets num_short_term_ref_pic_sets, long_term_ref_pics_present_flag, and long_term_ref_pic_set to the SPS. Then, the process proceeds to step S40.

In step S40, the slice type setting unit 64 determines whether or not the number of reference layers is 2 or more based on direct_dependency_flag set to vps_extension. When the number of reference layers is determined not to be 2 or more in step S40, the process proceeds to step S41.

In step S41, the slice type setting unit 64 sets the slice type of at least one slice in each picture of the enhancement image to the P slice, and sets the slice type of the remaining slices to the I slice. The slice type setting unit 64 supplies the set slice types to the prediction structure setting unit 65. Further, the slice type setting unit 64 sets slice_type indicating the set slice type to the slice header. Then, the process proceeds to step S43.

On the other hand, when the number of reference layers is determined to be 2 or more in step S40, the process proceeds to step S42. In step S42, the slice type setting unit 64 sets the slice type of at least one slice in each picture of the enhancement image to the P slice or the B slice, and sets the slice type of the remaining slices to the I slice. The slice type setting unit 64 supplies the set slice types to the prediction structure setting unit 65. Further, the slice type setting unit 64 sets slice_type indicating the set slice type to the slice header. Then, the process proceeds to step 343.

In step S43, the scaling list setting unit 63 sets sps_infer_scaling_list_flag and pps_infer_scaling_list_flag to 0. Then, the scaling list setting unit 63 sets sps_infer_scaling_list_flag to the SPS, and sets pps_infer_scaling_list_flag to the PPS.

In step S44, the scaling list setting unit 63 sets scaling_list_data in units of sequences and in units of pictures. Then, the scaling list setting unit 63 sets scaling_list_data in units of sequences to the SPS, and sets scaling_list_data in units of pictures to the PPS. Then, the process ends.

As described above, the encoding device 30 sets general_profile_idc indicating that the profile of the enhancement image is the scalable main still picture profile when the profile of the base image is the main still picture profile. Thus, it is possible to optimize encoding of the enhancement image when the profile of the base image is the main still picture profile.

Further, the encoding device 30 sets general_profile_idc indicating that the profile of the enhancement image is the scalable all intra profile when the profile of the base image is the all intra profile. Thus, it is possible to optimize encoding of the enhancement image when the profile of the base image is the all intra profile.

In addition, the encoding device 30 refers to only an image of another layer at the time of encoding the P slice or the B slice when the profile of the enhancement image is the scalable all intra profile. Thus, it is possible to edit the encoded data of the enhancement image, similarly to the base image without setting all slices to the I slice. As a result, it is possible to edit the encoded data of the enhancement image without worsening the encoding efficiency.

Further, when the profile of the enhancement image is the scalable main still picture profile or the scalable all intra profile, the encoding device 30 decides the slice_type so that the enhancement image and the base image necessarily have the reference relation. Thus, the encoding efficiency can be improved.

(Exemplary Configuration of Embodiment of Decoding Device)

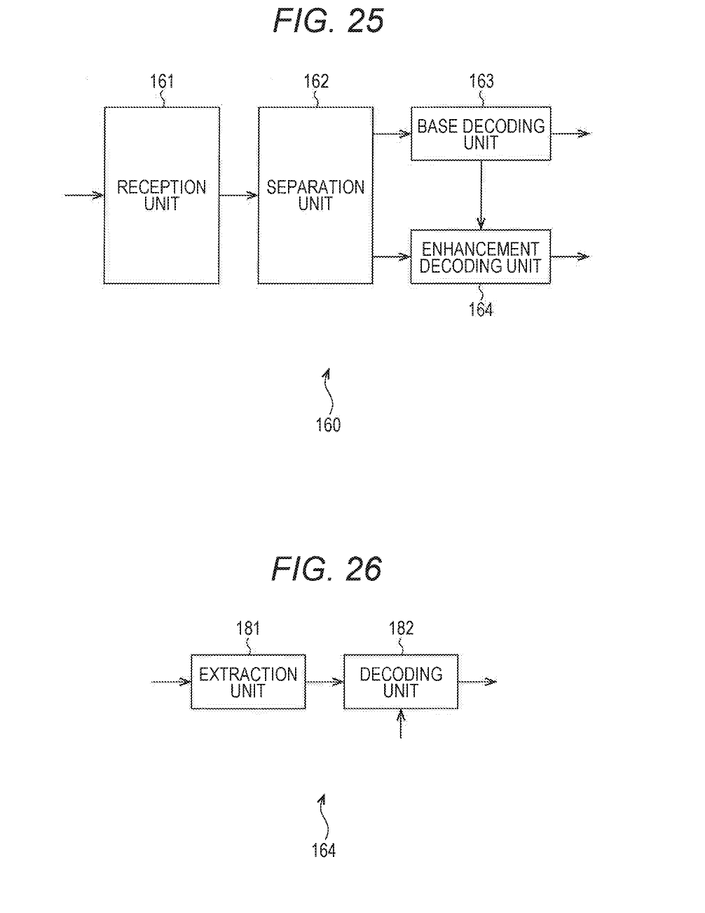

FIG. 25 is a block diagram illustrating an exemplary configuration of a decoding device that decodes the encoded stream of all layers transmitted from the encoding device 30 of FIG. 4 according to an embodiment of the present disclosure.

A decoding device 160 of FIG. 25 includes a reception unit 161, a separation unit 162, a base decoding unit 163, and an enhancement decoding unit 164.

The reception unit 161 receives the encoded stream of all layers transmitted from the encoding device 30 of FIG. 4, and supplies the encoded stream of all layers to the separation unit 162.

The separation unit 162 separates the base stream from the encoded stream of all layers supplied from the reception unit 161 and supplies the base stream to the base decoding unit 163, and separates the enhancement stream and supplies the enhancement stream to the enhancement decoding unit 164.

The base decoding unit 163 has the same configuration as a decoding device according to the HEVC scheme, and decodes the base stream supplied from the separation unit 162 according to the HEVC scheme and generates the base image. The base decoding unit 163 supplies the base image and the header portion included in the base stream to the enhancement decoding unit 164. The base decoding unit 163 outputs the base image as necessary.

The enhancement decoding unit 164 decodes the enhancement stream supplied from the separation unit 162 according to the scheme complying with the HEVC scheme, and generates the enhancement image. At this time, the enhancement decoding unit 164 refers to the base image and the header portion of the base image supplied from the base decoding unit 163. The enhancement decoding unit 164 outputs the generated enhancement image.

(Exemplary Configuration of Enhancement Decoding Unit)

FIG. 26 is a block diagram illustrating an exemplary configuration of the enhancement decoding unit 164 of FIG. 25.

The enhancement decoding unit 164 of FIG. 26 includes an extraction unit 181 and a decoding unit 182.

The extraction unit 181 of the enhancement decoding unit 164 extracts the header portion and the encoded data from the enhancement stream supplied from the separation unit 162 of FIG. 25, and supplies the header portion and the encoded data to the decoding unit 182.

The decoding unit 182 decodes the encoded data supplied from the extraction unit 181 according to the scheme complying with the HEVC scheme with reference to the base image supplied from the base decoding unit 163 of FIG. 25. At this time, the decoding unit 182 also refers to the header portion of the enhancement image supplied from the extraction unit 181 and the header portion of the base image supplied from the base decoding unit 163 as necessary. The decoding unit 182 outputs the enhancement image obtained as a result of decoding.

(Exemplary Configuration of Decoding Unit)

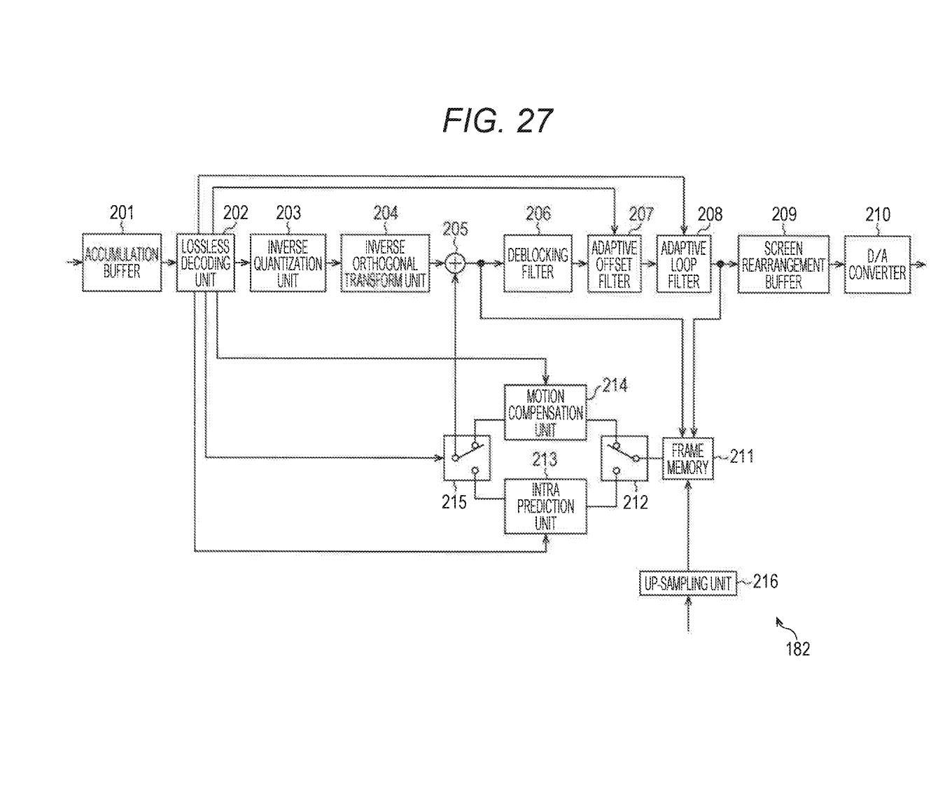

FIG. 27 is a block diagram illustrating an exemplary configuration of the decoding unit 182 of FIG. 26.

The decoding unit 182 of FIG. 27 includes an accumulation buffer 201, a lossless decoding unit 202, an inverse quantization unit 203, an inverse orthogonal transform unit 204, an addition unit 205, a deblocking filter 206, an adaptive offset filter 207, an adaptive loop filter 208, and a screen rearrangement buffer 209. The decoding unit 182 further includes a D/A converter 210, a frame memory 211, a switch 212, an intra prediction unit 213, a motion compensation unit 214, a switch 215, and an up-sampling unit 216. The decoding unit 182 refers to the header portion supplied from the extraction unit 181 as necessary.

The accumulation buffer 201 of the decoding unit 182 receives the encoded data from the extraction unit 181 of FIG. 26 and accumulates the encoded data. The accumulation buffer 201 supplies the accumulated encoded data to the lossless decoding unit 202.

The lossless decoding unit 202 obtains the quantized orthogonal transform coefficients and the encoding information by performing lossless decoding corresponding to lossless encoding of the lossless encoding unit 76 of FIG. 21 such as variable length decoding or arithmetic decoding on the encoded data supplied from the accumulation buffer 201. The lossless decoding unit 202 supplies the quantized orthogonal transform coefficients to the inverse quantization unit 203. The lossless decoding unit 202 supplies, for example, the intra prediction mode information serving as the encoding information to the intra prediction unit 213. The lossless decoding unit 202 supplies the motion vector, the inter prediction mode information, the information specifying the reference image, and the like to the motion compensation unit 214.

The lossless decoding unit 202 supplies either of the intra prediction mode information and the inter prediction mode information serving as the encoding information to the switch 215. The lossless decoding unit 202 supplies the offset filter information serving as the encoding information to the adaptive offset filter 207. The lossless decoding unit 202 supplies the filter coefficient serving as the encoding information to the adaptive loop filter 208.

An image is decoded such that the inverse quantization unit 203, the inverse orthogonal transform unit 204, the addition unit 205, the deblocking filter 206, the adaptive offset filter 207, the adaptive loop filter 208, the frame memory 211, the switch 212, the intra prediction unit 213, and the motion compensation unit 214 perform the same processes as the inverse quantization unit 79, the inverse orthogonal transform unit 80, the addition unit 81, the deblocking filter 82, the adaptive offset filter 83, the adaptive loop filter 84, the frame memory 85, the switch 86, the intra prediction unit 87, and the motion prediction/compensation unit 88 of FIG. 21, respectively.

Specifically, the inverse quantization unit 203 performs the inverse quantization on the quantized orthogonal transform coefficients supplied from the lossless decoding unit 202 based on the scaling list, sps_infer_scaling_list_flag, and pps_infer_scaling_list_flag set to the header portion of the base image or the enhancement image. The inverse quantization unit 203 supplies the orthogonal transform coefficients obtained as a result to the inverse orthogonal transform unit 204.

The inverse orthogonal transform unit 204 performs the inverse orthogonal transform on the orthogonal transform coefficients supplied from the inverse quantization unit 203 in units of TUs. The inverse orthogonal transform unit 204 supplies the residual information obtained as a result of the inverse orthogonal transform to the addition unit 205.

The addition unit 205 functions as a decoding unit, and performs decoding by adding the residual information supplied from the inverse orthogonal transform unit 204 to the predicted image supplied from the switch 215. The addition unit 205 supplies the enhancement image obtained as a result of decoding to the deblocking filter 206 and the frame memory 213.

Further, when no predicted image is supplied from the switch 215, the addition unit 205 supplies the image serving as the residual information supplied from the inverse orthogonal transform unit 204 to the deblocking filter 206 and the frame memory 211 as the enhancement image obtained as a result of decoding.

The deblocking filter 206 performs the deblocking filter process on the enhancement image supplied from the addition unit 205, and supplies the enhancement image obtained as a result to the adaptive offset filter 207.

The adaptive offset filter 207 performs the adaptive offset filter process of the type indicated by the offset filter information on the enhancement image that has undergone the deblocking filter process using the offset indicated by the offset filter information supplied from the lossless decoding unit 202 for each LCU. The adaptive offset filter 207 supplies the enhancement image that has undergone the adaptive offset filter process to the adaptive loop filter 208.

The adaptive loop filter 208 performs the adaptive loop filter process on the enhancement image supplied from the adaptive offset filter 207 for each LCU using the filter coefficient supplied from the lossless decoding unit 202. The adaptive loop filter 208 supplies the enhancement image obtained as a result to the frame memory 211 and the screen rearrangement buffer 209.

The screen rearrangement buffer 209 stores the enhancement image supplied from the adaptive loop filter 208 in units of frames. The screen rearrangement buffer 209 rearranges the stored enhancement image of the frame unit arranged in the encoding order in the original display order, and supplies the resulting enhancement image to the D/A converter 210.

The D/A converter 210 performs D/A conversion on the enhancement image of the frame unit supplied from the screen rearrangement buffer 209, and outputs the resulting image.

The frame memory 211 accumulates the enhancement image supplied from the adaptive loop filter 208 and the addition unit 205 and the base image supplied from the up-sampling unit 216. Adjacent pixels in a PU in the enhancement image that is cumulated in the frame memory 211 but has not undergone the filter process are supplied to the intra prediction unit 213 via the switch 212 as neighboring pixels. On the other hand, the enhancement image and the base image that have undergone the filter process and accumulated in the frame memory 211 are supplied to the motion compensation unit 214 via the switch 212 as the reference image.

The intra prediction unit 213 performs the intra prediction of the optimal intra prediction mode indicated by the intra prediction mode information supplied from the lossless decoding unit 202 using the neighboring pixels read from the frame memory 211 via the switch 212 in units of PUs. The intra prediction unit 213 supplies the predicted image generated as a result to the switch 215.

The motion compensation unit 214 reads the reference image specified by the information specifying the reference image supplied from the lossless decoding unit 202 from the frame memory 211 via the switch 212 based on the reference picture sets of the short term and the long term included in the header portion. The motion compensation unit 214 includes a 2D linear interpolation adaptive filter. The motion compensation unit 214 increases the resolution of the reference image by performing the interpolation filter process on the reference image using the 2D linear interpolation adaptive filter. The motion compensation unit 214 performs the motion compensation process of the optimal inter prediction mode indicated by the inter prediction mode information supplied from the lossless decoding unit 202 in units of PUs using the reference image having the high resolution and the motion vector supplied from the lossless decoding unit 202. The motion compensation unit 214 supplies the predicted image generated as a result to the switch 215.

When the intra prediction mode information is supplied from the lossless decoding unit 202, the switch 215 supplies the predicted image supplied from the intra prediction unit 213 to the addition unit 205. On the other hand, when the inter prediction mode information is supplied from the lossless decoding unit 202, the switch 215 supplies the predicted image supplied from the motion compensation unit 214 to the addition unit 205.

The up-sampling unit 216 performs the up-sampling on the base image supplied from the base decoding unit 163 of FIG. 25, and supplies the up-sampled base image to the frame memory 211.

(Description of Process of Decoding Device)

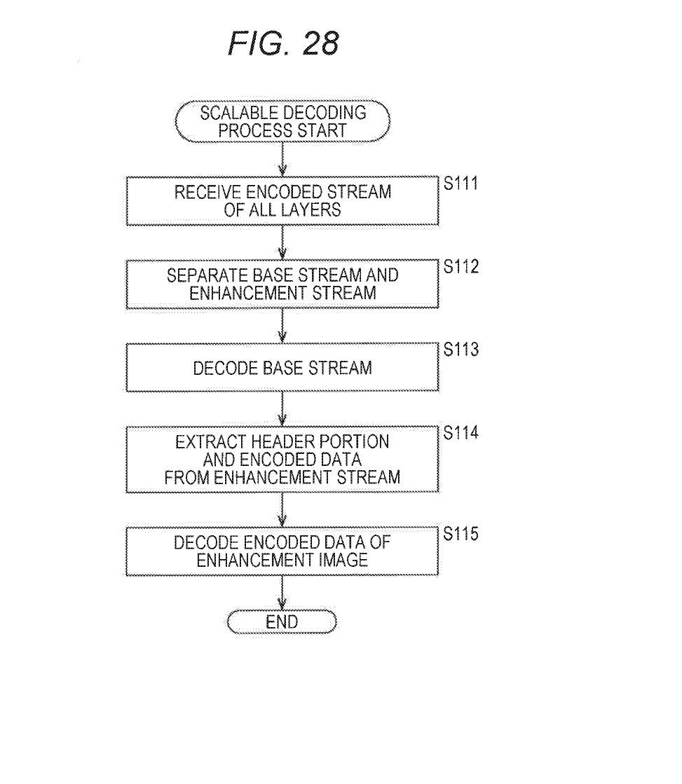

FIG. 28 is a flowchart for describing the scalable decoding process of the decoding device 160 of FIG. 25.

In step S111 of FIG. 28, the reception unit 161 of the decoding device 160 receives the encoded stream of all layers transmitted from the encoding device 30 of FIG. 4, and supplies the encoded stream of all layers to the separation unit 162.

In step S112, the separation unit 162 separates the base stream and the enhancement stream from the encoded stream of all layers. The separation unit 162 supplies the base stream to the base decoding unit 163, and supplies the enhancement stream to the enhancement decoding unit 164.

In step S113, the base decoding unit 163 decodes the base stream supplied from the separation unit 162 according to the HEVC scheme, and generates the base image. The base decoding unit 163 supplies the generated base image and the header portion included in the base stream to the enhancement decoding unit 164. The base decoding unit 163 outputs the base image as necessary.

In step S114, the extraction unit 181 (FIG. 26) of the enhancement decoding unit 164 extracts the header portion and the encoded data from the enhancement stream supplied from the separation unit 162.

In step S115, the decoding unit 182 decodes the encoded data of the enhancement image according to the scheme complying with the HEVC scheme with reference to the base image and the header portion of the base image supplied from the base decoding unit 163 and the header portion of the enhancement image supplied from the extraction unit 181. Then, the process ends.

As described above, the decoding device 160 decodes the encoded data of the enhancement image based on general_profile_idc that is set when the profile of the base image is the main still picture profile and indicates that the profile of the enhancement image is the scalable main still picture profile. Thus, it is possible to decode the encoded data that is optimally encoded when the profile of the base image is the main still picture profile.

Further, the decoding device 160 decodes the encoded data of the enhancement image based on general_profile_idc that is set when the profile of the base image is the all intra profile and indicates that the profile of the enhancement image is the scalable all intra profile. Thus, it is possible to decode the encoded data that is optimally encoded when the profile of the base image is the all intra profile.

The scaling list may not be set to the SPS or the PPS of the enhancement image, the scaling list for inter encoding may be set to the SPS or the PPS of the base image, and the scaling list may be used as the scaling list of the enhancement image. In this case, sps_infer_scaling_list_flag and pps_infer_scaling_list_flag are set to 1.

Further, when the enhancement image is the enhancement image of the bit-depth scalability, at least one of bit_depth_luma_mainus8 and bit_depth_chroma_minus8 of the SPS illustrated in FIGS. 10 and 11 may be limited.

In other words, when the bit-depth scalability is performed, the bit depth of the enhancement image is larger than the bit depth of the base image. Thus, bit_depth_luma_mainus8 serving as a value obtained by subtracting 8 from the bit depth of the luminance signal set to the SPS of the enhancement image can be limited to a value larger than bit_depth_luma_mainus8 set to the SPS of the base image. Further, bit_depth_chroma_mainus8 serving as a value obtained by subtracting 8 from the bit depth of the chrominance signal set to the SPS of the enhancement image can be limited to a value larger than bit_depth_chroma_mainus8 set to the SPS of the base image.

<Another Example of Scalable Coding>

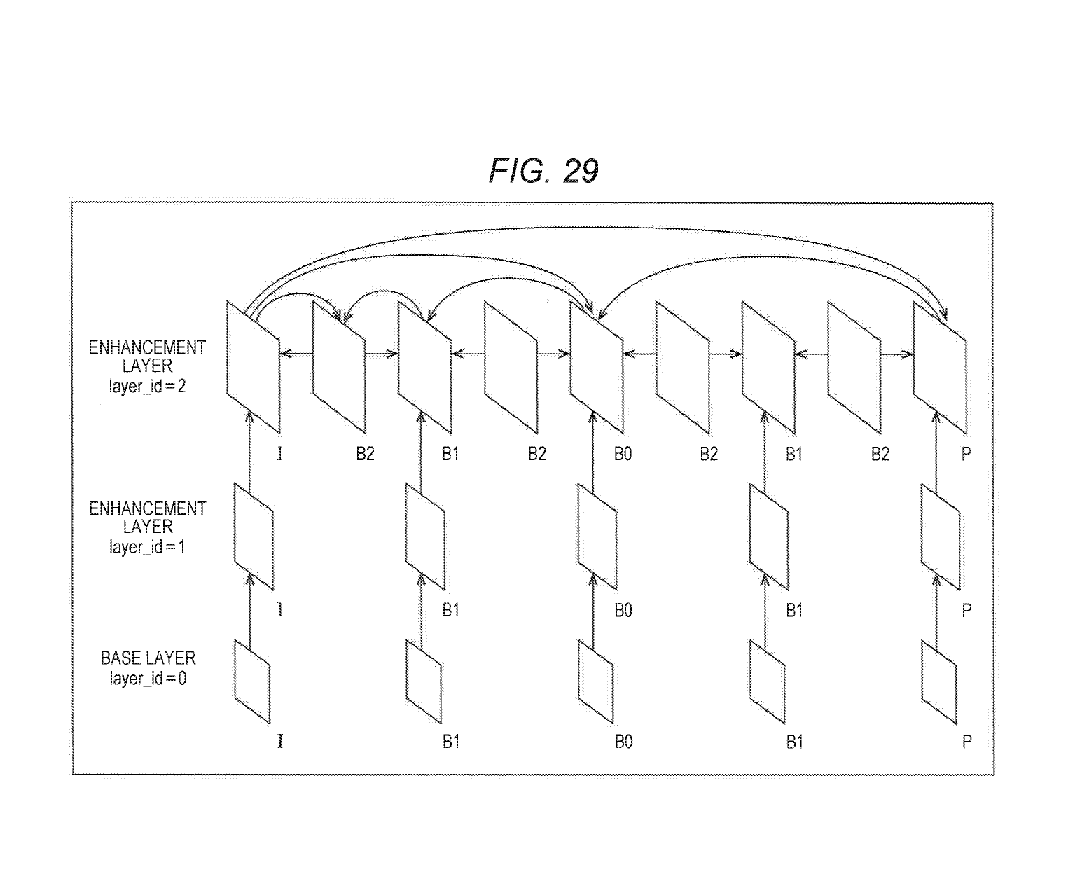

FIG. 29 illustrates another example of the scalable coding.

As illustrated in FIG. 29, in the scalable coding, a difference in a quantization parameter may be used in each layer (the same layer):

(1) base-layer:

(1-1) dQP (base layer)=Current_CU_QP (base layer)—LCU QP (base layer)

(1-2) dQP (base layer)=Current_CU_QP (base layer)—Previous_CU_QP (base layer)

(1-3) dQP (base layer)=Current_CU_QP (base layer)—Slice_QP (base layer)

(2) non-base-layer:

(2-1) dQP (non-base layer)=Current_CU_QP (non-base layer)—LCU_QP (non-base layer)

(2-2) dQP (non-base layer)=CurrentQP (non-base layer)—PreviousQP (non-base layer)

(2-3) dQP (non-base layer)=Current_CU_QP (non-base layer)—Slice_QP (non-base layer)

Further, in the respective layers (different layers), a difference in a quantization parameter may be used:

(3) base-layer/non-base layer:

(3-1) dQP (inter-layer)=Slice_QP (base layer)—Slice_QP (non-base layer)

(3-2) dQP (inter-layer)=LCU_QP (base layer)—LCU_QP (non-base layer)

(4) non-base layer/non-base layer:

(4-1) dQP (inter-layer)=Slice_QP (non-base layer i)—Slice_QP (non-base layer j)

(4-2) dQP (inter-layer)=LCU_QP (non-base layer i)—LCU_QP (non-base layer j)

In this case, a combination of (1) to (4) described above may be used. For example, in the non-base layer, a technique (a combination of 3-1 and 2-3) of using a difference in a quantization parameter at a slice level between the base layer and the non-base layer or a technique (a combination of 3-2 and 2-1) of using a difference in a quantization parameter at an LCU level between the base layer and the non-base layer is considered. As described above, by applying the difference repeatedly, the encoding efficiency can be improved even when the scalable coding is performed.

Similarly to the above-described technique, a flag identifying whether or not there is dQP having a non-zero value may be set to each dQP described above.

### Second Embodiment

### Description of Computer According to Present Disclosure

The above-described series of processes may be executed by hardware or software. When the series of processes are executed by software, a program configuring the software is installed in a computer. Here, examples of the computer includes a computer incorporated into dedicated hardware and a general purpose personal computer that includes various programs installed therein and is capable of executing various kinds of functions.

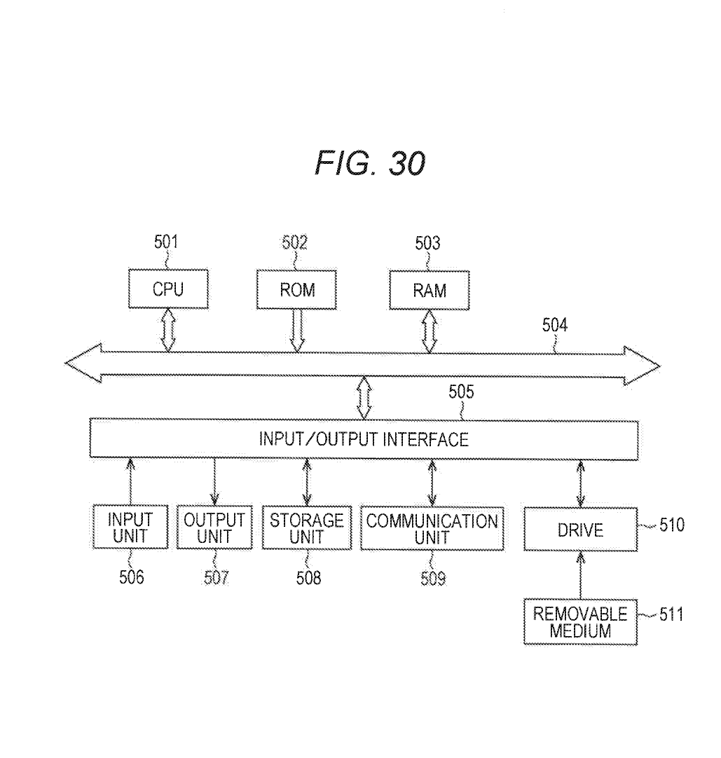

FIG. 30 is a block diagram illustrating an exemplary hardware configuration of a computer that executes the above-described series of processes by a program.

In a computer 500, a central processing unit (CPU) 501, a read only memory (ROM) 502, and a random access memory (RAM) 503 are connected with one another via a bus 504.

An input/output (I/O) interface 505 is further connected to the bus 504. An input unit 506, an output unit 507, a storage unit 508, a communication unit 509, and a drive 510 are connected to the I/O interface 505.

The input unit 506 includes a keyboard, a mouse, a microphone, and the like. The output unit 507 includes a display, a speaker, and the like. The storage unit 508 includes a hard disk, a non-volatile memory, and the like. The communication unit 509 includes a network interface or the like. The drive 510 drives a removable medium 511 such as a magnetic disk, an optical disk, a magneto optical disk, or a semiconductor memory.

In the computer 500 having the above configuration, the CPU 501 executes the above-described series of processes, for example, by loading the program stored in the storage unit 508 onto the RAM 503 through the I/O interface 505 and the bus 504 and executing the program.

For example, the program executed by the computer 500 (the CPU 501) may be recorded in the removable medium 511 as a package medium or the like and provided. Further, the program may be provided through a wired or wireless transmission medium such as a local area network (LAN), the Internet, or digital satellite broadcasting.

In the computer 500, the removable medium 511 is mounted to the drive 510, and then the program may be installed in the storage unit 508 through the I/O interface 505. Further, the program may be received by the communication unit 509 via a wired or wireless transmission medium and then installed in the storage unit 508. In addition, the program may be installed in the ROM 502 or the storage unit 508 in advance.

Further, the program executed by the computer 500 may be a program in which the processes are chronologically performed in the order described in this specification or may be a program in which the processes are performed in parallel or at necessary timings such as called timings.

### Third Embodiment

### Application to Multi-View Image Coding and Multi-View Image Decoding

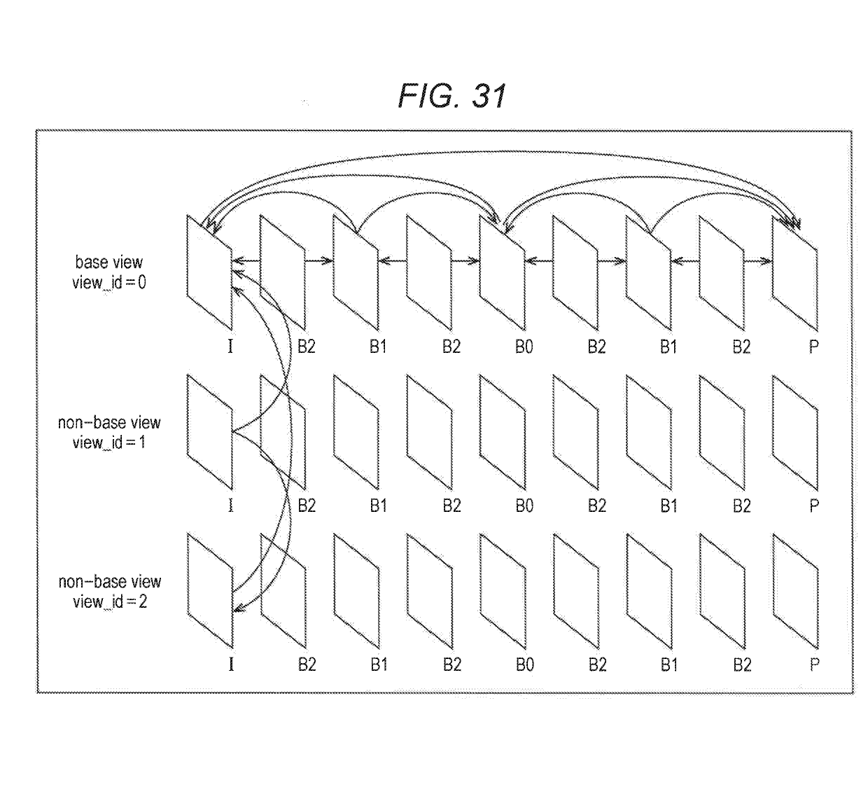

The above-described series of processes can be applied to multi-view image coding and multi-view image decoding. FIG. 31 illustrates an exemplary multi-view image coding scheme.

As illustrated in FIG. 31, a multi-view image includes images of a plurality of views. The plurality of views of the multi-view image include a base view in which encoding and decoding are performed using only an image of its own view without using images of other views and a non-base view in which encoding and decoding are performed using images of other views. As the non-base view, an image of a base view may be used, and an image of another non-base view may be used.

When the multi-view image of FIG. 31 is encoded and decoded, an image of each view is encoded and decoded, but the technique according to the first embodiment may be applied to encoding and decoding of respective views. Accordingly, it is possible to optimize encoding of the enhancement image when the profile of the base image is the main still picture profile or the all intra profile.

Furthermore, the flags or the parameters used in the technique according to the first embodiment may be shared in encoding and decoding of respective views. More specifically, for example, the syntax elements of the header portion may be shared in encoding and decoding of respective views. Of course, any other necessary information may be shared in encoding and decoding of respective views.

Accordingly, it is possible to prevent transmission of redundant information and reduce an amount (bit rate) of information to be transmitted (that is, it is possible to prevent coding efficiency from degrading.

(Multi-View Image Encoding Device)

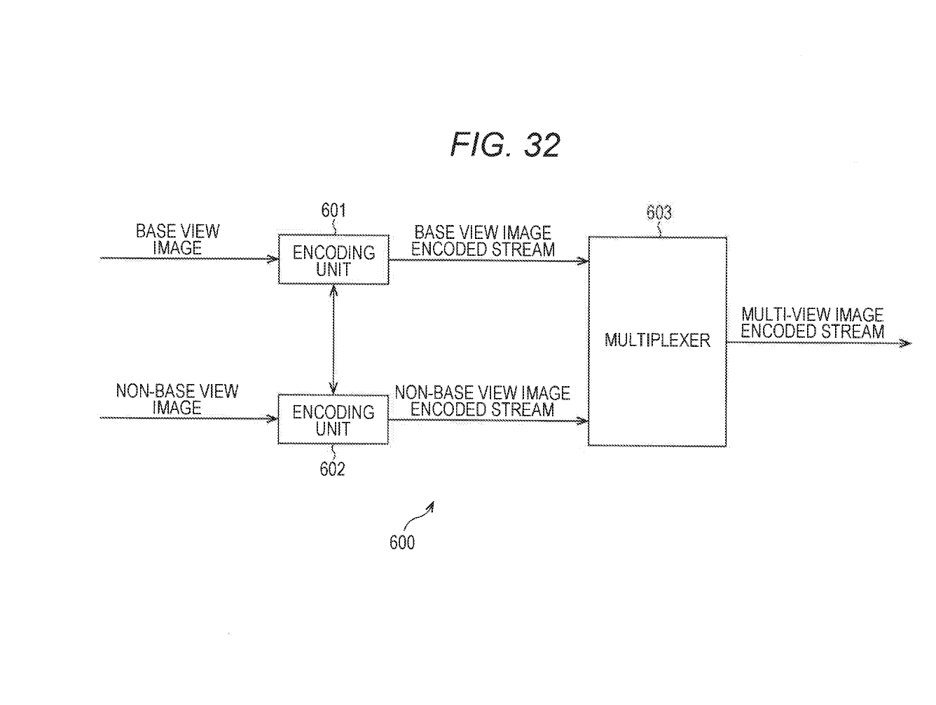

FIG. 32 is a diagram illustrating a multi-view image encoding device that performs the above-described multi-view image coding. A multi-view image encoding device 600 includes an encoding unit 601, an encoding unit 602, and a multiplexer 603 as illustrated in FIG. 32.

The encoding unit 601 encodes a base view image, and generates a base view image encoded stream. The encoding unit 602 encodes a non-base view image, and generates a non-base view image encoded stream. The multiplexer 603 performs multiplexing of the base view image encoded stream generated by the encoding unit 601 and the non-base view image encoded stream generated by the encoding unit 602, and generates a multi-view image encoded stream.

The encoding device 30 (FIG. 4) can be applied as the encoding unit 601 and the encoding unit 602 of the multi-view image encoding device 600. In other words, in encoding of each view, it is possible to optimize encoding of the enhancement image when the profile of the base image is the main still picture profile or the all intra profile. Further, the encoding unit 601 and the encoding unit 602 can perform encoding using the same flags or parameters (for example, syntax elements related to inter-image processing) (that is, can share the flags or the parameters), and thus it is possible to prevent the coding efficiency from degrading.

(Multi-View Image Decoding Device)

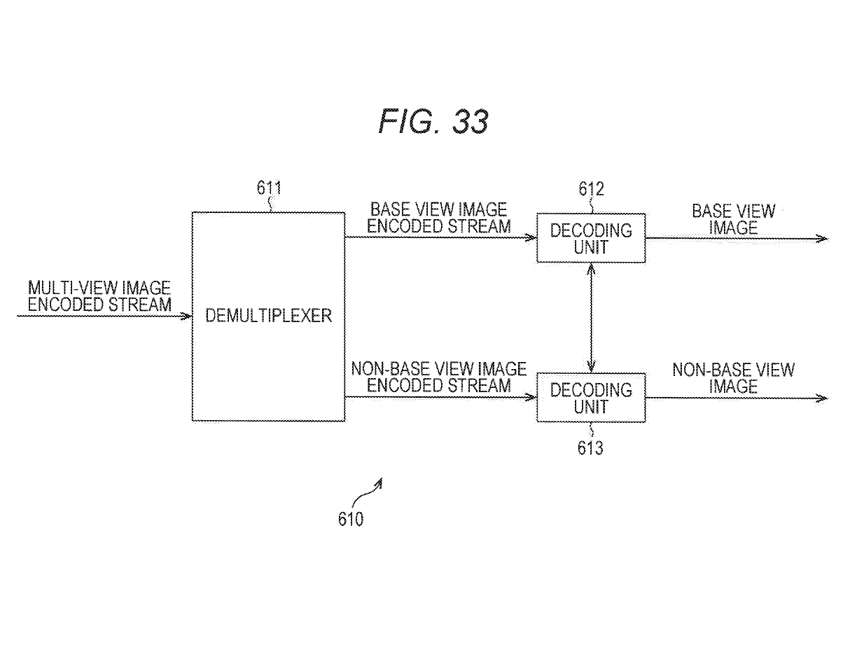

FIG. 33 is a diagram illustrating a multi-view image decoding device that performs the above-described multi-view image decoding. A multi-view image decoding device 610 includes a demultiplexer 611, a decoding unit 612, and a decoding unit 613 as illustrated in FIG. 33.

The demultiplexer 611 performs demultiplexing of the multi-view image encoded stream obtained by multiplexing the base view image encoded stream and the non-base view image encoded stream, and extracts the base view image encoded stream and the non-base view image encoded stream. The decoding unit 612 decodes the base view image encoded stream extracted by the demultiplexer 611, and obtains the base view image. The decoding unit 613 decodes the non-base view image encoded stream extracted by the demultiplexer 611, and obtains the non-base view image.

The decoding device 160 (FIG. 25) can be applied as the decoding unit 612 and the decoding unit 613 of the multi-view image decoding device 610. In other words, in decoding of each view, it is possible to decode the encoded data that is optimally encoded when the profile of the base image is the main still picture profile or the all intra profile. Further, the decoding unit 612 and the decoding unit 613 can perform decoding using the same flags or parameters (for example, syntax elements related to inter-image processing) (that is, can share the flags or the parameters), and thus it is possible to prevent the coding efficiency from degrading.

### Fourth Embodiment

### Application to Scalable Image Coding and Scalable Image Decoding

The above-described series of processes can be applied to scalable image coding and scalable image decoding (scalable coding and scalable decoding). FIG. 33 illustrates an exemplary scalable image coding scheme.

The scalable image coding (scalable coding) is a scheme in which an image is divided into a plurality of layers (hierarchized) so that image data has a scalable function for a certain parameter, and encoding is performed on each layer. The scalable image decoding (scalable decoding) is decoding corresponding to the scalable image coding.

As illustrated in FIG. 33, for hierarchization of an image, an image is divided into a plurality of images (layers) based on a certain parameter having a scalable function. In other words, a hierarchized image (a scalable image) includes images of a plurality of layers that differ in a value of the certain parameter from one another. The plurality of layers of the scalable image include a base layer in which encoding and decoding are performed using only an image of its own layer without using images of other layers and non-base layers (which are also refer red to as “enhancement layers”) in which encoding and decoding are performed using images of other layers. As the non-base layer, an image of the base layer may be used, and an image of any other non-base layer may be used.

Generally, the non-base layer is configured with data (differential data) of a differential image between its own image and an image of another layer so that the redundancy is reduced. For example, when one image is hierarchized into two layers, that is, a base layer and a non-base layer (which is also referred to as an enhancement layer), an image of a quality lower than an original image is obtained when only data of the base layer is used, and an original image (that is, a high quality image) is obtained when both data of the base layer and data of the non-base layer are combined.

As an image is hierarchized as described above, images of various qualities can be easily obtained depending on the situation. For example, for a terminal having a low processing capability such as a mobile phone, image compression information of only the base layer is transmitted, and a moving image of low spatial and temporal resolutions or a low quality is reproduced, and for a terminal having a high processing capability such as a television or a personal computer, image compression information of the enhancement layer as well as the base layer is transmitted, and a moving image of high spatial and temporal resolutions or a high quality is reproduced. In other words, without performing the transcoding process, image compression information according to a capability of a terminal or a network can be transmitted from a server.

When the scalable image illustrated in FIG. 33 is encoded and decoded, images of respective layers are encoded and decoded, but the technique according to the first embodiment may be applied to encoding and decoding of the respective layers. Accordingly, it is possible to optimize encoding of the enhancement image when the profile of the base image is the main still picture profile or the all intra profile.

Furthermore, the flags or the parameters used in the technique according to the first embodiment may be shared in encoding and decoding of respective layers. More specifically, for example, the syntax elements of the header portion may be shared in encoding and decoding of respective layers. Of course, any other necessary information may be shared in encoding and decoding of respective views.

Accordingly, it is possible to prevent transmission of redundant information and reduce an amount (bit rate) of information to be transmitted (that is, it is possible to prevent coding efficiency from degrading).

(Scalable Parameter)

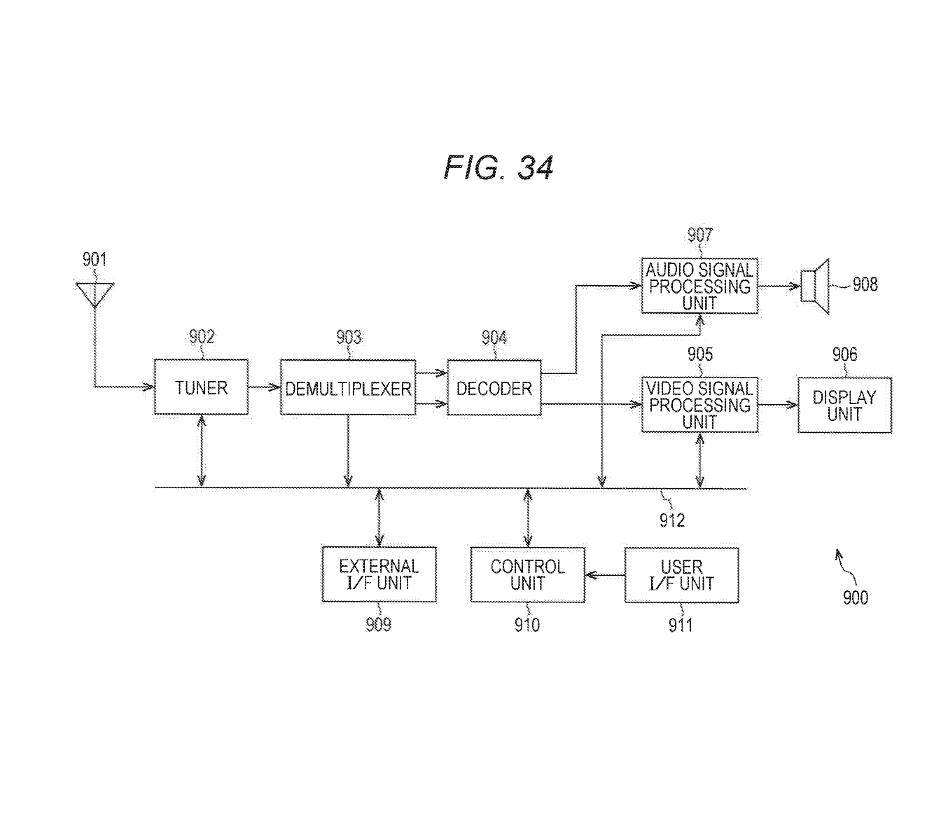

In the scalable image coding and the scalable image decoding (the scalable coding and the scalable decoding), any parameter has a scalable function. For example, a spatial resolution may be used as the parameter (spatial scalability) as illustrated in FIG. 34. In the case of the spatial scalability, respective layers have different image resolutions. In other words, in this case, each picture is hierarchized into two layers, that is, a base layer of a resolution spatially lower than that of an original image and an enhancement layer that is combined with the base layer to obtain an original spatial resolution as illustrated in FIG. 34. Of course, the number of layers is an example, and each picture can be hierarchized into an arbitrary number of layers.

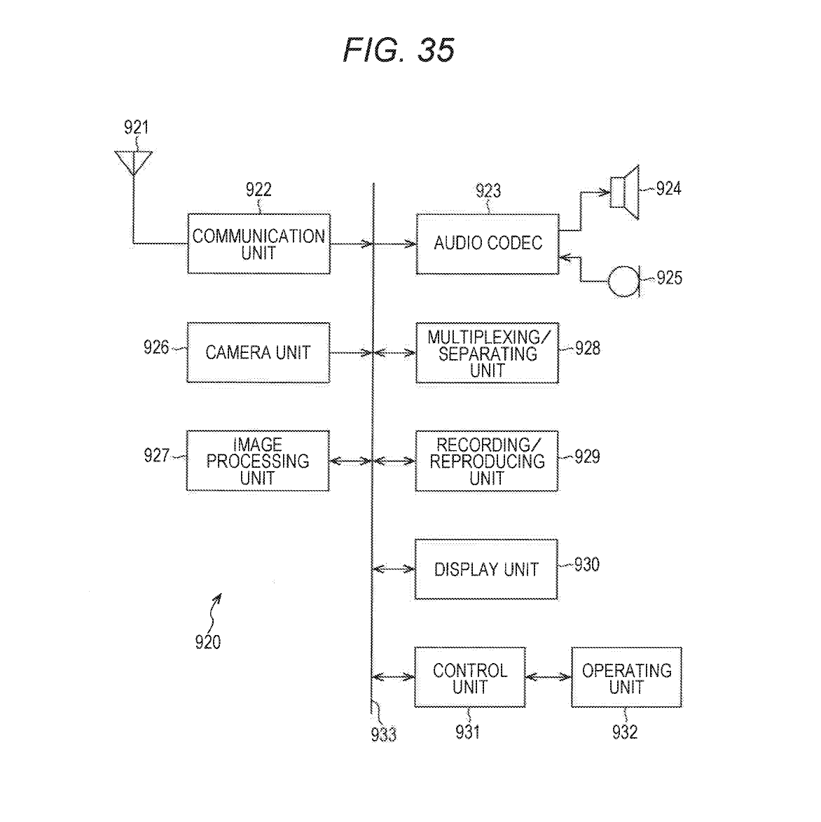

As another parameter having such scalability, for example, a temporal resolution may be applied (temporal scalability) as illustrated in FIG. 35. In the case of the temporal scalability, respective layers have different frame rates. In other words, in this case, each picture is hierarchized into two layers, that is, a base layer of a frame rate lower than that of an original moving image and an enhancement layer that is combined with the base layer to obtain an original frame rate as illustrated in FIG. 35. Of course, the number of layers is an example, and each picture can be hierarchized into an arbitrary number of layers.

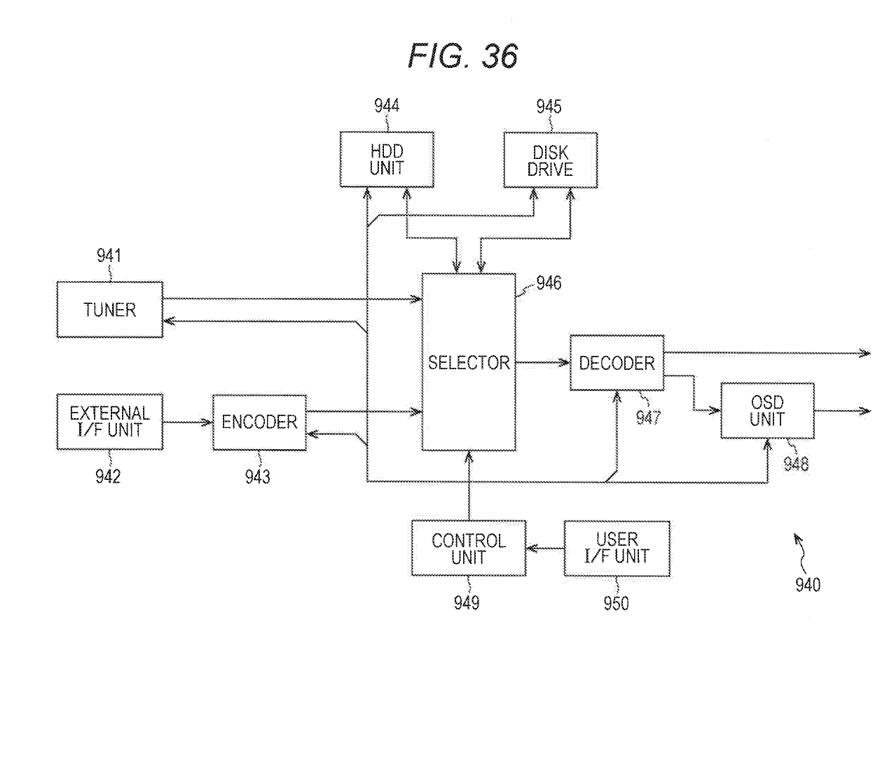

As another parameter having such scalability, for example, a signal-to-noise ratio (SNR) may be applied (SNR scalability). In the case of the SNR scalability, respective layers have different SNRs. In other words, in this case, each picture is hierarchized into two layers, that is, a base layer of a SNR lower than that of an original image and an enhancement layer that is combined with the base layer to obtain an original SNR as illustrated in FIG. 36. Of course, the number of layers is an example, and each picture can be hierarchized into an arbitrary number of layers.

A parameter other than the above-described examples may be applied as a parameter having scalability. For example, a bit depth may be used as a parameter having scalability (bit-depth scalability). In the case of the bit-depth scalability, respective layers have different bit depths. In this case, for example, the base layer includes an 8-bit image, and a 10-bit image can be obtained by adding the enhancement layer to the base layer.

As another parameter having scalability, for example, a chroma format may be used (chroma scalability). In the case of the chroma scalability, respective layers have different chroma formats. In this case, for example, the base layer (base layer) includes a component image of a 4:2:0 format, and a component image of a 4:2:2 format can be obtained by adding the enhancement layer to the base layer.

(Scalable Image Encoding Device)

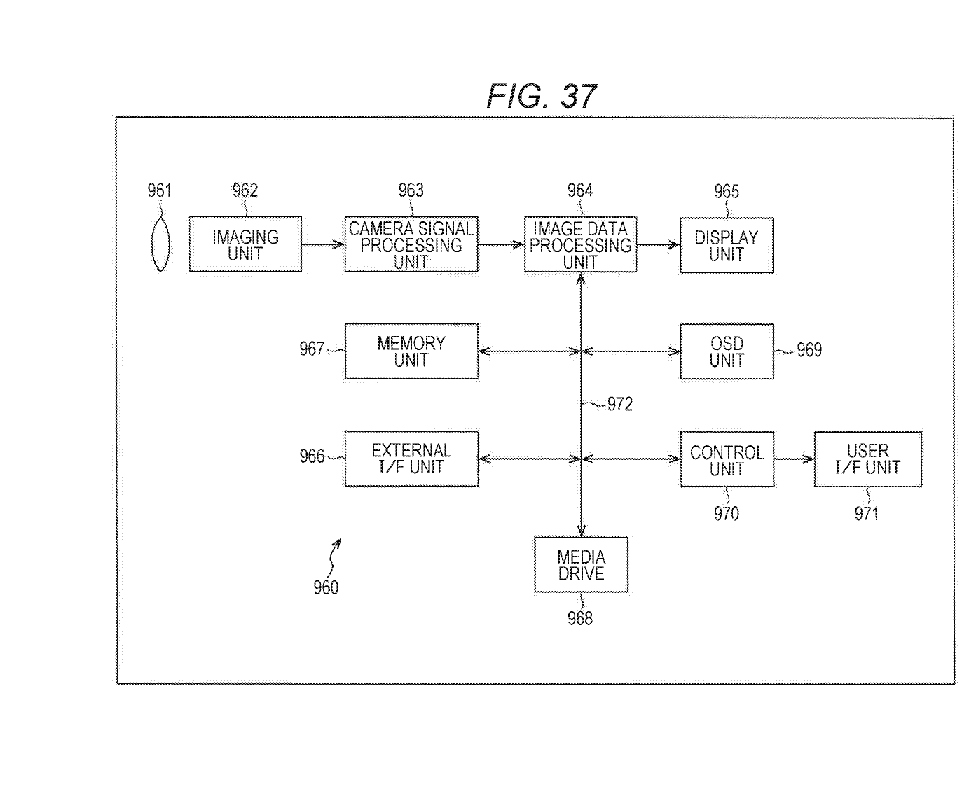

FIG. 37 is a diagram illustrating a scalable image encoding device that performs the above-described scalable image coding. A scalable image encoding device 620 includes an encoding unit 621, an encoding unit 622, and a multiplexer 623 as illustrated in FIG. 37.

The encoding unit 621 encodes a base layer image, and generates a base layer image encoded stream. The encoding unit 622 encodes a non-base layer image, and generates a non-base layer image encoded stream. The multiplexer 623 performs multiplexing of the base layer image encoded stream generated by the encoding unit 621 and the non-base layer image encoded stream generated by the encoding unit 622, and generates a scalable image encoded stream.

The encoding device 30 (FIG. 4) can be applied as the encoding unit 621 and the encoding unit 622 of the scalable image encoding device 620. In other words, in encoding of each layer, it is possible to optimize encoding of the enhancement image when the profile of the base image is the main still picture profile or the all intra profile. Further, the encoding unit 621 and the encoding unit 622 can perform, for example, control of an intra prediction filter process using the same flags or parameters (for example, syntax elements related to inter-image processing) (that is, can share the flags or the parameters), and thus it is possible to prevent the coding efficiency from degrading.

(Scalable Image Decoding Device)

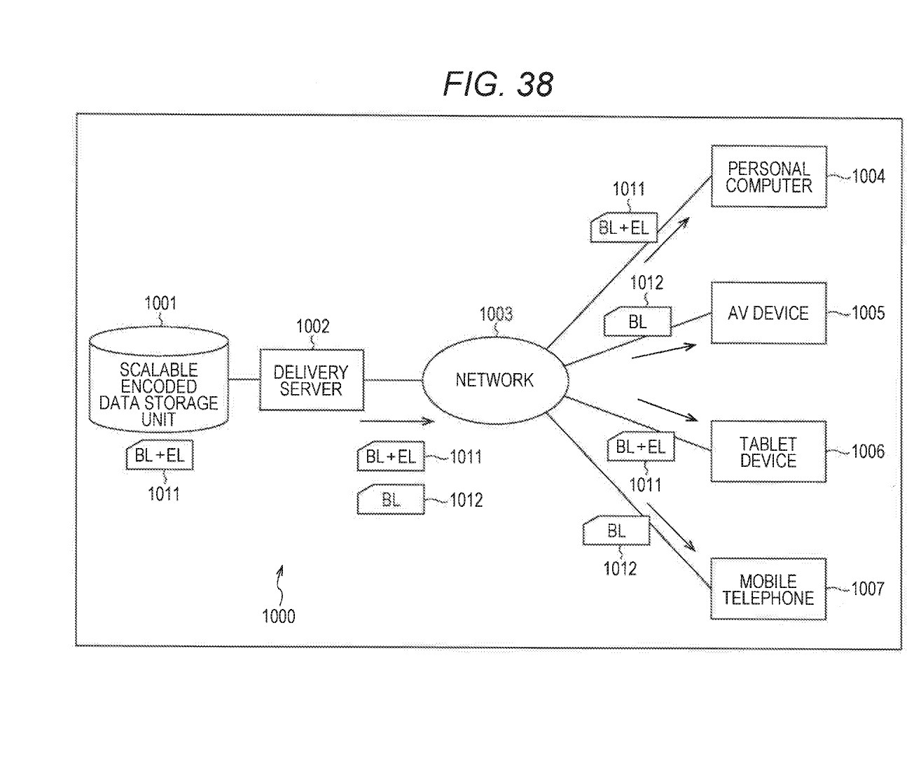

FIG. 38 is a diagram illustrating a scalable image decoding device that performs the above-described scalable image decoding. A scalable image decoding device 630 includes a demultiplexer 631, a decoding unit 632, and a decoding unit 633 as illustrated in FIG. 38.

The demultiplexer 631 performs demultiplexing of the scalable image encoded stream obtained by multiplexing the base layer image encoded stream and the non-base layer image encoded stream, and extracts the base layer image encoded stream and the non-base layer image encoded stream. The decoding unit 632 decodes the base layer image encoded stream extracted by the demultiplexer 631, and obtains the base layer image. The decoding unit 633 decodes the non-base layer image encoded stream extracted by the demultiplexer 631, and obtains the non-base layer image.

The decoding device 160 (FIG. 25) can be applied as the decoding unit 632 and the decoding unit 633 of the scalable image decoding device 630. In other words, in decoding of each layer, it is possible to decode the encoded data that is optimally encoded when the profile of the base image is the main still, picture profile or the all intra profile.

Further, the decoding unit 612 and the decoding unit 613 can perform decoding using the same flags or parameters (for example, syntax elements related to inter-image processing) (that is, can share the flags or the parameters), and thus it is possible to prevent the coding efficiency from degrading.

### Fifth Embodiment

### Exemplary Configuration of Television Device

FIG. 34 illustrates a schematic configuration of a television device to which the present technology is applied. A television device 900 includes an antenna 901, a tuner 902, a demultiplexer 903, a decoder 904, a video signal processing unit 905, a display unit 906, an audio signal processing unit 907, a speaker 908, and an external I/F unit 909. The television device 900 further includes a control unit 910, a user I/F unit 911, and the like.

The tuner 902 tunes to a desired channel from a broadcast wave signal received by the antenna 901, performs demodulation, and outputs an obtained encoded bitstream to the demultiplexer 903.

The demultiplexer 903 extracts video or audio packets of a program of a viewing target from the encoded bitstream, and outputs data of the extracted packets to the decoder 904. The demultiplexer 903 provides packets of data such as an electronic program guide (EPG) to the control unit 910. Further, when scrambling has been performed, descrambling is performed by the demultiplexer or the like.

The decoder 904 performs a decoding process of decoding the packets, and outputs video data and audio data generated by the decoding process to the video signal processing unit 905 and the audio signal processing unit 907, respectively.

The video signal processing unit 905 performs a noise canceling process or video processing according to a user setting on the video data. The video signal processing unit 905 generates video data of a program to be displayed on the display unit 906, image data according to processing based on an application provided via a network, or the like. The video signal processing unit 905 generates video data for displaying, for example, a menu screen used to select an item, and causes the video data to be superimposed on video data of a program. The video signal processing unit 905 generates a drive signal based on the video data generated as described above, and drives the display unit 906.

The display unit 906 drives a display device (for example, a liquid crystal display device or the like) based on the drive signal provided from the video signal processing unit 905, and causes a program video or the like to be displayed.

The audio signal processing unit 907 performs a certain process such as a noise canceling process on the audio data, performs a digital to analog (D/A) conversion process and an amplification process on the processed audio data, and provides resultant data to the speaker 908 to output a sound.

The external I/F unit 909 is an interface for a connection with an external device or a network, and performs transmission and reception of data such as video data or audio data.

The user I/F unit 911 is connected with the control unit 910. The user I/F unit 911 includes an operation switch, a remote control signal receiving unit, and the like, and provides an operation signal according to the user's operation to the control unit 910.

The control unit 910 includes a central processing unit (CPU), a memory, and the like. The memory stores a program executed by the CPU, various kinds of data necessary when the CPU performs processing, EPG data, data acquired via a network, and the like. The program stored in the memory is read and executed by the CPU at a certain timing such as a timing at which the television device 900 is activated. The CPU executes the program, and controls the respective units such that the television device 900 is operated according to the user's operation.

The television device 900 is provided with a bus 912 that connects the tuner 902, the demultiplexer 903, the video signal processing unit 905, the audio signal processing unit 907, the external I/F unit 909, and the like with the control unit 910.

in the television device having the above configuration, the decoder 904 is provided with the function of the decoding device (decoding method) according to the present application. Thus, it is possible to decode the encoded data that is optimally encoded when the profile of the base image is the main still picture profile or the all intra profile.

### Sixth Embodiment

### Exemplary Configuration of Mobile Telephone

FIG. 35 illustrates a schematic configuration of a mobile telephone to which the present technology is applied. A mobile telephone 920 includes a communication unit 922, an audio codec 923, a camera unit 926, an image processing unit 927, a multiplexing/separating unit 928, a recording/reproducing unit 929, a display unit 930, and a control unit 931. These units are connected with one another via a bus 933.

Further, an antenna 921 is connected to the communication unit. 922, and a speaker 924 and a microphone 925 are connected to the audio codec 923. Further, an operating unit 932 is connected to the control unit 931.

The mobile telephone 920 performs various kinds of operations such as transmission and reception of a voice signal, transmission and reception of an electronic mail or image data, image capturing, or data recording in various modes such as a voice call mode and a data communication mode.

In the voice call mode, a voice signal generated by the microphone 925 is converted to voice data through the audio codec 923, compressed, and then provided to the communication unit 922. The communication unit 922 performs, for example, a modulation process and a frequency transform process of the voice data, and generates a transmission signal. Further, the communication unit 922 provides the transmission signal to the antenna 921 so that the transmission signal is transmitted to a base station (not illustrated). Further, the communication unit 922 performs an amplification process, a frequency transform process, and a demodulation process of a reception signal received through the antenna 921, and provides the obtained voice data to the audio codec 923. The audio codec 923 decompresses the voice data, converts the compressed data to an analog voice signal, and outputs the analog voice signal to the speaker 924.

In the data communication mode, when mail transmission is performed, the control unit 931 receives text data input by operating the operating unit 932, and causes the input text to be displayed on the display unit 930. Further, the control unit 931 generates mail data, for example, based on a user instruction input through the operating unit 932, and provides the mail data to the communication unit 922. The communication unit 922 performs, for example, a modulation process and a frequency transform process of the mail data, and transmits an obtained transmission signal through the antenna 921. Further, the communication unit 922 performs, for example, an amplification process, a frequency transform process, and a demodulation process of a reception signal received through the antenna 921, and restores the mail data. The mail data is provided to the display unit 930 so that mail content is displayed.

The mobile telephone 920 can store the received mail data in a storage medium through the recording/reproducing unit 929. The storage medium is an arbitrary rewritable storage medium. Examples of the storage medium include a semiconductor memory such as a RAM or an internal flash memory, a hard disk, a magnetic disk, a magneto optical disk, an optical disk, and a removable medium such as a universal serial bus (USB) memory or a memory card.

In the data communication mode, when image data is transmitted, image data generated through the camera unit 926 is provided to the image processing unit 927. The image processing unit 927 performs an encoding process of encoding the image data, and generates encoded data.

The multiplexing/separating unit 928 multiplexes the encoded data generated through the image processing unit 927 and the voice data provided from the audio codec 923 according to a certain scheme, and provides resultant data to the communication unit 922. The communication unit 922 performs, for example, a modulation process and a frequency transform process of the multiplexed data, and transmits an obtained transmission signal through the antenna 921. Further, the communication unit 922 performs, for example, an amplification process, a frequency transform process, and a demodulation process of a reception signal received through the antenna 921, and restores multiplexed data. The multiplexed data is provided to the multiplexing/separating unit 928. The multiplexing/separating unit 928 demultiplexes the multiplexed data, and provides the encoded data and the voice data to the image processing unit 927 and the audio codec 923, respectively. The image processing unit 927 performs a decoding process of decoding the encoded data, and generates image data. The image data is provided to the display unit 930 so that a received image is displayed. The audio codec 923 converts the voice data into an analog voice signal, provides the analog voice signal to the speaker 924, and outputs a received voice.

In the mobile telephone device having the above configuration, the image processing unit 927 is provided with the functions of the encoding device and the decoding device (the encoding method and the decoding method) according to the present application. Thus, it is possible to optimize encoding of the enhancement image when the profile of the base image is the main still picture profile or the all intra profile. Further, it is possible to decode the encoded data that is optimally encoded when the profile of the base image is the main still picture profile or the all intra profile.

### Seventh Embodiment

### Exemplary Configuration of Recording/Reproducing Device

FIG. 36 illustrates a schematic configuration of a recording/reproducing device to which the present technology is applied. A recording/reproducing device 940 records, for example, audio data and video data of a received broadcast program in a recording medium, and provides the recorded data to the user at a timing according to the user's instruction. Further, the recording/reproducing device 940 can acquire, for example, audio data or video data from another device and cause the acquired data to be recorded in a recording medium. Furthermore, the recording/reproducing device 940 decodes and outputs the audio data or the video data recorded in the recording medium so that an image display or a sound output can be performed in a monitor device, and the like.

The recording/reproducing device 940 includes a tuner 941, an external I/F unit 942, an encoder 943, a hard disk drive (HDD) unit 944, a disk drive 945, a selector 946, a decoder 947, an on-screen display (OSD) unit 948, a control unit 949, and a user I/F unit 950.

The tuner 941 tunes to a desired channel from a broadcast signal received through an antenna (not illustrated). The tuner 941 demodulates a reception signal of the desired channel, and outputs an obtained encoded bitstream to the selector 946.

The external I/F unit 942 is configured with at least one of an IEEE1394 interface, a network interface, a USB interface, a flash memory interface, and the like. The external I/F unit 942 is an interface for a connection with an external device, a network, a memory card, and the like, and receives data such as video data to audio data to be recorded.

The encoder 943 encodes non-encoded video data or audio data provided from the external I/F unit 942 according to a certain scheme, and outputs an encoded bitstream to the selector 946.

The HDD unit 944 records content data such as a video or a sound, various kinds of programs, and other data in an internal hard disk, and reads recorded data from the hard disk at the time of reproduction or the like.

The disk drive 945 records a signal in a mounted optical disk, and reproduces a signal from the optical disk. Examples of the optical disk include a DVD disk (DVD-Video, DVD-RAM, DVD-R, DVD-RW, DVD+R, DVD+RW, and the like) and a Blu-ray (a registered trademark) disk.

When a video or a sound is recorded, the selector 946 selects either of an encoded bitstream provided from the tuner 941 or an encoded bitstream provided from the encoder 943, and provides the selected encoded bitstream to either of the HDD unit 944 or the disk drive 945. Further, when a video or a sound is reproduced, the selector 946 provides the encoded bitstream output from the HDD unit 944 or the disk drive 945 to the decoder 947.

The decoder 947 performs the decoding process of decoding the encoded bitstream. The decoder 947 provides video data generated by performing the decoding process to the OSD unit 948. Further, the decoder 947 outputs audio data generated by performing the decoding process.

The OSD unit 948 generates video data used to display, for example, a menu screen used to, for example, select an item, and outputs the video data to be superimposed on the video data output from the decoder 947.

The user I/F unit 950 is connected to the control unit 949. The user I/F unit 950 includes an operation switch, a remote control signal receiving unit, and the like, and provides an operation signal according to the user's operation to the control unit 949.

The control unit 949 is configured with a CPU, a memory, and the like. The memory stores a program executed by the CPU and various kinds of data necessary when the CPU performs processing. The program stored in the memory is read and executed by the CPU at a certain timing such as a timing at which the recording/reproducing device 940 is activated. The CPU executes the program, and controls the respective units such that the recording/reproducing device 940 is operated according to the user's operation.

In the recording/reproducing device having the above configuration, the decoder 947 is provided with the function of the decoding device (decoding method) according to the present application. Thus, it is possible to decode the encoded data that is optimally encoded when the profile of the base image is the main still picture profile or the all intra profile.

### Eighth Embodiment

### Exemplary Configuration of Imaging Device

FIG. 37 illustrates a schematic configuration of an imaging device to which the present technology is applied. An imaging device 960 photographs a subject, and causes an image of the subject to be displayed on a display unit or records image data in a recording medium.

The imaging device 960 includes an optical block 961, an imaging unit 962, a camera signal processing unit 963, an image data processing unit 964, a display unit 965, an external I/F unit 966, a memory unit 967, a media drive 968, an OSD unit 969, and a control unit 970. Further, a user I/F unit 971 is connected to the control unit 970. Furthermore, the image data processing unit 964, the external I/F unit 966, the memory unit 967, the media drive 968, the OSD unit 969, the control unit 970, and the like are connected with one another via a bus 972.

The optical block 961 is configured with a focus lens, a diaphragm mechanism, and the like. The optical block 961 forms an optical image of a subject on an imaging plane of the imaging unit 962. The imaging unit 962 is configured with a CCD image sensor or a CMOS image sensor, and generates an electrical signal according to an optical image obtained by photoelectric conversion, and provides the electrical signal to the camera signal processing unit 963.

The camera signal processing unit 963 performs various kinds of camera signal processes such as knee correction, gamma correction, and color correction on the electrical signal provided from the imaging unit 962. The camera signal processing unit 963 provides the image data that has been subjected to the camera signal processes to the image data processing unit 964.

The image data processing unit 964 performs the encoding process of encoding the image data provided from the camera signal processing unit 963. The image data processing unit 964 provides encoded data generated by performing the encoding process to the external I/F unit 966 or the media drive 968. Further, the image data processing unit 964 performs the decoding process of decoding encoded data provided from the external I/F unit 966 or the media drive 968. The image data processing unit 964 provides image data generated by performing the decoding process to the display unit 965. Further, the image data processing unit 964 performs a process of providing the image data provided from the camera signal processing unit 963 to the display unit 965, or provides display data acquired from the OSD unit 969 to the display unit 965 to be superimposed on image data.

The OSD unit 969 generates a menu screen including a symbol, a text, or a diagram or display data such as an icon, and outputs the generated menu screen or the display data to the image data processing unit 964.

The external I/F unit 966 is configured with, for example, an USB I/O terminal or the like, and connected with a printer when an image is printed. Further, a drive is connected to the external I/F unit 966 as necessary, a removable medium such as a magnetic disk or an optical, disk is appropriately mounted, and a computer program read from the removable medium is installed as necessary. Furthermore, the external I/F unit 966 includes a network interface connected to a certain network such as an IAN or the Internet. The control unit 970 can read encoded data from the media drive 968, for example, according to an instruction given through the user I/F unit 971 and provide the read encoded data to another device connected via a network through the external I/F unit 966. Further, the control unit 970 can acquire encoded data or image data provided from another device via a network through the external I/F unit 966 and provide the acquire encoded data or the image data to the image data processing unit 964.

As a recording media driven by the media drive 968, for example, an arbitrary readable/writable removable medium such as a magnetic disk, a magneto optical disk, an optical disk, or a semiconductor memory is used. Further, the recording medium may be a tape device, a disk, or a memory card regardless of a type of a removable medium. Of course, the recording medium may be a non-contact integrated circuit (IC) card or the like.

Further, the media drive 968 may be integrated with the recording medium to configure a non-portable storage medium such as an internal HDD or a solid state drive (SSD).

The control unit 970 is configured with a CPU. The memory unit 967 stores a program executed by the control unit 970, various kinds of data necessary when the control unit 970 performs processing, and the like. The program stored in the memory unit 967 is read and executed by the control unit 970 at a certain timing such as a timing at which the imaging device 960 is activated. The control unit 970 executes the program, and controls the respective units such that the imaging device 960 is operated according to the user's operation.

In the imaging device having the above configuration, the image data processing unit 964 is provided with the functions of the encoding device and the decoding device (the encoding method and the decoding method) according to the present application. Thus, it is possible to optimize encoding of the enhancement image when the profile of the base image is the main still picture profile or the all intra profile. Further, it is possible to decode the encoded data that is optimally encoded when the profile of the base image is the main still picture profile or the all intra profile.

<Applications of Scalable Coding>

(First System)

Next, specific application examples of scalable encoded data generated by scalable coding will be described. The scalable coding is used for selection of data to be transmitted, for example, as illustrated in FIG. 38.

In a data transmission system 1000 illustrated in FIG. 38, a delivery server 1002 reads scalable encoded data stored in a scalable encoded data storage unit 1001, and delivers the scalable encoded data to terminal devices such as a personal computer 1004, an AV device 1005, a tablet device 1006, and a mobile telephone 1007 via a network 1003.

At this time, the delivery server 1002 selects an appropriate high-quality encoded data according to the capabilities of the terminal devices or a communication environment, and transmits the selected high-quality encoded data. Although the delivery server 1002 transmits unnecessarily high-quality data, the terminal devices do not necessarily obtain a high-quality image, and a delay or an overflow may occur. Further, a communication band may be unnecessarily occupied, and a load of a terminal device may be unnecessarily increased. On the other hand, although the delivery server 1002 transmits unnecessarily low-quality data, the terminal devices are unlikely to obtain an image of a sufficient quality. Thus, the delivery server 1002 reads scalable encoded data stored in the scalable encoded data storage unit 1001 as encoded data of a quality appropriate for the capability of the terminal device or a communication environment, and then transmits the read data.

For example, the scalable encoded data storage unit 1001 is assumed to store scalable encoded data (BL+EL) 1011 that is encoded by the scalable coding. The scalable encoded data (BL+EL) 1011 is encoded data including both of a base layer and an enhancement layer, and both an image of the base layer and an image of the enhancement layer can be obtained by decoding the scalable encoded data (BL+EL) 1011.

The delivery server 1002 selects an appropriate layer according to the capability of a terminal device to which data is transmitted or a communication environment, and reads data of the selected layer. For example, for the personal computer 1004 or the tablet device 1006 having a high processing capability, the delivery server 1002 reads the high-quality scalable encoded data (BL+EL) 1011 from the scalable encoded data storage unit 1001, and transmits the scalable encoded data (BL+EL) 1011 without change. On the other hand, for example, for the AV device 1005 or the mobile telephone 1007 having a low processing capability, the delivery server 1002 extracts data of the base layer from the scalable encoded data (BL+EL) 1011, and transmits a scalable encoded data (BL) 1012 that is the same content as the scalable encoded data (BL+EL) 1011 but lower in quality than the scalable encoded data (BL+EL) 1011.

As described above, an amount of data can be easily adjusted using scalable encoded data, and thus it is possible to prevent the occurrence of a delay or an overflow and prevent a load of a terminal device or a communication medium from being unnecessarily increased. Further, the scalable encoded data (BL+EL) 1011 is reduced in redundancy between layers, and thus it is possible to reduce an amount of data to be smaller than when individual data is used as encoded data of each layer. Thus, it is possible to more efficiently use a memory area of the scalable encoded data storage unit 1001.

Further, various devices such as the personal computer 1004 to the mobile telephone 1007 can be applied as the terminal device, and thus the hardware performance of the terminal devices differ according to each device. Further, since various applications can be executed by the terminal devices, software has various capabilities. Furthermore, all communication line networks including either or both of a wired network and a wireless network such as the Internet or a local area network (LAN), can be applied as the network 1003 serving as a communication medium, and thus various data transmission capabilities are provided. In addition, a change may be made by another communication or the like.

In this regard, the delivery server 1002 may be configured to perform communication with a terminal device serving as a transmission destination of data before starting data transmission and obtain information related to a capability of a terminal device such as hardware performance of a terminal device or a performance of an application (software) executed by a terminal device and information related to a communication environment such as an available bandwidth of the network 1003. Then, the delivery server 1002 may select an appropriate layer based on the obtained information.

Further, the extracting of the layer may be performed in a terminal device. For example, the personal computer 1004 may decode the transmitted scalable encoded data (BL+EL) 1011 and display the image of the base layer or the image of the enhancement layer. Further, for example, the personal computer 1004 may extract the scalable encoded data (BL) 1.01.2 of the base layer from the transmitted scalable encoded data (BL+EL) 1011, store the scalable encoded data (BL) 1012 of the base layer, transfer the scalable encoded data (BL) 1012 of the base layer to another device, decode the scalable encoded data (BL) 1012 of the base layer, and display the image of the base layer.

Of course, the number of the scalable encoded data storage units 1001, the number of the delivery servers 1002, the number of the networks 1003, and the number of terminal devices are arbitrary. The above description has been made in connection with the example in which the delivery server 1002 transmits data to the terminal devices, but the application example is not limited to this example. The data transmission system 1000 can be applied to any system in which when encoded data generated by the scalable coding is transmitted to a terminal device, an appropriate layer is selected according to a capability of a terminal device or a communication environment, and the encoded data is transmitted.

(Second System)

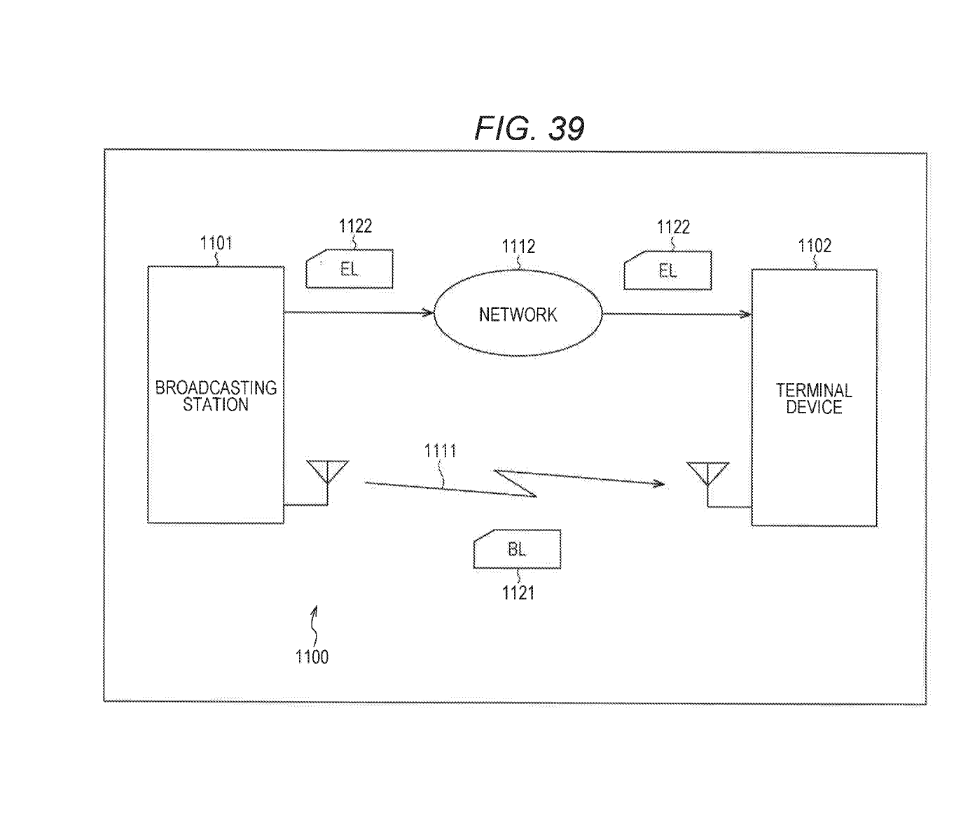

The scalable coding is used for transmission using a plurality of communication media, for example, as illustrated in FIG. 39.

In a data transmission system 1100 illustrated in FIG. 39, a broadcasting station 1101 transmits scalable encoded data (BL) 1121 of abase layer through terrestrial broadcasting 1111. Further, the broadcasting station 1101 transmits scalable encoded data (EL) 1122 of an enhancement layer (for example, packetizes the scalable encoded data (EL) 1122 and then transmits resultant packets) via an arbitrary network 1112 configured with a communication network including either or both of a wired network and a wireless network.

A terminal device 1102 has a reception function of receiving the terrestrial broadcasting 1111 broadcast by the broadcasting station 1101, and receives the scalable encoded data (BL) 1121 of the base layer transmitted through the terrestrial broadcasting 1111. The terminal device 1102 further has a communication function of performing communication via the network 1112, and receives the scalable encoded data (EL) 1122 of the enhancement layer transmitted via the network 1112.

The terminal device 1102 decodes the scalable encoded data (BL) 1121 of the base layer acquired through the terrestrial broadcasting 1111, for example, according to the user's instruction or the like, obtains the image of the base layer, stores the obtained image, and transmits the obtained image to another device.

Further, the terminal device 1102 combines the scalable encoded data (BL) 1121 of the base layer acquired through the terrestrial broadcasting 1111 with the scalable encoded data (EL) 1122 of the enhancement layer acquired through the network 1112, for example, according to the user's instruction or the like, obtains the scalable encoded data (BL+EL), decodes the scalable encoded data (BL+EL) to obtain the image of the enhancement layer, stores the obtained image, and transmits the obtained image to another device.

As described above, it is possible to transmit scalable encoded data of respective layers, for example, through different communication media. Thus, it is possible to distribute a load, and it is possible to prevent the occurrence of a delay or an overflow.

Further, it is possible to select a communication medium used for transmission for each layer according to the situation. For example, the scalable encoded data (BL) 1121 of the base layer having a relative large amount of data may be transmitted through a communication medium having a large bandwidth, and the scalable encoded data (EL) 1122 of the enhancement layer having a relative small amount of data may be transmitted through a communication medium having a small bandwidth. Further, for example, a communication medium for transmitting the scalable encoded data (EL) 1122 of the enhancement layer may be switched between the network 1112 and the terrestrial broadcasting 1111 according to an available bandwidth of the network 1112. Of course, the same applies to data of an arbitrary layer.

As control is performed as described above, it is possible to further suppress an increase in a load in data transmission.

Of course, the number of layers is arbitrary, and the number of communication media used for transmission is also arbitrary. Further, the number of the terminal devices 1102 serving as a data delivery destination is also arbitrary. The above description has been made in connection with the example of broadcasting from the broadcasting station 1101, and the application example is not limited to this example. The data transmission system 1100 can be applied to any system in which encoded data generated by the scalable coding is divided into two or more in units of layers and transmitted through a plurality of lines.

(Third System)

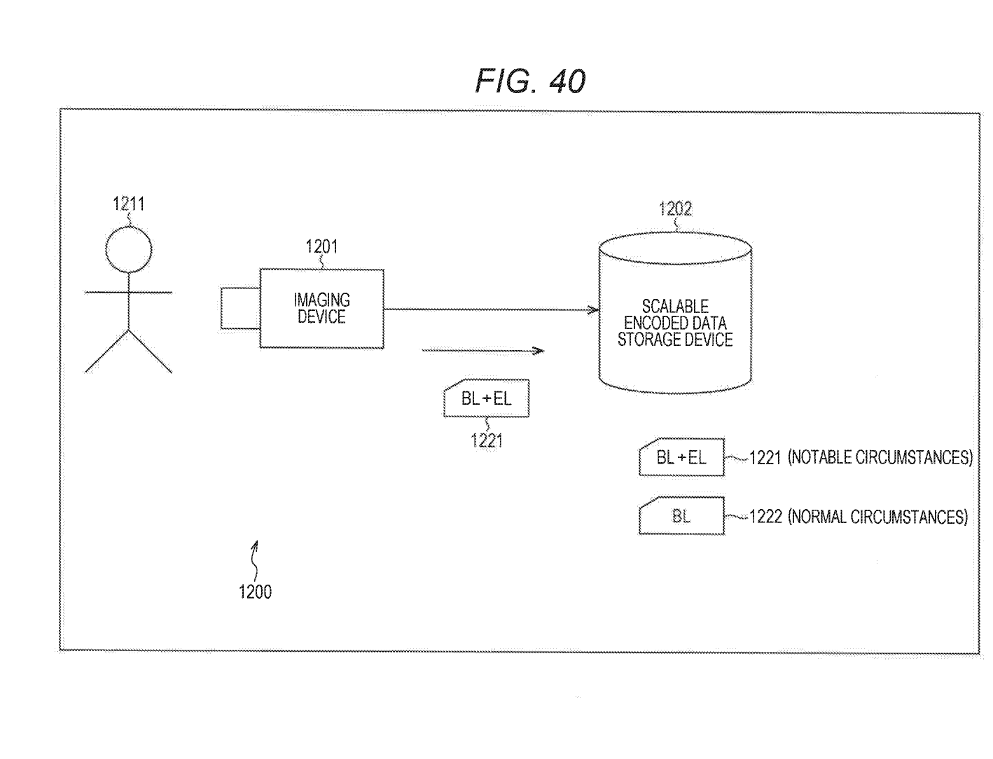

The scalable coding is used for storage of encoded data, for example, as illustrated in FIG. 40.

In an imaging system 1200 illustrated in FIG. 40, an imaging device 1201 photographs a subject 1211, performs the scalable coding on obtained image data, and provides scalable encoded data (BL+EL) 1221 to a scalable encoded data storage device 1202.

The scalable encoded data storage device 1202 stores the scalable encoded data (BL+EL) 1221 provided from the imaging device 1201 in a quality according to the situation. For example, during a normal time, the scalable encoded data storage device 1202 extracts data of the base layer from the scalable encoded data (BL+EL) 1221, and stores the extracted data as scalable encoded data (BL) 1.222 of the base layer having a small amount of data in a low quality. On the other hand, for example, during an observation time, the scalable encoded data storage device 1202 stores the scalable encoded data (BL+EL) 1221 having a large amount of data in a high quality without change.

Accordingly, the scalable encoded data storage device 1202 can store an image in a high quality only when necessary, and thus it is possible to suppress an increase in an amount of data and improve use efficiency of a memory area while suppressing a reduction in a value of an image caused by quality deterioration.

For example, the imaging device 1201 is a monitoring camera. When monitoring target (for example, intruder) is not shown on a photographed image (during a normal time), content of the photographed image is likely to be inconsequential, and thus a reduction in an amount of data is prioritized, and image data (scalable encoded data) is stored in a low quality. On the other hand, when a monitoring target is shown on a photographed image as the subject 1211 (during an observation time), content of the photographed image is likely to be consequential, and thus an image quality is prioritized, and image data (scalable encoded data) is stored in a high quality.

It may be determined whether it is the normal time or the observation time, for example, by analyzing an image through the scalable encoded data storage device 1202. Further, the imaging device 1201 may perform the determination and transmit the determination result to the scalable encoded data storage device 1202.

Further, a determination criterion as to whether it is the normal time or the observation time is arbitrary, and content of an image serving as the determination criterion is arbitrary. Of course, a condition other than content of an image may be a determination criterion. For example, switching may be performed according to the magnitude or a waveform of a recorded sound, switching may be performed at certain time intervals, or switching may be performed according an external instruction such as the user's instruction.

The above description has been made in connection with the example in which switching is performed between two states of the normal time and the observation time, but the number of states is arbitrary. For example, switching may be performed among three or more states such as a normal time, a low-level observation time, an observation time, a high-level observation time, and the like. Here, an upper limit number of states to be switched depends on the number of layers of scalable encoded data.

Further, the imaging device 1201 may decide the number of layers for the scalable coding according to a state. For example, during the normal time, the imaging device 1201 may generate the scalable encoded data (BL) 1222 of the base layer having a small amount of data in a low quality and provide the scalable encoded data (BL) 1222 of the base layer to the scalable encoded data storage device 1202. Further, for example, during the observation time, the imaging device 1201 may generate the scalable encoded data (BL+EL) 1221 of the base layer having a large amount of data in a high quality and provide the scalable encoded data (BL+EL) 1221 of the base layer to the scalable encoded data storage device 1202.

The above description has been made in connection with the example of a monitoring camera, but the purpose of the imaging system 1200 is arbitrary and not limited to a monitoring camera.

### Ninth Embodiment

### Other Embodiments

The above embodiments have been described in connection with the example of the device, the system, or the like according to the present technology, but the present technology is not limited to the above examples and may be implemented as any component mounted in the device or the device configuring the system, for example, a processor serving as a system (large scale integration) LSI or the like, a module using a plurality of processors or the like, a unit using a plurality of modules or the like, a set (that is, some components of the device) in which any other function is further added to a unit, or the like.

(Exemplary Configuration of Video Set)

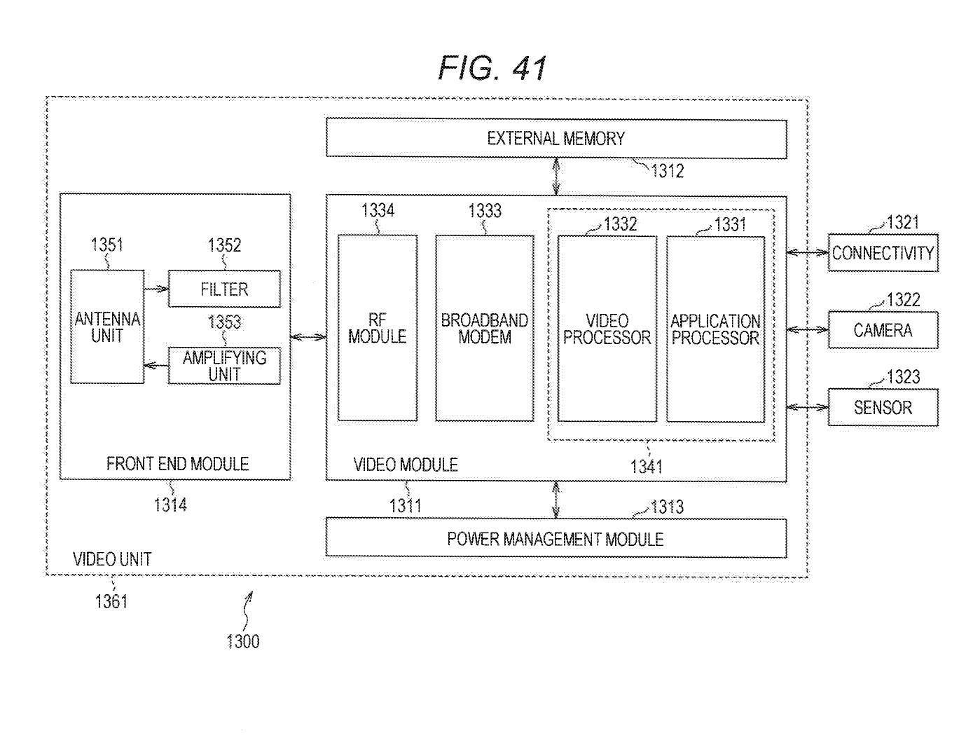

An example in which the present technology is implemented as a set will be described with reference to FIG. 41. FIG. 41 illustrates an exemplary schematic configuration of a video set to which the present technology is applied.

In recent years, functions of electronic devices have become diverse, and when some components are implemented as sale, provision, or the like in development or manufacturing, there are many cases in which a plurality of components having relevant functions are combined and implemented as a set having a plurality of functions as well as cases in which an implementation is performed as a component having a single function.

A video set 1300 illustrated in FIG. 41 is a multi-functionalized configuration in which a device having a function related to image encoding and/or image decoding is combined with a device having any other function related to the function.

As illustrated in FIG. 41, the video set 1300 includes a module group such as a video module 1311, an external memory 1312, a power management module 1313, and a front end module 1314 and a device having relevant functions such as a connectivity 1321, a camera 1322, and a sensor 1323.

A module is a part having multiple functions into which several relevant part functions are integrated. A specific physical configuration is arbitrary, but, for example, it is configured such that a plurality of processes having respective functions, electronic circuit elements such as a resistor and a capacitor, and other devices are arranged and integrated on a wiring substrate. Further, a new module may be obtained by combining another module or a processor with a module.

In the case of the example of FIG. 41, the video module 1311 is a combination of components having functions related to image processing, and includes an application processor, a video processor, a broadband modem 1333, and a radio frequency (RF) module 1334.

A processor is one in which a configuration having a certain function is integrated into a semiconductor chip through System On a Chip (SoC), and also refers to, for example, a system LSI or the like. The configuration having the certain function may be a logic circuit (hardware configuration), may be a CPU, a ROM, a RAM, and a program (software configuration) executed using the CPU, the ROM, and the RAM, and may be a combination of a hardware configuration and a software configuration. For example, a processor may include a logic circuit, a CPU, a ROM, a RAM, and the like, some functions may be implemented through the logic circuit (hardware configuration), and the other functions may be implemented through a program (software configuration) executed by the CPU.

The application processor 1331 of FIG. 41 is a processor that executes an application related to image processing. An application executed by the application processor 1331 can not only perform a calculation process but also control components inside and outside the video module 1311 such as the video processor 1332 as necessary in order to implement a certain function.

The video processor 1332 is a process having a function related to image encoding and/or image decoding.

The broadband modem 1333 is a processor (or module) that performs a process related to wired and/or wireless broadband communication that is performed via broadband line such as the Internet or a public telephone line network. For example, the broadband modem 1333 converts data (digital signal) to be transmitted into an analog signal, for example, through digital modulation, demodulates a received analog signal, and converts the analog signal into data (digital signal). For example, the broadband modem 1333 can perform digital modulation and demodulation on arbitrary information such as image data processed by the video processor 1332, a stream in which image data is encoded, an application program, or setting data.

The RF module 1334 is a module that performs a frequency transform process, a modulation/demodulation process, an amplification process, a filtering process, and the like on an RF signal transceived through an antenna. For example, the RF module 1334 performs, for example, frequency transform on a baseband signal generated by the broadband modem 1333, and generates an RF signal. Further, for example, the RF module 1334 performs, for example, frequency transform on an RF signal received through the front end module 1314, and generates a baseband signal.

Further, a dotted line 1341, that is, the application processor 1331 and the video processor 1332 may be integrated into a single processor as illustrated in FIG. 41.

The external memory 1312 is installed outside the video module 1311, and a module having a storage device used by the video module 1311. The storage device of the external memory 1312 can be implemented by any physical configuration, but is commonly used to store large capacity data such as image data of frame units, and thus it is desirable to implement the storage device of the external memory 1312 using a relatively cheap large-capacity semiconductor memory such as a dynamic random access memory (DRAM).

The power management module 1313 manages and controls power supply to the video module 1311 (the respective components in the video module 1311).

The front end module 1314 is a module that provides a front end function (a circuit of a transceiving end at an antenna side) to the RF module 1334. As illustrated in FIG. 41, the front end module 1314 includes, for example, an antenna unit 1351, a filter 1352, and an amplifying unit 1353.

The antenna unit 1351 includes an antenna that transceives a radio signal and a peripheral configuration. The antenna unit 1351 transmits a signal provided from the amplifying unit 1353 as a radio signal, and provides a received radio signal to the filter 1352 as an electrical signal (RF signal). The filter 1352 performs, for example, a filtering process on an RF signal received through the antenna unit 1351, and provides a processed RF signal to the RF module 1334. The amplifying unit 1353 amplifies the RF signal provided from the RF module 1334, and provides the amplified PR signal to the antenna unit 1351.

The connectivity 1321 is a module having a function related to a connection with the outside. A physical configuration of the connectivity 1321 is arbitrary. For example, the connectivity 1321 includes a configuration having a communication function other than a communication standard supported by the broadband modem 1333, an external I/O terminal, or the like.

For example, the connectivity 1321 may include a module having a communication function based on a wireless communication standard such as Bluetooth (a registered trademark), IEEE 802.11 (for example, Wireless Fidelity (Wi-Fi) (a registered trademark)), Near Field Communication (NFC), InfraRed Data Association (IrDA), an antenna that transceives a signal satisfying the standard, or the like. Further, for example, the connectivity 1321 may include a module having a communication function based on a wired communication standard such as Universal Serial Bus (USB), or High-Definition Multimedia Interface (HDMI) (a registered trademark) or a terminal that satisfies the standard. Furthermore, for example, the connectivity 1321 may include any other data (signal) transmission function or the like such as an analog I/O terminal.

Further, the connectivity 1321 may include a device of a transmission destination of data (signal). For example, the connectivity 1321 may include a drive (including a hard disk, a solid state drive (SSD), a Network Attached Storage (NAS), or the like as well as a drive of a removable medium) that reads/writes data from/in a recording medium such as a magnetic disk, an optical disk, a magneto optical disk, or a semiconductor memory. Furthermore, the connectivity 1321 may include an output device (a monitor, a speaker, or the like) that outputs an image or a sound.

The camera 1322 is a module having a function of photographing a subject and obtaining image data of the subject. For example, image data obtained by the photographing of the camera 1322 is provided to and encoded by the video processor 1332.

The sensor 1323 is a module having an arbitrary sensor function such as a sound sensor, an ultrasonic sensor, an optical sensor, an illuminance sensor, an infrared sensor, an image sensor, a rotation sensor, an angle sensor, an angular velocity sensor, a velocity sensor, an acceleration sensor, an inclination sensor, a magnetic identification sensor, a shock sensor, or a temperature sensor. For example, data detected by the sensor 1323 is provided to the application processor 1331 and used by an application or the like.

A configuration described above as a module may be implemented as a processor, and a configuration described as a processor may be implemented as a module.

In the video set 1300 having the above configuration, the present technology can be applied to the video processor 1332 as will be described later. Thus, the video set 1300 can be implemented as a set to which the present technology is applied.

(Exemplary Configuration of Video Processor)

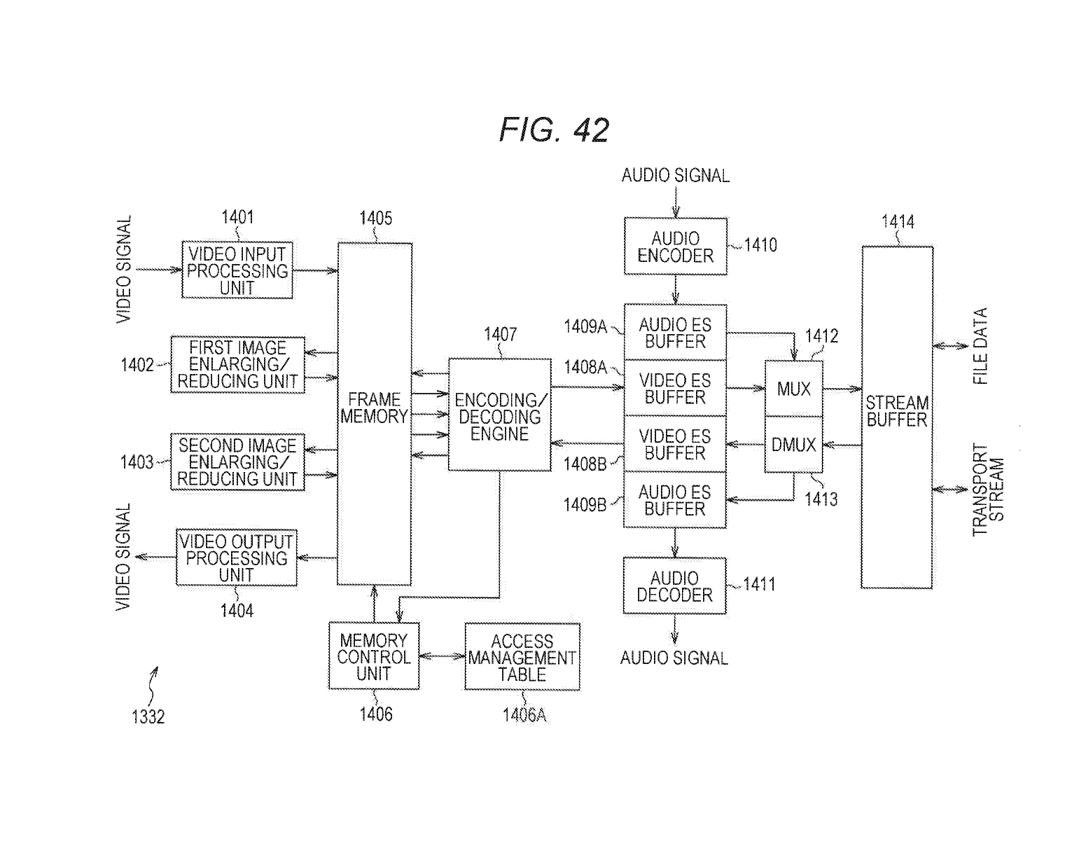

FIG. 42 illustrates an exemplary schematic configuration of the video processor 1332 (FIG. 41) to which the present technology is applied.

In the case of the example of FIG. 42, the video processor 1332 has a function of receiving an input of a video signal and an audio signal and encoding the video signal and the audio signal according to a certain scheme and a function of decoding encoded video data and audio data, and reproducing and outputting a video signal and an audio signal.

The video processor 1332 includes a video input processing unit 1401, a first image enlarging/reducing unit 1402, a second image enlarging/reducing unit 1403, a video output processing unit 1404, a frame memory 1405, and a memory control unit 1406 as illustrated in FIG. 42. The video processor 1332 further includes an encoding/decoding engine 1407, video elementary stream (ES) buffers 1408A and 1408B, and audio ES buffers 1409A and 1409B. The video processor 1332 further includes an audio encoder 1410, an audio decoder 1411, a multiplexer (multiplexer (MUX)) 1412, a demultiplexer (demultiplexer (DMUX)) 1413, and a stream buffer 1414.

For example, the video input processing unit 1401 acquires a video signal input from the connectivity 1321 (FIG. 41) or the like, and converts the video signal into digital image data. The first image enlarging/reducing unit 1402 performs, for example, a format conversion process and an image enlargement/reduction process on the image data. The second image enlarging/reducing unit 1403 performs an image enlargement/reduction process on the image data according to a format of a destination to which the image data is output through the video output processing unit 1404 or performs the format conversion process and the image enlargement/reduction process which are identical to those of the first image enlarging/reducing unit 1402 on the image data. The video output processing unit 1404 performs format conversion and conversion into an analog signal on the image data, and outputs a reproduced video signal to, for example, the connectivity 1321 (FIG. 41) or the like.

The frame memory 1405 is an image data memory that is shared by the video input processing unit 1401, the first image enlarging/reducing unit 1402, the second image enlarging/reducing unit 1403, the video output processing unit 1404, and the encoding/decoding engine 1407. The frame memory 1405 is implemented as, for example, a semiconductor memory such as a DRAM.

The memory control unit 1406 receives a synchronous signal from the encoding/decoding engine 1407, and controls writing/reading access to the frame memory 1405 according to an access schedule for the frame memory 1405 written in an access management table 1406A. The access management table 1406A is updated through the memory control unit 1406 according to processing executed by the encoding/decoding engine 1407, the first image enlarging/reducing unit 1402, the second image enlarging/reducing unit 1403, or the like.

The encoding/decoding engine 1407 performs an encoding process of encoding image data and a decoding process of decoding a video stream that is data obtained by encoding image data. For example, the encoding/decoding engine 1407 encodes image data read from the frame memory 1405, and sequentially writes the encoded image data in the video ES buffer 1408A as a video stream. Further, for example, the encoding/decoding engine 1407 sequentially reads the video stream from the video ES buffer 1408B, sequentially decodes the video stream, and sequentially writes the decoded image data in the frame memory 1405. The encoding/decoding engine 1407 uses the frame memory 1405 as a working area at the time of the encoding or the decoding. Further, the encoding/decoding engine 1407 outputs the synchronous signal to the memory control unit 1406, for example, at a timing at which processing of each macroblock starts.

The video ES buffer 1408A buffers the video stream generated by the encoding/decoding engine 1407, and then provides the video stream to the multiplexer (MUX) 1412. The video ES buffer 1408B buffers the video stream provided from the demultiplexer (DMUX) 1413, and then provides the video stream to the encoding/decoding engine 1407.

The audio ES buffer 1409A buffers an audio stream generated by the audio encoder 1410, and then provides the audio stream to the multiplexer (MUX) 1412. The audio ES buffer 1409B buffers an audio stream provided from the demultiplexer (DMUX) 1413, and then provides the audio stream to the audio decoder 1411.

For example, the audio encoder 1410 converts an audio signal input from, for example, the connectivity 1321 (FIG. 41) or the like into a digital signal, and encodes the digital signal according to a certain scheme such as an MPEG audio scheme or an AudioCode number 3 (AC3) scheme. The audio encoder 1410 sequentially writes the audio stream that is data obtained by encoding the audio signal in the audio ES buffer 1409A. The audio decoder 1411 decodes the audio stream provided from the audio ES buffer 1409B, performs, for example, conversion into an analog signal, and provides a reproduced audio signal to, for example, the connectivity 1321 (FIG. 41) or the like.

The multiplexer (MUX) 1412 performs multiplexing of the video stream and the audio stream. A multiplexing method (that is, a format of a bitstream generated by multiplexing) is arbitrary. Further, at the time of multiplexing, the multiplexer (MUX) 1412 may add certain header information or the like to the bitstream. In other words, the multiplexer (MUX) 1412 may convert a stream format by multiplexing. For example, the multiplexer (MUX) 1412 multiplexes the video stream and the audio stream to be converted into a transport stream that is a bitstream of a transfer format. Further, for example, the multiplexer (MUX) 1412 multiplexes the video stream and the audio stream to be converted into data (file data) of a recording file format.

The demultiplexer (DMUX) 1413 demultiplexes the bitstream obtained by multiplexing the video stream and the audio stream by a method corresponding to the multiplexing performed by the multiplexer (MUX) 1412. In other words, the demultiplexer (DMUX) 1413 extracts the video stream and the audio stream (separates the video stream and the audio stream) from the bitstream read from the stream buffer 1414. In other words, the demultiplexer (DMUX) 1413 can perform conversion (inverse conversion of conversion performed by the multiplexer (MUX) 1412) of a format of a stream through the demultiplexing. For example, the demultiplexer (DMUX) 1413 can acquire the transport stream provided from, for example, the connectivity 1321 or the broadband modem 1:333 (both FIG. 41) through the stream buffer 1414 and convert the transport stream into a video stream and an audio stream through the demultiplexing. Further, for example, the demultiplexer (DMUX) 1413 can acquire file data read from various kinds of recording media (FIG. 41) by, for example, the connectivity 1321 through the stream buffer 1414 and converts the file data into a video stream and an audio stream by the demultiplexing.

The stream buffer 1414 buffers the bitstream. For example, the stream buffer 1414 buffers the transport stream provided from the multiplexer (MUX) 1412, and provides the transport stream to, for example, the connectivity 1321 or the broadband modem 1333 (both FIG. 41) at a certain timing or based on an external request or the like.

Further, for example, the stream buffer 1414 buffers file data provided from the multiplexer (MUX) 1412, provides the file data to, for example, the connectivity 1321 (FIG. 41) or the like at a certain timing or based on an external request or the like, and causes the file data to be recorded in various kinds of recording media.

Furthermore, the stream buffer 1414 buffers the transport stream acquired through, for example, the connectivity 1321 or the broadband modem 1333 (both FIG. 41), and provides the transport stream to the demultiplexer (DMUX) 141.3 at a certain timing or based on an external request or the like.

Further, the stream buffer 1414 buffers file data read from various kinds of recording media in, for example, the connectivity 1321 (FIG. 41) or the like, and provides the file data to the demultiplexer (DMUX) 1413 at a certain timing or based on an external request or the like.

Next, an operation of the video processor 1332 having the above configuration will be described. The video signal input to the video processor 1332, for example, from the connectivity 1321 (FIG. 41) or the like is converted into digital image data according to a certain scheme such as a 4:2:2Y/Cb/Cr scheme in the video input processing unit 1401 and sequentially written in the frame memory 1405. The digital image data is read out to the first image enlarging/reducing unit 1402 or the second image enlarging/reducing unit 1403, subjected to a format conversion process of performing a format conversion into a certain scheme such as a 4:2:0Y/Cb/Cr scheme and an enlargement/reduction process, and written in the frame memory 1405 again. The image data is encoded by the encoding/decoding engine 1407, and written in the video ES buffer 1408A as a video stream.

Further, an audio signal input to the video processor 1332 from the connectivity 1321 (FIG. 41) or the like is encoded by the audio encoder 1410, and written in the audio ES buffer 1409A as an audio stream.

The video stream of the video ES buffer 1408A and the audio stream of the audio ES buffer 1409A are read out to and multiplexed by the multiplexer (MUX) 1412, and converted into a transport stream, file data, or the like. The transport stream generated by the multiplexer (MUX) 1412 is buffered in the stream buffer 1414, and then output to an external network through, for example, the connectivity 1321 or the broadband modem 1333 (both FIG. 41). Further, the file data generated by the multiplexer (MUX) 1412 is buffered in the stream buffer 1414, then output to, for example, the connectivity 1321 (FIG. 41) or the like, and recorded in various kinds of recording media.

Further, the transport stream input to the video processor 1332 from an external network through, for example, the connectivity 1321 or the broadband modem 1333 (both FIG. 41) is buffered in the stream buffer 1414 and then demultiplexed by the demultiplexer (DMUX) 1413. Further, the file data that is read from various kinds of recording media in, for example, the connectivity 1321 (FIG. 41) or the like and then input to the video processor 1332 is buffered in the stream buffer 1414 and then demultiplexed by the demultiplexer (DMUX) 1413. In other words, the transport stream or the file data input to the video processor 1332 is demultiplexed into the video stream and the audio stream through the demultiplexer (DMUX) 1413.

The audio stream is provided to the audio decoder 1411 through the audio ES buffer 1409B and decoded, and so an audio signal is reproduced. Further, the video stream is written in the video ES buffer 1408B, sequentially read out to and decoded by the encoding/decoding engine 1407, and written in the frame memory 1405. The decoded image data is subjected to the enlargement/reduction process performed by the second image enlarging/reducing unit 1403, and written in the frame memory 1405. Then, the decoded image data is read out to the video output processing unit 1404, subjected to the format conversion process of performing format conversion to a certain scheme such as a 4:2:2Y/Cb/Cr scheme, and converted into an analog signal, and so a video signal is reproduced.

When the present technology is applied to the video processor 1332 having the above configuration, it is preferable that the above embodiments of the present technology be applied to the encoding/decoding engine 1407. In other words, for example, the encoding/decoding engine 1407 preferably has the function of the encoding device or the decoding device according to the first embodiment. Accordingly, the video processor 1332 can obtain the same effects as the effects described above with reference to FIGS. 1 to 29.

Further, in the encoding/decoding engine 1407, the present technology (that is, the functions of the image encoding devices or the image decoding devices according to the above embodiments) may be implemented by either or both of hardware such as a logic circuit or software such as an embedded program.

(Another Exemplary Configuration of Video Processor)

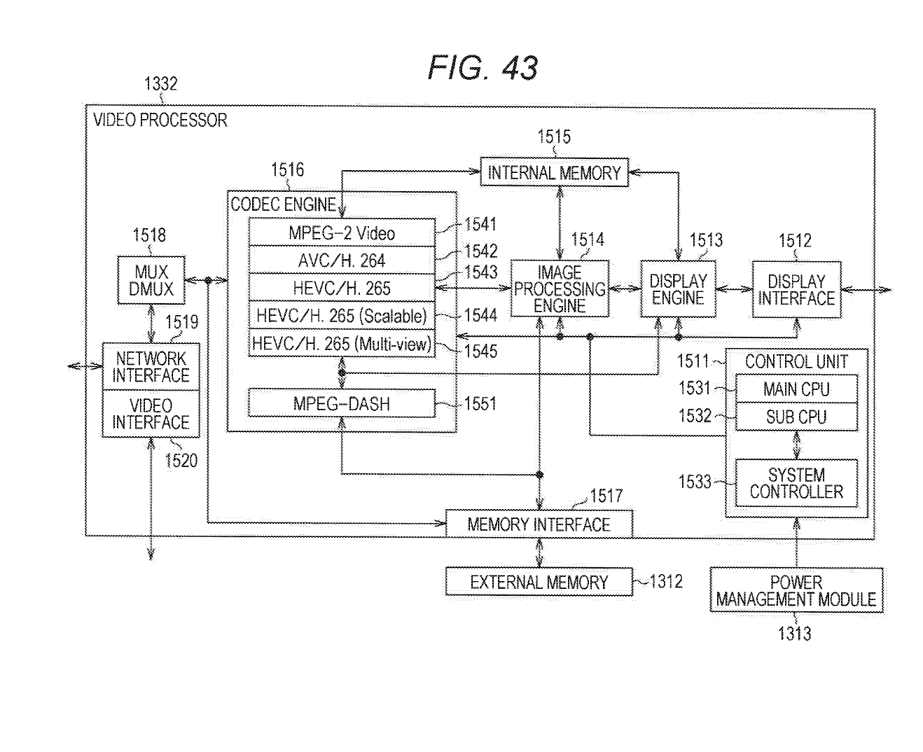

FIG. 43 illustrates another exemplary schematic configuration of the video processor 1332 (FIG. 41) to which the present technology is applied. In the case of the example of FIG. 43 the video processor 1332 has a function of encoding and decoding video data according to a certain scheme.

More specifically, the video processor 1332 includes a control unit 1511, a display interface 1512, a display engine 1513, an image processing engine 1514, and an internal memory 1515 as illustrated in FIG. 43. The video processor 1332 further includes a codec engine 1516, a memory interface 1517, a multiplexing/demultiplexing unit (MUX DMUX) 1518, a network interface 1519, and a video interface 1520.

The control unit 1511 controls an operation of each processing unit in the video processor 1332 such as the display interface 1512, the display engine 1513, the image processing engine 1514, and the codec engine 1516.

The control unit 1511 includes, for example, a main CPU 1531, a sub CPU 1532, and a system controller 1533 as illustrated in FIG. 43. The main CPU 1531 executes, for example, a program for controlling an operation of each processing unit in the video processor 1332. The main CPU 1531 generates a control signal, for example, according to the program, and provides the control signal to each processing unit (that is, controls an operation of each processing unit). The sub CPU 1532 plays a supplementary role of the main CPU 1531. For example, the sub CPU 1532 executes a child process or a subroutine of a program executed by the main CPU 1531. The system controller 1533 controls operations of the main CPU 1531 and the sub CPU 1532, for example, designates a program executed by the main CPU 1531 and the sub CPU 1532.

The display interface 1512 outputs image data to, for example, the connectivity 1321 (FIG. 41) or the like under control of the control unit 1511. For example, the display interface 1512 converts image data of digital data into an analog signal, and outputs the analog signal to, for example, the monitor device of the connectivity 1321 (FIG. 41), as a reproduced video signal or the image data of the digital data without change.

The display engine 1513 performs various kinds of conversion processes such as a format conversion process, a size conversion process, and a color gamut conversion process on the image data under control of the control unit 1511 to comply with, for example, a hardware specification of the monitor device that displays the image.

The image processing engine 1514 performs certain image processing such as a filtering process for improving an image quality on the image data under control of the control unit 1511.

The internal memory 1515 is a memory that is installed in the video processor 1332 and shared by the display engine 1513, the image processing engine 1514, and the codec engine 1516. The internal memory 1515 is used for data transfer performed among, for example, the display engine 1513, the image processing engine 1514, and the codec engine 1516. For example, the internal memory 1515 stores data provided from the display engine 1513, the image processing engine 1514, or the codec engine 1516, and provides the data to the display engine 1513, the image processing engine 1514, or the codec engine 1516 as necessary (for example, according to a request). The internal memory 1515 can be implemented by any storage device, but since the internal memory 1515 is mostly used for storage of small-capacity data such as image data of block units or parameters, it is desirable to implement the internal memory 1515 using a semiconductor memory that is relatively small in capacity (for example, compared to the external memory 3312) and fast in response speed such as a static random access memory (SRAM).

The codec engine 1516 performs processing related to encoding and decoding of image data. An encoding/decoding scheme supported by the codec engine 1516 is arbitrary, and one or more schemes may be supported by the codec engine 1516.

For example, the codec engine 1516 may have a codec function of supporting a plurality of encoding/decoding schemes and perform encoding of image data or decoding of encoded data using a scheme selected from among the schemes.

In the example illustrated in FIG. 43, the codec engine 1516 includes, for example, an MPEG-2 Video 1541, an AVC/H.264 1542, a HEVC/H.265 1543, a HEVC/H.265 (Scalable) 1544, a HEVC/H.265 (Multi-view) 1545, and an MPEG-DASH 1551 as functional blocks of processing related to a codec.

The MPEG-2 Video 1541 is a functional block of encoding or decoding image data according to an MPEG-2 scheme. The AVC/H.264 1542 is a functional block of encoding or decoding image data according to an AVC scheme. The HEVC/H.265 1543 is a functional block of encoding or decoding image data according to a HEVC scheme. The HEVC/H.265 (Scalable) 1544 is a functional block of per forming scalable coding or scalable decoding on image data according to a HEVC scheme. The HEVC/H.265 (Multi-view) 1545 is a functional block of performing multi-view encoding or multi-view decoding on image data according to a HEVC scheme.

The MPEG-DASH 1551 is a functional block of transmitting and receiving image data according to an MPEG-Dynamic Adaptive Streaming over HTTP (MPEG-DASH) scheme. The MPEG-DASH is a technique of streaming a video using a HyperText Transfer Protocol (HTTP), and has a feature of selecting appropriate one from among a plurality of pieces of encoded data that differ in a previously prepared resolution or the like in units of segments and transmitting a selected one. The MPEG-DASH 1551 performs generation of a stream complying with a standard, transmission control of the stream, and the like, and uses the MPEG-2 Video 1541 to the HEVC/H.265 (Multi-view) 1545 for encoding and decoding of image data.

The memory interface 1517 is an interface for the external memory 1312. Data provided from the image processing engine 1514 or the codec engine 1516 is provided to the external memory 1312 through the memory interface 1517. Further, data read from the external memory 1312 is provided to the video processor 1332 (the image processing engine 1514 or the codec engine 1516) through the memory interface 1517.

The multiplexing/demultiplexing unit (MUX DMUX) 1518 performs multiplexing and demultiplexing of various kinds of data related to an image such as a bitstream of encoded data, image data, and a video signal. The multiplexing/demultiplexing method is arbitrary. For example, at the time of multiplexing, the multiplexing/demultiplexing unit (MUX DMUX) 1518 can not only combine a plurality of data into one but also add certain header information or the like to the data. Further, at the time of demultiplexing, the multiplexing/demultiplexing unit (MUX DMUX) 1518 can not only divide one data into a plurality of data but also add certain header information or the like to each divided data. In other words, the multiplexing/demultiplexing unit (MUX DMUX) 1518 can converts a data format through multiplexing and demultiplexing. For example, the multiplexing/demultiplexing unit (MUX DMUX) 1518 can multiplex a bitstream to be converted into a transport stream serving as a bitstream of a transfer format or data (file data) of a recording file format. Of course, inverse conversion can be also performed through demultiplexing.

The network interface 1519 is an interface for, for example, the broadband modem 1333 or the connectivity 1321 (both FIG. 41). The video interface 1520 is an interface for, for example, the connectivity 1321 or the camera 1322 (both FIG. 41).

Next, an exemplary operation of the video processor 1332 will be described. For example, when the transport stream is received from the external network through, for example, the connectivity 1321 or the broadband modem 1333 (both FIG. 41), the transport stream is provided to the multiplexing/demultiplexing unit (MUX DMUX) 1518 through the network interface 1519, demultiplexed, and then decoded by the codec engine 1516. Image data obtained by the decoding of the codec engine 1516 is subjected to certain image processing performed, for example, by the image processing engine 1514, subjected to certain conversion performed by the display engine 1513, and provided to, for example, the connectivity 1321 (FIG. 41) or the like through the display interface 1512, and so the image is displayed on the monitor. Further, for example, image data obtained by the decoding of the codec engine 1516 is encoded by the codec engine 1516 again, multiplexed by the multiplexing/demultiplexing unit (MUX DMUX) 1518 to be converted into file data, output to, for example, the connectivity 1321 (FIG. 41) or the like through the video interface 1520, and then recorded in various kinds of recording media.

Furthermore, for example, file data of encoded data obtained by encoding image data read from a recording medium (not illustrated) through the connectivity 1321 (FIG. 41) or the like is provided to the multiplexing/demultiplexing unit (MUX DMUX) 1518 through the video interface 1520, and demultiplexed, and decoded by the codec engine 1516. Image data obtained by the decoding of the codec engine 1516 is subjected to certain image processing performed by the image processing engine 1514, subjected to certain conversion performed by the display engine 1513, and provided to, for example, the connectivity 1321 (FIG. 41) or the like through the display interface 1512, and so the image is displayed on the monitor. Further, for example, image data obtained by the decoding of the codec engine 1516 is encoded by the codec engine 1516 again, multiplexed by the multiplexing/demultiplexing unit (MUX DMUX) 1518 to be converted into a transport stream, provided to, for example, the connectivity 1321 or the broadband modem 1333 (both FIG. 41) through the network interface 1519, and transmitted to another device (not illustrated).

Further, transfer of image data or other data between the processing units in the video processor 1332 is performed, for example, using the internal memory 1515 or the external memory 1312. Furthermore, the power management module 1313 controls, for example, power supply to the control unit 1511.

When the present technology is applied to the video processor 1332 having the above configuration, it is desirable to apply the above embodiments of the present technology to the codec engine 1516. In other words, for example, it is preferable that the codec engine 1516 have a functional block of implementing the encoding device and the decoding device according to the first embodiment. Furthermore, for example, as the codec engine 1516 operates as described above, the video processor 1332 can have the same effects as the effects described above with reference to FIGS. 1 to 29.

Further, in the codec engine 1516, the present technology (that is, the functions of the image encoding devices or the image decoding devices according to the above embodiments) may be implemented by either or both of hardware such as a logic circuit or software such as an embedded program.

The two exemplary configurations of the video processor 1332 have been described above, but the configuration of the video processor 1332 is arbitrary and may have any configuration other than the above two exemplary configurations. Further, the video processor 1332 may be configured with a single semiconductor chip or may be configured with a plurality of semiconductor chips. For example, the video processor 1332 may be configured with a three-dimensionally stacked LSI in which a plurality of semiconductors are stacked. Further, the video processor 1332 may be implemented by a plurality of LSIs.

(Application Examples to Devices)

The video set 1300 may be incorporated into various kinds of devices that process image data. For example, the video set 1300 may be incorporated into the television device 900 (FIG. 34), the mobile telephone 920 (FIG. 35), the recording/reproducing device 940 (FIG. 36), the imaging device 960 (FIG. 37), or the like. As the video set 1300 is incorporated, the devices can have the same effects as the effects described above with reference to FIGS. 1 to 29.

Further, the video set 1300 may be also incorporated into a terminal device such as the personal computer 1004, the AV device 1005, the tablet device 1006, or the mobile telephone 1007 in the data transmission system 1000 of FIG. 38, the broadcasting station 1101 or the terminal device 1102 in the data transmission system 1100 of FIG. 39, or the imaging device 1201 or the scalable encoded data storage device 1202 in the imaging system 1200 of FIG. 40. As the video set 1300 is incorporated, the devices can have the same effects as the effects described above with reference to FIGS. 1 to 29.

Further, even each component of the video set 1300 can be implemented as a component to which the present technology is applied when the component includes the video processor 1332. For example, only the video processor 1332 can be implemented as a video processor to which the present technology is applied. Further, for example, the processors indicated by the dotted line 1341 as described above, the video module 1311, or the like can be implemented as, for example, a processor or a module to which the present technology is applied. Further, for example, a combination of the video module 1311, the external memory 1312, the power management module 1313, and the front end module 1314 can be implemented as a video unit 1361 to which the present technology is applied. These configurations can have the same effects as the effects described above with reference to FIGS. 1 to 29.

In other words, a configuration including the video processor 1332 can be incorporated into various kinds of devices that process image data, similarly to the case of the video set 1300. For example, the video processor 1332, the processors indicated by the dotted line 1341, the video module 1311, or the video unit 1361 can be incorporated into the television device 900 (FIG. 34), the mobile telephone 920 (FIG. 35), the recording/reproducing device 940 (FIG. 36), the imaging device 960 (FIG. 37), the terminal device such as the personal computer 1004, the AV device 1005, the tablet device 1006, or the mobile telephone 1007 in the data transmission system 1000 of FIG. 38, the broadcasting station 1101 or the terminal device 1102 in the data transmission system 1100 of FIG. 39, the imaging device 1201 or the scalable encoded data storage device 1202 in the imaging system 1200 of FIG. 40, or the like. Further, as the configuration to which the present technology is applied, the devices can have the same effects as the effects described above with reference to FIGS. 1 to 29, similarly to the video set 1300.

In the present specification, the description has been made in connection with the example in which various kinds of information such as general_profile_idc is multiplexed into encoded data and transmitted from an encoding side to a decoding side. However, the technique of transmitting the information is not limited to this example. For example, the information may be transmitted or recorded as individual data associated with encoded data without being multiplexed into encoded data. Here, a term “associated” means that an image (or a part of an image such as a slice or a block) included in a bitstream can be linked with information corresponding to the image at the time of decoding. In other words, the information may be transmitted through a transmission path different from that for encoded data. Further, the information may be recorded in a recording medium (or a different recording area of the same recording medium) different from that for encoded data. Furthermore, the information and the encoded data may be associated with each other, for example, in units of a plurality of frames, a frame, or arbitrary units such as parts of a frame.

The present disclosure can be applied to an encoding device or a decoding device used when a bit stream compressed by orthogonal transform such as discrete cosine transform and motion compensation is received through a network medium such as satellite broadcasting, a cable television, the Internet, or a mobile telephone or when a bit stream is processed on a storage medium such as an optical disk, a magnetic disk, or a flash memory, for example, in the MPEG or H.26x.

Further, the present disclosure can be applied to an encoding device and a decoding device capable of performing scalable coding in which an encoding scheme of the base image is an encoding scheme complying with the main still picture profile or the all intra profile.

In the present specification, a system represents a set of a plurality of components (devices, modules (parts), and the like), and all components need not be necessarily arranged in a single housing. Thus, both a plurality of devices that are arranged in individual housings and connected with one another via a network and a single device including a plurality of modules arranged in a single housing are regarded as a system.

The effects described in the present specification are merely examples, and any other effect may be included.

Further, an embodiment of the present disclosure is not limited to the above embodiments, and various changes can be made within a scope not departing from the gist of the present disclosure.

For example, the present disclosure may have a cloud computing configuration in which one function is shared and jointly processed by a plurality of devices via a network. The steps described above with reference to the flowchart may be performed by a single device or may be shared and performed by a plurality of devices.

Furthermore, when a plurality of processes are included in a single step, the plurality of processes included in the single step may be performed by a single device or may be shared and performed by a plurality of devices.

The present disclosure can have the following configurations as well.

(1)

A decoding device, including:

a decoding unit that decodes encoded data of an enhancement image based on still profile information that is set when a profile of a base image serving as an image of a first layer is a main still picture profile and indicates that a profile of the enhancement image serving as an image of a second layer is a scalable main still picture profile or intra profile information that is set when the profile of the base image is an all intra profile and indicates that the profile of the enhancement image is a scalable all intra profile.

(2)

The decoding device according to (I),

wherein, when the number of images of other layers that can be referred to at the time of the decoding is 1, slices of the enhancement image are an I slice or a P slice.

(3)

The decoding device according to (2),

wherein the decoding unit performs the decoding based on reference layer number information indicating the number of images of other layers that can be referred to at a time of the decoding.

(4)

The decoding device according to any one of (1) to (3),

wherein at least one slice in a picture of the enhancement image is a P slice or a B slice.

(5)

The decoding device according to any one of (1) to (4),

wherein the decoding unit refers to only an image of another layer at a time of inter decoding of the encoded data of the enhancement image based on the intra profile information.

(6)

The decoding device according to (5),

wherein the decoding unit decodes the encoded data of the enhancement image based on the intra profile information with reference to a reference picture set of a long term at the time of the inter decoding of the encoded data of the enhancement image.

(7)

The decoding device according to any one of (1) to (6), further including

an inverse quantization unit that performs inverse quantization on quantized encoded data of the enhancement image based on reference scaling list information indicating that a scaling list used at a time of quantization of encoded data of an image of another layer is not used at a time of quantization of the encoded data of the enhancement image and a scaling list of the enhancement image,

wherein the decoding unit decodes the encoded data of the enhancement image obtained as a result of the inverse quantization.

(8)

The decoding device according to any one of (1) to (6), further including

an inverse quantization unit that performs inverse quantization on quantized encoded data of the enhancement image based on reference scaling list information indicating that a scaling list used at a time of quantization of encoded data of an image of another layer is used at a time of quantization of the encoded data of the enhancement image and a scaling list of the image of the other layer,

wherein the decoding unit decodes the encoded data of the enhancement image obtained as a result of the inverse quantization.

(9)

The decoding device according to any one of (1) to (8),

wherein the decoding unit decodes the encoded data of the enhancement image based on bit depth information indicating that a bit depth of the enhancement image is larger than a bit depth of the base image.

(10)

A decoding method, including:

a decoding step of decoding, by a decoding device, encoded data of an enhancement image based on still profile information that is set when a profile of a base image serving as an image of a first layer is a main still picture profile and indicates that a profile of the enhancement image serving as an image of a second layer is a scalable main still picture profile or intra profile information that is set when the profile of the base image is an all intra profile and indicates that the profile of the enhancement image is a scalable all intra profile.

(11)

An encoding device, including:

a setting unit that sets still profile information indicating that a profile of an enhancement image serving as an image of a second layer is a scalable main still picture profile when a profile of a base image serving as an image of a first layer is a main still picture profile, and sets intra profile information indicating that the profile of the enhancement image is a scalable all intra profile when the profile of the base image is an all intra profile;

an encoding unit that encodes the enhancement image, and generates encoded data; and

a transmission unit that transmits the still profile information and the intra profile information set by the setting unit and the encoded data generated by the encoding unit.

(12)

The encoding device according to (11),

wherein, when the number of images of other layers that can be referred to at a time of the encoding is 1, slices of the enhancement image are an I slice or a P slice.

(13)

The encoding device according to (12),

wherein the setting unit sets reference layer number information indicating the number of images of other layers that can be referred to at the time of the encoding, and

the transmission unit transmits the reference layer number information set by the setting unit.

(14)

The encoding device according to anyone of (11) to (13),

wherein at least one slice in a picture of the enhancement image is a P slice or a B slice.

(15)

The encoding device according to any one of (11) to (14),

wherein, when the intra profile information is set by the setting unit, the encoding unit refers to only an image of another layer at a time of inter encoding of the enhancement image.

(16)

The encoding device according to (15),

wherein, when the intra profile information is set by the setting unit, the encoding unit encodes the enhancement image based on a reference picture set of a long term at the time of the inter encoding of the enhancement image.

(17)

The encoding device according to any one of (11) to (16), further including

a quantization unit that quantizes the encoded data generated by the encoding unit based on a scaling list of the enhancement image,

wherein the setting unit sets reference scaling list information indicating that a scaling list used at a time of quantization of encoded data of an image of another layer is not used at a time of quantization of the encoded data of the enhancement image, and

the transmission unit transmits the encoded data quantized by the quantization unit, the reference scaling list information set by the setting unit, and the scaling list of the enhancement image.

(18)

The encoding device according to anyone of (11) to (16), further including

a quantization unit that quantizes the encoded data generated by the encoding unit based on a scaling list of an image of another layer serving as a layer other than the second layer,

wherein the setting unit sets reference scaling list information indicating that a scaling list of the image of the other layer is used at a time of quantization of the encoded data of the enhancement image, and the transmission unit transmits the encoded data quantized by the quantization unit and the reference scaling list information set by the setting unit.

(19)

The encoding device according to any one of (11) to (18),

wherein the setting unit sets bit depth information indicating that a bit depth of the enhancement image is larger than a bit depth of the base image, and

the transmission unit transmits the bit depth information set by the setting unit.

(20)

An encoding method, including:

a setting step of setting, by an encoding device, still profile information indicating that a profile of an enhancement image serving as an image of a second layer is a scalable main still picture profile when a profile of a base image serving as an image of a first layer is a main still picture profile, and sets intra profile information indicating that the profile of the enhancement image is a scalable all intra profile when the profile of the base image is an all intra profile;

an encoding step of encoding, by the encoding device, the enhancement image, and generates encoded data; and

a transmission step of transmitting, by the encoding device, the still profile information and the intra profile information set in the setting step and the encoded data generated in the encoding step.

### REFERENCE SIGNS LIST

30 Encoding device
34 Transmission unit
51a Specific profile setting unit
73 Operation unit
75 Quantization unit
160 Decoding device
203 Inverse quantization unit
205 Addition unit

1. A decoding device, comprising:
a decoding unit that decodes encoded data of an enhancement image based on still profile information that is set when a profile of a base image serving as an image of a first layer is a main still picture profile and indicates that a profile of the enhancement image serving as an image of a second layer is a scalable main still picture profile or intra profile information that is set when the profile of the base image is an all intra profile and indicates that the profile of the enhancement image is a scalable all intra profile.

2. The decoding device according to claim 1,
wherein, when the number of images of other layers that can be referred to at the time of the decoding is 1, slices of the enhancement image are an I slice or a P slice.

3. The decoding device according to claim 2,
wherein the decoding unit performs the decoding based on reference layer number information indicating the number of images of other layers that can be referred to at a time of the decoding.

4. The decoding device according to claim 1,
wherein at least one slice in a picture of the enhancement image is a P slice or a B slice.

5. The decoding device according to claim 1,
wherein the decoding unit refers to only an image of another layer at a time of inter decoding of the encoded data of the enhancement image based on the intra profile information.

6. The decoding device according to claim 5,
wherein the decoding unit decodes the encoded data of the enhancement image based on the intra profile information with reference to a reference picture set of a long term at the time of the inter decoding of the encoded data of the enhancement image.

7. The decoding device according to claim 1, further comprising
an inverse quantization unit that performs inverse quantization on quantized encoded data of the enhancement image based on reference scaling list information indicating that a scaling list used at a time of quantization of encoded data of an image of another layer is not used at a time of quantization of the encoded data of the enhancement image and a scaling list of the enhancement image,
wherein the decoding unit decodes the encoded data of the enhancement image obtained as a result of the inverse quantization.

8. The decoding device according to claim 1, further comprising
an inverse quantization unit that performs inverse quantization on quantized encoded data of the enhancement image based on reference scaling list information indicating that a scaling list used at a time of quantization of encoded data of an image of another layer is used at a time of quantization of the encoded data of the enhancement image and a scaling list of the image of the other layer,
wherein the decoding unit decodes the encoded data of the enhancement image obtained as a result of the inverse quantization.

9. The decoding device according to claim 1,
wherein the decoding unit decodes the encoded data of the enhancement image based on bit depth information indicating that a bit depth of the enhancement image is larger than a bit depth of the base image.

10. A decoding method, comprising:
a decoding step of decoding, by a decoding device,
encoded data of an enhancement image based on still profile information that is set when a profile of a base image serving as an image of a first layer is a main still picture profile and indicates that a profile of the enhancement image serving as an image of a second layer is a scalable main still picture profile or intra profile information that is set when the profile of the base image is an all intra profile and indicates that the profile of the enhancement image is a scalable all intra profile.

11. An encoding device, comprising:
a setting unit that sets still profile information indicating that a profile of an enhancement image serving as an image of a second layer is a scalable main still picture profile when a profile of a base image serving as an image of a first layer is a main still picture profile, and sets intra profile information indicating that the profile of the enhancement image is a scalable all intra profile when the profile of the base image is an all intra profile;
an encoding unit that encodes the enhancement image, and generates encoded data; and
a transmission unit that transmits the still profile information and the intra profile information set by the setting unit and the encoded data generated by the encoding unit.

12. The encoding device according to claim 11,
wherein, when the number of images of other layers that can be referred to at a time of the encoding is 1, slices of the enhancement image are an I slice or a P slice.

13. The encoding device according to claim 12,
wherein the setting unit sets reference layer number information indicating the number of images of other layers that can be referred to at the time of the encoding, and
the transmission unit transmits the reference layer number information set by the setting unit.

14. The encoding device according to claim 11,
wherein at least one slice in a picture of the enhancement image is a P slice or a B slice.

15. The encoding device according to claim 11,
wherein, when the intra profile information is set by the setting unit, the encoding unit refers to only an image of another layer at a time of inter encoding of the enhancement image.

16. The encoding device according to claim 15,
wherein, when the intra profile information is set by the setting unit, the encoding unit encodes the enhancement image based on a reference picture set of a long term at the time of the inter encoding of the enhancement image.

17. The encoding device according to claim 11, further comprising
a quantization unit that quantizes the encoded data generated by the encoding unit based on a scaling list of the enhancement image,
wherein the setting unit sets reference scaling list information indicating that a scaling list used at a time of quantization of encoded data of an image of another layer is not used at a time of quantization of the encoded data of the enhancement image, and
the transmission unit transmits the encoded data quantized by the quantization unit, the reference scaling list information set by the setting unit, and the scaling list of the enhancement image.

18. The encoding device according to claim 11, further comprising
a quantization unit that quantizes the encoded data generated by the encoding unit based on a scaling list of an image of another layer serving as a layer other than the second layer,
wherein the setting unit sets reference scaling list information indicating that a scaling list of the image of the other layer is used at a time of quantization of the encoded data of the enhancement image, and
the transmission unit transmits the encoded data quantized by the quantization unit and the reference scaling list information set by the setting unit.

19. The encoding device according to claim 11,
wherein the setting unit sets bit depth information indicating that a bit depth of the enhancement image is larger than a bit depth of the base image, and
the transmission unit transmits the bit depth information set by the setting unit.

20. An encoding method, comprising:
a setting step of setting, by an encoding device, still profile information indicating that a profile of an enhancement image serving as an image of a second layer is a scalable main still picture profile when a profile of a base image serving as an image of a first layer is a main still picture profile, and setting intra profile information indicating that the profile of the enhancement image is a scalable all intra profile when the profile of the base image is an all intra profile;
an encoding step of encoding, by the encoding device, the enhancement image, and generating encoded data; and
a transmission step of transmitting, by the encoding device, the still profile information and the intra profile information set in the setting step and the encoded data generated in the encoding step.
